(19) United States
(12) Patent Application Publication
(10) Pub. No.: US 2018/0122143 A1
(43) Pub. Date: May 3, 2018

(54) HYBRID PHOTONIC VR/AR SYSTEMS

(71) Applicant: Sutherland Cook Ellwood, JR., Cheltenham (GB)

(72) Inventor: Sutherland Cook Ellwood, JR., Cheltenham (GB)

(21) Appl. No.: 15/458,009

(22) Filed: Mar. 13, 2017

Related U.S. Application Data
(60) Provisional application No. 62/308,687, filed on Mar. 15, 2016.
(60) Provisional application No. 62/308,361, filed on Mar. 15, 2016.
(60) Provisional application No. 62/308,585, filed on Mar. 15, 2016.
(60) Provisional application No. 62/308,825, filed on Mar. 15, 2016.

(51) Int. Cl. G06T 19/00; H04N 9/64; H04N 9/31

(52) U.S. Cl. CPC G06T 19/006; H04N 9/64; G06T 2207/10048; G06T 2200/21; G06T 2200/28; H04N 9/31

(57) ABSTRACT

A VR/AR system, method, architecture includes an augmentor that concurrently receives and processes real world image constituent signals while producing synthetic world image constituent signals and then interleaves/augments these signals for further processing. In some implementations, the real world signals (pass through with possibility of processing by the augmentor) are converted to IR (using, for example, a false color map) and interleaved with the synthetic world signals (produced in IR) for continued processing including visualization (conversion to visible spectrum), amplitude/bandwidth processing, and output shaping for production of a set of display image precursors intended for a HVS.

### CROSS REFERENCE TO RELATED APPLICATIONS

This application claims benefit from U.S. Patent Application No. 62/308,825, and claims benefit from U.S. Patent Application No. 62/308,361, and claims benefit from U.S. Patent Application No. 62/308,585, and claims benefit from U.S. Patent Application No. 62/308,687, all filed 15 Mar. 2016, and this application is related to U.S. patent application Ser. Nos. 12/371,461, 62/181,143, and 62/234,942, the contents of which are all hereby expressly incorporated by reference thereto in their entireties for all purposes.

### FIELD OF THE INVENTION

The present invention relates generally to video and digital image and data processing devices and networks which generate, transmit, switch, allocate, store, and display such data, as well as non-video and non-pixel data processing in arrays, such as sensing arrays and spatial light modulators, and the application and use of data for same, and more specifically, but not exclusively, to digital video image displays, whether flat screen, flexible screen, 2D or 3D, or projected images, and non-display data processing by device arrays, and to the spatial forms of organization and locating these processes, including compact devices such as flat screen televisions and consumer mobile devices, as well as the data networks which provide image capture, transmission, allocation, division, organization, storage, delivery, display and projection of pixel signals or data signals or aggregations or collections of same.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The field of the present invention is not single, but rather combines two related fields, augmented reality and virtual reality, but addressing and providing an integrated mobile device solution that solves critical problems and limitations of the prior art in both fields. A brief review of the background of these related fields will make evident the problems and limitations to be solved, and set the stage for the proposed solutions of the present disclosure.

Two standard dictionary definitions of these terms (source: Dictionary.com) are as follows:

VIRTUAL REALITY: “A realistic simulation of an environment, including three-dimensional graphics, by a computer system using interactive software and hardware. Abbreviation: VR”

AUGMENTED REALITY: “An enhanced image or environment as viewed on a screen or other display, produced by overlaying computer-generated images, sounds, or other data on a real-world environment. AND: “A system or technology used to produce such an enhanced environment. Abbreviation: AR”

It is evident from the definitions, though non-technical, and to those skilled in these related fields, that the essential difference lies in whether the simulated elements are a complete and immersive simulation, screening completely even a partial direct view of reality, or the simulated elements are super-imposed over an otherwise clear, unobstructed view of reality.

Slightly more technical definitions is provided under the Wikipedia entry for the topic, which may be considered well-represented of the field, given the depth and range of contributions to the editing of the pages.

Virtual reality (VR), sometimes referred to as immersive multimedia, is a computer-simulated environment that can simulate physical presence in places in the real world or imagined worlds. Virtual reality can recreate sensory experiences, including virtual taste, sight, smell, sound, touch etc.

Augmented reality (AR) is a live direct or indirect view of a physical, real-world environment whose elements are augmented (or supplemented) by computer-generated sensory input such as sound, video, graphics or GPS data.

Inherent but only implicit in these definitions is the essential attribute of a mobile point of view. What differentiates Virtual or Augmented reality from the more general class of computer simulation, with or without any combination, fusion, synthesis, or integration with “real-time,”“direct” imaging of reality, either local or remote, is that the simulated or hybrid (augmented or “mixed”) reality “simul-real” images, is that the point of view of the viewer moves with the viewer as the viewer moves in the real world.

This disclosure proposes that this more precise definition is needed to distinguish between stationary navigation of immersively-displayed and experienced simulated worlds (simulators), and mobile navigation of simulated worlds (virtual reality). A sub-category of simulators then would be “personal simulators,” or at most, “partial virtual reality,” in which a stationary user is equipped with an immersive HMD (head mounted display) and haptic interface (e.g., motion-tracked gloves), which enable a partial “virtual-reality-like” navigation of a simulated world.

A CAVE system, would, on the other hand, qualify schematically as a limited virtual reality system, as navigation past the dimensions of the CAVE would only be possible by means of a moveable floor, and once the limits of the CAVE itself were reached, what would follow would be another form of “partial virtual reality.”

Note the difference between a “mobile” point of view and a “movable” point of view. Computer simulations, such as video games, are simulated worlds or “realities” but unless the explorer of that simulated world is personally in motion, or directing the motion of another person or robot, then all that can be said (though this one of the major accomplishments of computer graphics in the last forty years, simply “building” simulated environments which are, in software, explorable) is that the simulated world is “navigable.”

For a simulation to be either a virtual or hybrid (the author's preferred term) reality, an essential, defining characteristic is that there is a mapping of the simulation, whether entirely synthetic or hybrid, to a real space. Such a real space may be as basic as a room inside a laboratory or soundstage, and simply a grid that maps and calibrates, in some ratio, to the simulated world.

This differentiation is not evaluative, as a partial VR which provides real-time natural interface (head-tracking, haptic, auditory, etc.) without being mobile or mapping to an actual, real topography, whether natural, man-made, or hybrid, is not fundamentally less valuable than a partial VR system which simulates physical interaction and provides sensory immersion. But, without a podiatric feedback system, or more universally, a full-body, range-of-motion feedback system, and/or a dynamically-deformable mechanical interface-interaction surface which supports the users simulated but (to their senses) full-body movement over any terrain, any stationary, whether standing, sitting, or reclining, VR system is by definition, “partial.”

But, in the absence of such an ideal full-body physical interface/feedback system, limiting VR to a “full” and fully-mobile version would limit the terrains of the VR world to that which can be found in the real world, modified or built from scratch. Such a limitations would severely limit the scope and power of virtual reality experience in general.

But, as will be evident in the forthcoming disclosure, this differentiation makes a difference, as it sets the “bright line” for how existing VR and AR systems differ and their limitations, as well as providing background to inform the teaching of the present disclosure.

Having established the missing but essential characteristic and requirement of a simulation to be a complete “virtual reality,” the next step is to identify the implicit question of by what means is a “mobile point of view” realized. The answer is, to provide a view of the simulation which is mobile requires two components, themselves realized by a combination of hardware and software: a moving image display means, by which the simulation can be viewed, and motion-tracking means, which can track the movement of the device which includes the display in 3 axes of motion, which means to measure position over time of a 3-dimensional viewing device from a minimum of three tracking points (two, if the measurements the device is mapped so that a the third position on a third axis can be inferred), and in relation to a 3-axis frame of reference, which can be any arbitrary 3D coordinate system mapped to a real space, although for practical purposes of mechanically navigating the space, the 2 axes will form a plane that is a ground plane, gravitationally level, and the third axis, the Z, is normal to that ground plane.

The solutions to practically achieving this positional orientation, accurately and frequently as a function of time, requires a combination of sensors and software, and the advances in these solutions represents a major vector in the development of the field of both VR and AR hardware/software mobile viewing devices and systems.

These being relatively new fields, in terms of the time-frame between the earliest experiments and present-day, practical technologies and products, it is sufficient to make note of the origins and then the current state-of-the-art in both categories of mobile visual simulation systems, with exceptions only made for particular innovations in the prior art which are of significance to the development of the present disclosure or in relation to significant points of difference or similarity which serve to better explain either the current problems in the field or what distinguishes the solutions of the present disclosure from the prior art.

The period from 1968 through the late nineties spans a period of many innovations in related simulation and simulator, VR and AR fields, in which many of the key problems in achieving practical VR and AR found initial or partial solutions.

The seminal experiments and experimental head-mounted display systems of Ivan Sutherland and his assistant Bob Sprouell from 1968 are commonly considered to mark the origin of these related fields, although earlier work, essentially conceptual development had preceded this, the first experimental implementation of any form of AR/VR achieving immersion and navigation.

The birth of stationary simulator systems may be traced to the addition of computer-generated imaging to flight simulators, which is generally recognized to have begun in the mid-late 1960's. This was limited to the use of CRT's, displaying a full-focus image at the distance of the CRT from the user, until 1972, when the Singer-Link company debuted a collimated projection system which projected a distant-focus image through a beam-splitter-mirror system, which improved the field of view to about 25-35 degrees per unit (100 degrees with three units employed in a single-pilot simulator).

This benchmark was only improved by the Rediffusion Company in 1982, with the introduction of a wide-field of view system, the Wide Angle Infinity Display System, which realized 150 and then eventually 240 degree FOV through the use of multiple projectors and a large, curved collimating screen. It was at this stage where stationary simulators might be described as finally achieving a significant degree of real immersion in a virtual reality, with the use of an HMD to isolate the viewer and eliminate visual cue distractions from the periphery.

But at the time the Singer-Link Company was introducing its screen collimation system for simulators, as stepping-stones to a VR-type experience, the first very-limited commercial helmet-mounted displays were first being developed for military use, which integrated a reticle-based electronic targeting system with motion-tracking of the helmet itself. These initial developments are generally recognized to have been achieved in rudimentary form by the South African Air Force in the 1970's (followed by the Israeli Air Force between then and the mid-seventies), and may be said to be the start of a rudimentary AR or mediated/hybrid reality system.

These early, graphically-minimal but still seminal helmet-mounted systems, which implemented a limited compositing of positionally-coordinated targeting information overlaid on a reticle and user-actuated motion-tracked targeting, was followed by the invention by Steve Mann of the first “mediate reality” mobile view-through system, the first generation “EyeTap,” which superimposed graphics on glasses.

Later versions by Mann have employed an optical recombination system, based on a beam-splitter/combiner optic merging real and processed-imagery. This work preceded later work by Chunyu Gao and Augmented Vision Inc, which essentially proposes a dual Mann system, combining processed real image and a generated image optically, where Mann's system accomplished both processed-real and generated electronically. In Man's system, real-view through imagery is retained, but in Gao's system all view-through imagery is processed, eliminating any direct view-through imagery even as an option. (Chunyu Gao, US Patent Application 20140177023, filed Apr. 13, 2013). The “light-path folding optics” structures and methods specified by Gao's system are found in other optical HMD systems.

By 1985, Jaron Lanier and VPL Reseearch was formed to develop HMD's and the “data glove,” so there were, by the 1980's three major development paths for simulation, VR and AR, with Mann, Lanier, and the Redefussion Company, among a very active field of development, credited with some of the most critical advances and establishing of some basic solution-types, which in most cases persist to the present day and state of the art.

Sophistication of computer generated imaging (CGI), continued improvement in game machines (hardware and software) with real-time, interactive CG technology, larger system integration among multiple systems, and extension of both AR, and to a more limited degree, VR mobility were among the major development trends of the 1990's

What was both a limited form of mobile VR and a new kind of simulator was the CAVE system, developed at the Electronic Visualization Laboratory at the University of Illinois, Chicago, and debuted to the world in 1992. (Carolina Cruz-Neira, Daniel J. Sandin, Thomas A. DeFanti, Robert V. Kenyon and John C. Hart. “The CAVE: Audio Visual Experience Automatic Virtual Environment”, Communications of the ACM, vol. 35(6), 1992, pp. 64-72.) Instead of Lanier's HMD/data glove combination, the CAVE combined a WFOV multi-wall simulator “stage” with haptic interfaces.

Concurrently, a form of stationary partial-AR was being developed at the Armstrong US Air Force Research Lab by Louis Rosenberg, with his “Virtual Fixtures” system (1992), while Jonathan Waldern's stationary “Virtuality” VR systems, which have been recognized as under initial development from as early as 1985 through 1990, were to debut commercially in 1992 as well.

Mobile AR, integrated into a multi-unit mobile vehicle “wargame” system, combining real and virtual vehicles in an “augmented simulation” (“AUGSIMM”) was to see its next major advance in the form of the Loral WDL, demonstrated to the trade in 1993. Writing afterwards in 1999, “Experiences and Observations in Applying Augmented Reality to Live Training,” a project participant, Jon Barrilleaux of Peculiar Technologies, commented on the findings of the final 1995 SBIR report, and noted what are, even up to the present time, continued issues facing mobile VR and (mobile) AR:

AR vs. VR Tracking

In general, commercial products developed for VR have good resolution but lack the absolute accuracy and wide area coverage necessary for AR, much less for their use in AUGSIM.

VR applications—where the user is immersed in a synthetic environment—are more concerned with relative tracking than in absolute accuracy. Since the user's world is completely synthetic and self-consistent the fact that his/her head just turned 0.1 degrees is much more important than knowing within even 10 degrees that it is now pointing due North.

AR systems, such as AUGSIM, do not have this luxury. AR tracking must have good resolution so that virtual elements appear to move smoothly in the real world as the user's head turns or vehicle moves, and it must have good accuracy so that virtual elements correctly overlay and are obscured by objects in the real world.

As computational and network speeds continued to improve during the nineties, new projects in open-air AR systems were initiated, including at the US Naval Research Laboratory, with the BARS system, “BARS: Battlefield Augmented Reality System,” Simon Julier, Yohan Baillot, Marco Lanzagorta, Dennis Brown, Lawrence Rosenblum; NATO Symposium on Information Processing Techniques for Military Systems, 2000. From the Abstract: “The system consists of a wearable computer, a wireless network system and a tracked see-through Head Mounted Display (HMD). The user's perception of the environment is enhanced by superimposing graphics onto the user's field of view. The graphics are registered (aligned) with the actual environment.”

Non-military-specific developments were underway as well, including the work of Hirokazu Kato, the ARToolkit, at the Nara Institute of Science and Technology and later published and further developed at HITLab, which introduced a software development suite and protocol for viewpoint tracking and virtual object tracking.

These milestones are frequently cited as most significant during this period, although other researchers and companies were active in the field.

While military funding for large-scale development and testing of AR for training-simulation is well-documented, and the need for such obvious, other system-level designs and system demonstrations were underway concurrently with military-funded research efforts.

Among the most important non-military experiments was the AR version of the video game Quake, ARQuake, a development initiated and led by Bruce Thomas at the Wearable Computer Lab at the University of South Australia, and published in “ARQuake: An Outdoor/Indoor Augmented Reality First Person Application,” 4th International Symposium on Wearable Computers, pp 139-146, Atlanta, Ga., October 2000; (Thomas, B., Close, B., Donoghue, J., Squires, J., De Bondi, P., Morris, M., and Piekarski, W.). From the Abstract: “We present an architecture for a low cost, moderately accurate six degrees of freedom tracking system based on GPS, digital compass, and fiducial vision-based tracking.”

Another system which began design development in 1995 was one developed by the author of the present disclosure. Initially intended to realize a hybrid of open-air AR and television programing, dubbed “Everquest Live,” the design was further developed through the late nineties, with the essential elements finalized by 1999, when a commercial effort to fund the original video game/tv hybrid was launched, and which by then included another version, for use in a high-end themed resort development. By 2001, it was being disclosed on a confidential basis to companies including the Ridley and Tony Scott companies, in particular their joint venture, Airtightplanet (other partners including Renny Harlin, Jean Giraud, and the European Heavy Metal), for which the author of the present disclosure served as an executive overseeing operations and to which he brought the then “Otherworld” and “Otherworld Industries” project and venture as a proposed joint venture for investment and collaboration with ATP.

The following is a summary of the system design and components as they were finalized by 1999/2000:

Excerpt from “Otherworld Industries Business Proposal Document” (archive document version, 2003):

Technical Backgrounder: Proprietary Integration of State of the Art Technologies “Open-field” Simulation and Mobile Virtual Reality: Tools, Facilities and Technologies

This is only a partial list and summary of relevant techniques, that together form the backbone of a proprietary system. Some technology components are proprietary, some from outside vendors. But the unique system that combines the proven components will be absolutely proprietary

and revolutionary:

Interacting with a Vr-Altered World:

1) Mobile Military-grade VR equipment for immersion of the guest/participants and actors in the VR-augmented landscape of the OTHERWORLD. While their “adventure” (that is, their every motion as they explore the OTHERWORLD around the resort) is being captured in real-time by the mobile motion-capture sensors and digital cameras (with automatic matting technology), guest/players and employee/actors can see each other through their visors along with overlays of computer simulation imagery. Visors are either binocular, semi-transparent flat panel displays, or binocular, but opaque flat panel displays with binocular cameras affixed to the front.

These “synthetic elements,” superimposed by the flat panel displays in the field of view, can include altered portions of the landscape (or the entire landscape, altered digitally). In effect, those portions of “synthetic” landscape that replace what is really there are generated based on original 3D photographic “captures” of every part of the resort. (See #7 below). As accurate, photo-based geometric “virtual spaces” in the computer, it is possible to digitally alter them in any way, while maintaining the photo-real quality and geometric/spatial accuracy of the original capture. This makes for accurate combination of live digital photography of the same space and altered digital portions.

Other “synthetic elements” superimposed by the flat panel display include people, creatures, atmospheric FX, and “magic” which are computer generated or altered. These appear as realistic elements of the field of view through the displays (transparent or opaque).

Through use of positioning data, motion-capture data of the guests/players and employee/actors, and real-time matting of the same by multiple digital cameras, all of which are calibrated to the previously “captured” versions of each area of the resort (see #4 & 5 below), synthetic elements can be matched with absolute accuracy, in real time, to the real elements shown through the display.

Thus a photo-real computer-generated dragon can appear to pass behind a real tree, come back around, and then fly up and land on top of the real castle of the resort—which the dragon can then “burn” with computer-generated fire. In the flat panel display (semi-transparent or opaque), the fire appears to leave the upper portion of the castle “blackened.” This effect is achieved because through the visor, the upper portion of the castle has been “matted-over” by a computer altered version of a 3D “capture” of the castle in the system's file.

2) Physical Electro-optic-mechanical Gear for combat between real people and virtual people, creatures and FX. “Haptic” interfaces that provide motion-sensor and other data, as well as vibrational and resistance feedback, allow real-time interaction of real people with virtual people, creatures, and magic. For example, a haptic device in the form of a “prop” sword haft provides data while the guest/player is swinging it, and physical feedback when the guest/player appears to “strike” the virtual ogre, to achieve the illusion of combat. All of this is combined in real-time and displayed through the binocular flat panel displays.

3) Open-field Motion-capture equipment. Mobile and fixed motion capture equipment rigs, (similar to those used for The Matrix movies), are deployed throughout the resort grounds. Data points on the themed “gear” worn by guest/players and employee/actors are tracked by cameras and/or sensors to provide motion data for interaction with virtual elements in the field of view displayed on the binocular flat-panels in the VR visor.

The output from the motion-capture data makes possible (with sufficient computational rendering capacity and employment of motion-editing and motion-libraries) CGI altered versions of guests/players and employee/actors along the principle of the Gollum character in the second and third films of The Lord of the Rings.

4) Augmentation of Motion-capture Data with LAAS & GPS data, live laser range-finding data and triangulation techniques (including from Moller Aerobot UAV's). Additional “positioning data” allow for even more effective (and error-correcting) integration of live and synthetic elements.

From a news release by a UAV manufacturer:

July 17th. One week ago a contract was given to Honeywell for the initial network of Local Area Augmentation System (LAAS) stations, and a few test stations are already in operation. This system will make it possible to guide aircraft accurately to touchdown at airports (and vertiports) with an accuracy of inches. The LAAS system is expected to be operational by 2006.

5) Automatic Real-time Matting of Open-field “Play.” In combination with the motion-capture data allowing interaction with simulated elements, resort guest/participants will be digitally imaged with P24 (or equivalent) digital cameras, working with proprietary Automatte software, to automatically isolate (matte) the proper elements from the field of view to be integrated with synthetic elements. This technique will be one of a suite used to ensure proper separation of foreground/background when superimposing digital elements.

6) Military-grade Simulation Hardware and Technology combined with state-of-the-art Game Engine Software. Combining the data from the motion-capture system, haptic devices for interacting with “synthetic” elements like prop swords, synthetic elements and live elements (matted or complete), is integrated by military simulation software and game engine software.

These software components provide AI code to animate synthetic people and creatures (AI—or artificial intelligence—software such as the Massive software used to animate the armies in The Lord of the Rings movies), generate realistic water, clouds, fire, etc, and otherwise integrate and combine all elements, just as computer games and military simulation software do.

7) Photo-based capture of real locations to create the realistic digital virtual sets with image-based techniques, pioneered by Dr. Paul Debevec (basis of the “bullet-time” FX for The Matrix).

The “base” virtual locations (interiors and exteriors of the resort) are indistinguishable from the real world, as they are derived from photographs and the real lighting of the location when “captured.” A small set of high-quality digital images, combined with data from light probes and laser-range finding data, and the appropriate “image-based” graphics software are all that are needed to recreate a photo-real virtual 3D space in the computer that matches the original exactly.

Though the “virtual sets” are captured from the real castle interiors and the exterior locations in the surrounding countryside, once digitized these “base” or default versions, with the lighting parameters and all the other data from the exact time when originally captured, can be altered, including the lighting, with elements added that don't exist in the real world, and with the elements that do exist altered and “dressed” to create a fantasy version of our world.

When guest/players and employee/actors cross the “gateways” at various points in the resort (the “gateways” are the effective “crossing points” from “Our World” to the “Otherworld”), a calibration procedure takes place. Positioning data from the guest/player or employee/actor at the “gateway” are taken at that moment to “lock” the virtual space in the computer to the coordinates of the “gateway.” The computer “knows” the coordinates of the gateway points with respect to its virtual version of the entire resort, obtained through the image-based “capture” process described above.

Thus, the computer can “line up” its virtual resort with what the guest/player or employee/actor sees before they put in the VR goggles. And therefore, through a semi-transparent version of the binocular flat panel displays, if the virtual version were superimposed over the real resort, the one would match up with the other very precisely.

Alternatively, with an “opaque” binocular flat panel display goggle or helmet, the wearer could confidently walk with the helmet on, seeing only the virtual version of the resort in front of him, because the landscape of the virtual world would match exactly the landscape he is actually walking on.

Of course, what could be shown to him through the goggles would be an altered red sky, boiling storm clouds that aren't really there, and a castle parapet with a dragon perched on top, having just “set fire” to the castle battlements.

As well as an army of 1000 Orcs charging down the hill in the distance!

8) Supercomputer Rendering and Simulation Facility at the Resorts. A key resource that will make possible the extremely high-quality, near feature-film quality simulations will be a supercomputer rendering and simulation complex in situ at each resort.

The improvement in graphics and game play on standalone computer game consoles (Playstation 2, Xbox, GameCube), as well as computer games for desktop computers, is well-known.

Consider, however, that that improvement in the gaming experience is based on the improvement of the processors and supporting systems of a single console or personal computer. Imagine then putting the capacity of a supercomputing center behind the gaming experience. That alone would be a quantum leap in the quality of graphics and gameplay. And that is only one aspect of the mobile VR adventuring that will be the Otherworld experience.

As will be evident from a review of the foregoing, and which should be evident to those skilled in the relevant arts, which are the fields of VR, AR, and simulation more broadly, individual hardware or software systems that are proposed to improve the state-of-the-art must take into account the broader system parameters and make explicit those assumptions about those system parameters, to be properly evaluated.

The substance thus of the present proposal, the focus of which is a hardware technology system that falls under the category of portable AR and VR technologies, and is in fact of fusion of both, but which is in its most preferable versions a wearable technology, and in the preferred wearable version, is an HMD technology, only makes a complete case for being a superior solution by consideration or re-consideration of the entire system of which it is a part. Thus the need for presentation of this history of the larger VR, AR and simulation systems, because there is a tendency in proposals for and commercial offerings of new HMD technologies, for instance, to be too narrow, and not take into account, nor review, the assumptions, requirements, and new possibilities at the system level.

A similar historical review of the major milestones in the evolution of HMD technologies is not necessary, as it is the broader history at the system level that will be necessary to provide a framework that can be drawn upon to help explain the limitations of the prior art and status quo of the prior art in HMD's, and the reasons for the proposed solutions and why the proposed solution solves the identified problems.

What is sufficient to understand and identify the limitations of the prior art in HMD's begins with the following.

In the category of head mounted displays (which, for the purposes of the present disclosure, subsumes helmet-mounted displays), there have been identified up to now two main sub-types: VR HMD's and AR HMD's, following the implications of those definitions already provided herein, and within the category of AR HMD's, two categories have been employed to differentiate the types are either “video see-through” or “optical see-through” (more often simply termed “optical HMD.”

In VR HMD displays, the user views a single panel or two separate displays. The typical shape of such HMD's typically is that of a goggle or face-mask, although many VR HMD's have the appearance of a welder's helmet with a bulky enclosed visor. To ensure optimal video quality, immersion and lack of distraction, such systems are fully-enclosed, with the periphery around the displays a light-absorbent material.

The author of the present disclosure had previously proposed two types of VR HMD's, in U.S. Provisional Application “SYSTEM, METHOD AND COMPUTER PROGRAM PRODUCT FOR MAGNETO-OPTIC DEVICE DISPLAY” No. 60/544,591 filed Feb. 12, 2004 and incorporated herein. One the two simply proposed a replacing a conventional direct-view LCD with a wafer-type embodiment of the primary object of that application, the first practical magneto-optic display, whose superior performance characteristics include extremely high frame rate, among other advantages for an improved display technology overall, and in that embodiment, for an improved VR HMD.

The second version contemplated, according to the teachings of the disclosure, a new kind of remotely-generated image display, which would be generated, for instance, in a vehicle cockpit, and then transmitted, via fiber-optic bundle, and then distributed, through a special fiber-optic array structure (structures and methods for which were disclosed in the application), building on the experience of fiber-optic faceplates with a new approach and structure for remote image-transport via optical fiber.

While the core MO technology was not productized for HMD's initially, but rather for projection systems, these developments are of relevance to some aspects of the present proposal, and in addition are not generally known to the art. The second version, in particular, disclosed a method that was made public in advance of other, more recent proposals using optical fiber to convey a video image from image engine not integrated into or near the HMD optics.

A crucial consideration of the practicality of a fully-enclosed VR HMD to mobility, beyond a tightly controlled stage environment with even floors, is that for locomotion to be safe, the virtual world being navigated has to map 1:1, within a deviation safe to human locomotion, to a real surface topography or motion path.

However, as has been observed and concluded by researchers such as Barrilleaux from the Loral WDL, the developers of BARS, and consistently by other researchers in the field over the past nearly quarter century of development, for AR systems qua systems to be practical, a very close correspondence must be obtained between the virtual (synthetic, CG-generated imagery) and the real-world topography and built-environment, including (as is not surprising from the development of systems by the military for urban warfare) the geometry of moving vehicles.

Thus, it is more the general case that for either VR or AR to be enabled in mobile form, there must be a 1:1 positional correspondence between any “virtual” or synthetic elements and any real-world elements.

In the category of AR HMD's, the distinction between “video see-through” and “optical see-through” is the distinction between the user looking directly through a transparent or semi-transparent pixel array and display, which is disposed directly in front of the viewer, as part of the glasses optic itself, and looking through a semi-transparent projected image on an optic element also disposed directly in front of the viewer, generated from a (typically directly adjacent) micro-display and conveyed through forms of optical relay to the facing optic piece.

The main and possibly only partly-practical type of direct view-through display a transparent or semi-transparent display system has (historically) been an LCD configured without an illumination backplane—therefore, specifically, the AR video view-through glasses hold a viewing optic(s) which includes a transparent optical substrate onto which has been fabricated a LCD light modulator pixel array.

For applications similar to the original Mann “EyeTap”, in which text/data are displayed either directly or projected on the facing optics, calibration to real-world topography and objects is not required, though some degree of positional correlation is helpful for contextual “tagging” of items in the field of view with information text. Such is the stated primary purpose of the Google Glass product, although as the drafting of this disclosure, a great many developers are focused on development AR-type applications which super-impose more than text on the live scene.

A major problem of such “calibration” to topography or objects in the field of view of the user of either a video or optical see-through system, other than a loose proximate positional correlation in an approximate 2D plane or rough viewing cone, is the determination of relative position of objects in the environment of the viewer. Calculation of perspective and relative size, without significant incongruities, cannot be performed without either reference and/or roughly real-time spatial positioning data and 3D mapping of the local environment.

A key aspect of perspective, from any viewing point, in addition to relative size, is realistic lighting/shading, including drop shadows, depending on lighting direction. And finally, occlusion of objects from any given viewing positioning, is a key optical characteristic of perceived perspective and relative distance and positioning.

No video see-through or optical see-through HMD exists or can be designed in isolation from the question of how such data is provided to enable, in either video or optical view-through-type systems, or indeed for mobile VR-type systems, dimensional viewing of the wearers surroundings, essential so safe locomotion or path-finding. Will such data be provided externally, locally, or a combination of sources? If in part local and part of the HMD, how does this affect the design and performance of the total HMD system? What affect, if any, does this question have on the choice between video and optical-see-through, given weight, balance, bulk, data processing requirements, lag between components, among other implications and affected parameters, and on the choice of display and optical components in detail?

Among the technical parameters and problems to be solved during the evolution and advances in VR HMD's, have been included principally the problems of increasing field of view, reducing latency (lag between motion-tracking sensors and changes in the virtual perspective), increasing resolution, frame-rate, dynamic range/contrast, and other general display quality characteristics, as well as weight, balance, bulk, and general ergonomics. The details of image collimation and other display optics have improved to effectively address the problem of “simulator sickness” that was a major issue from the early days.

Display, optics and other electronics weight and bulk have tended to diminish over time with the improvements in these general categories of technologies, as well as weight, size/bulk and balance.

Stationary VR gear has generally been employed for night-vision systems in vehicles, including aircraft; mobile night-vision goggles, however, can be considered a form of mediated viewing similar to mobile VR, because essentially what the wearer is viewing is a real scene (IR-imaged) in real-time, but through a video screen(s), and not in a form of “view-through.”

This sub-type is similar to what Barrilleaux defined, in the same referenced 1999 retrospective, as an “indirect view display.” He offered his definition with respect to a proposed AR HMD in which there is no actual “view-through,” but rather what is viewed is exclusively a merged/processed real/virtual image on a display, presumably as contained as any VR-type or night-vision system.

A night vision system, however, is not a fusion or amalgam of virtual-synthetic landscape and real, but rather a direct-transmitted video image of IR sensor data as interpreted, through video signal processing, as a monochrome image of varying intensity, depending on the strength of the IR signature. As a video image, it does lend itself to real-time text/graphics overlay, in the same simple form in which the Eyetap was originally conceived, and as Google has stated is the intended primary purpose for its Glass product.

The problem of how and what data to extract live or provide from reference, or both, to either a mobile VR or mobile AR system, or now including this hybrid live processed video-feed “indirect view display” that has similarities to both categories, to enable an effective integration of the virtual and the real landscape to provide a consistent-cued combined view is a design parameter and problem that must be taken into account in designing any new and improved mobile HMD system, regardless of type.

Software and data processing for AR has been advanced to deal with these issues, building on the early work of the system developers referenced already. And example of this is the work of Matsui and Suzuki, of Canon Corporation, as disclosed in their pending U.S. patent application, “Mixed reality space image generation method and mixed reality system,” (U.S. patent application Ser. No. 10/951,684 (US Publication No. 20050179617—Now U.S. Pat. No. 7,589,747), filed Sep. 29, 2004). Their Abstract:

“A mixed reality space image generation apparatus for generating a mixed reality space image formed by superimposing virtual space images onto a real space image obtained by capturing a real space, includes an image composition unit (109) which superimposes a virtual space image, which is to be displayed in consideration of occlusion by an object on the real space of the virtual space images, onto the real space image, and an annotation generation unit (108) which further imposes an image to be displayed without considering any occlusion of the virtual space images. In this way, a mixed reality space image which can achieve both natural display and convenient display can be generated.”

The purpose of this system was designed to enable combination of a fully-rendered industrial product, such as a camera, to be superimposed on a mockup (stand-in prop); both a pair of optical view-through HMD glasses and the mockup are equipped with positional sensors. A real-time pixel-by-pixel look-up comparison process is employed to matte out the pixels from the mockup so that the CG-generated virtual model can be superimposed on a composited video feed (buffer-delayed, to enable the layering with a slight lag). Annotation graphics are also added by the system. Computer graphics. The essential sources of data to determine matting and thus ensure correct and not erroneous occlusion in the composite is the motion sensor on the mockup and the pre-determined lookup table that compares pixels to pull a hand matte and a mockup matte.

While this system does not lend itself to generalization for mobile AR, VR, or any hybrids, it is an example of an attempt to provide a simple, though not entirely automatic, system for analyzing a real 3D space and positioning virtual objects properly in perspective view.

In the domain of video or optical see-through HMD's, little progress has been made in designing a display or optics and display system which can implement, even under the assumption of an ideally calculated mixed-reality perspective view delivered to the HMD, a satisfactory, realistic and accurate merged perspective view, including the handling of the proper order of perspective an proper occlusion of merged elements from any given viewer position in real-space.

One system claiming the most effective solution, even if partial, to this problem, and perhaps the only integrated HMD system (as opposed to software/photogrammetrics/data-processing and delivery systems designed to solve those issues in some generic fashion, independent of HMD), has been referenced in the preceeding already, which is the proposal of Chunyu Gao in U.S. patent application Ser. No. 13/857,656 (US Publication No. 20140177023), “APPARATUS FOR OPTICAL SEE-THROUGH HEAD MOUNTED DISPLAY WITH MUTUAL OCCLUSION AND OPAQUENESS CONTROL CAPABILITY.”

Gao begins his survey of the field of view-through HMDS for AR with the following observations:

There are two types of ST-HMDs: optical and video (J. Rolland and H. Fuchs, “Optical versus video see-through head mounted. displays,” In Fundamentals of Wearable Computers and Augmented Reality, pp. 113-157, 2001.). The major drawbacks of the video see-through approach include: degradation of the image quality of the see-through view; image lag due to processing of the incoming video stream; potentially loss of the see-through view due to hardware/software malfunction. In contrast, the optical see-through HMD (OST-HMD) provides a direct view of the real world through a beamsplitter and thus has minimal affects to the view of the real world. It is highly (preferred in demanding applications where a user's awareness to the live environment is paramount.

However, Gao's observations of the problems with video see-through are not qualified, in the first instance, by specification of prior art video see-through as being exclusively LCD, nor does he validate the assertion that LCD must (comparatively, and to what standard is also omitted) degrade the see-through image. Those skilled in the art will recognize that this view, of a poor-quality image, is derived from the results achieved in early view-through LCD systems, prior to the recent acceleration of advances in the field. It is not ipso-facto true nor evident that an optical see-through system, with the employment of by comparison many optical elements and the impacts of other display technologies on the re-processing or mediation of the “real” “see-through image”, by comparison to either state-of-the-art LCD or other video view-through display technologies, will relatively degrade the final result or be inferior to a proposal such as Gao's.

Another problem with this unfounded generalization is the presumption of lag in this category of see-through, as compared to other systems which also must process an input live-image. In this case, comparison of speed is a result of detailed analysis of the components and their performance, in aggregate, of competing systems. And finally, the conjecture of “potentially loss of see-through view to hardware/software” is essentially gratuitous, arbitrary, and not validated either by any rigorous analysis of comparative system robustness or stability, either between video and optical see-through schemes generally, or between particular versions of either and their component technologies and system designs.

Beyond the initial problem of faulty and biased representation of the comparatives in the fields, there are the qualitative problems of the solutions proposed themselves, including the omission and lack of consideration of the proposed HMD system as a complete HMD system, including as a component in a wider AR system, with the data acquisition, analysis and distribution issues that have been previously referenced and addressed. An HMD can not be allowed to treat as a “given” a certain level and quality of data or processing capacity for generation of altered or mixed images, when that alone is a significant question and problem, which the HMD itself and its design can either aid or hinder, and which simply cannot be offered as a given.

In addition, omitted from the specification of problem-solution are the complete dimension of the problem of visual integration of real and virtual in a mobile platform.

To take the disclosure and the system it teaches, specifically:

As has been described earlier in this background, the Gao proposal is to employ two display-type devices, as the specification of the spatial light modulator which will selectively reflect or transmit the live image is essentially the specification of an SLM for the same purposes as they are in any display application, operatively.

Output images from the two devices are then combined in a beam-splitter, combiner, which is assumed, without any specific explanation other than a statement about the precision of such devices, while line-up on a pixel-by-pixel basis.

However to accomplish this merger of two pixelated arrays, Gao specifies a duplication of what he refers to as “folded optics,” but is nothing essentially other than a dual version of the Mann Eyetap scheme, requiring in total two “folding optics” elements (e.g., planar grating/HOE or other compact prism or “flat” optics, one each for each source, plus two objective lens (one for wave-front from the real view, one at the other end for focus of the conjoined image, and a beam-splitter combiner).

Thus, multiple optical elements (for which he offers a variety of conventional optics variations), are required to: 1) collect light of the real scene via a first reflective/folding optic (planar-type grating/mirror, HOE, TIR prism, or other “flat” optics) and from there to the objective lens, pass it to the next planar-type grating/mirror, HOE, TIR prism, or other “flat” optics to “fold” the light path again, all of which is to ensure that the overall optical system is relatively compact and contained in a schematic set of two rectangular optical relay zones; from the folding optics, the beam is passed through the beam-splitter/combiner to the SLM; which then reflects or transmits, on a pixelated (sampled) basis, and thus passes the variably (variation from the real image contrast and intensity to modify grey scale, etc) modulated, now pixellated real-image back to the beam splitter/combiner. While the display generates, in sync, the virtual or synthetic/CG image, presumably also calibrated to ensure ease of integration with the modified, pixelated/sampled real wave-front, and is passed through the beam-splitter to integrate, pixel-for-pixel, with the multi-step, modified and pixelated sample of the real scene, from thence through an eyepiece objective lens, and then back to another “folding optics” element to be reflected out of the optical system to the viewers eye.

In total, for the modified, pixelated-sampled portion of the real image wave-front, passes through seven optical elements, not including the SLM, before it reaches the viewers eye; the display-generated synthetic image, only pass-through two.

While the problems of accurate alignments of optical image combiners, down to the pixel level, whether it is reflected light gathered from an image sample interrogated by laser or combining images generated small-featured SLM/display devices, maintaining alignments, especially under conditions of mechanical vibration and thermal stress, is considered non-trivial in the art.

Digital projection free-space optical beam-combining systems, which combine the outputs of high-resolution (2k or 4k) red, green and blue image engines (typically, images generated by DMD or LCoS SLM's are expensive achieving and maintaining these alignments are non-trivial. And some designs are simpler than in the case of the 7-element let of the Gao scheme.

In addition, these complex, multi-engine, multi-element optical combiner systems are not nearly as compact as is required for an HMD.

Monolithic prisms, such a the T-Rhomboid combiner developed and marketed by Agilent for the life-sciences market, have been developed specifically to address the problems that free-space combiners have exhibited in existing applications

And while companies such as Microvision and others have successfully deployed their SLM-based, originally-developed for micro-projection technology into HMD platforms, these optical setups are typically substantially less complicated than the Gao proposal.

In addition, it is difficult to determine what the basic rationale is for two image processing steps and calculation iterations, on two platforms, and why that is required to achieve the smoothing and integration of the real and virtual wave-front inputs, implementing the proper occlusion/opaquing of the combined scene elements. It would appear that Gao's biggest concern and problem to be solved is the problem of the synthetic image competing, with difficulty, against the brightness with the real image, and that the main task of the SLM thus seems to bring down, selectively, the brightness of portions of the real scene, or the real-scene overall. In general, it is also inferred that, while bringing down the intensity of an occluded real-scene element, for instance by minimizing the duration of a DMD mirror in reflective position in a time-division multiplexing system, the occluded pixel would simply be left “off,” although this is not specified by Gao, nor are the details of how the SLM will accomplish its image-altering function related.

Among the many parameters that will have to be both calculated, calibrated and aligned, include determination of the exactly what pixels from the real-field are the calibrated pixels to the synthetic ones. Without exact matching, ghost overlaps and mis-alignments and occlusions will multiply, particularly in a moving scene. The position of the reflective optical element that passes the real-scene wave-front portion to the objective lens has a real perspective position in relation to the scene which is, first, not identical to the perspective position of the viewer in the scene, as it is not flat nor positioned at dead center, and it is only a wave-front sample, not what the position. And furthermore, when mobile, also moving, and also not known to the synthetic image processing unit in advance. The number of variables in this system is extremely large by virtue of these facts alone.

If they were, and the objective of this solution made more specific, it might become clear that there may be simpler methods for accomplishing this than the use of a second display (in a binocular system, adding a total of 2 displays, the specified SLM's).

Second, it is clear on inspection of the scheme that if any approach would, by virtue of the durability of such a complex system with multiple, cumulative alignment tolerances, the accumulation of defects from original parts and wear-and-tear over time in the multi-element path, mis-alignment of the merged beam form the accumulated thermal and mechanical vibration effects, and other complications arising from the complexity of a seven-element plus optical system, it is this system that inherently poses a probably degradation, especially over time, of the exterior live image wave-front.

In addition, as has been noted at some length previously, the problem of computing the spatial relationship among real and virtual elements is a non-trivial one. Designing a system which must drive, from those calculations, two (and in a binocular system), four display-type devices, most likely of different types (and thus with differing color gamut, frame-rate, etc.), adds complication to an already demanding system design parameter.

Furthermore, in order to deliver a high-performance image without ghosting or lag, and without inducing eyestrain and fatigue to the visual system, a high frame rate is essential. However with the Gao system, the system design becomes slightly more simplified only with use of view-through, rather than reflective, SLM's; but even with the faster FeLCoS micro-displays, the frame rate and image speed is still substantially less than that of the MEMS device such as TI's DLP (DMD).

However, as higher resolution for HMD's is also desired, at the very least to achieve wider FOV, a recourse to a high-resolution DMD such as TI's 2k or 4k device means recourse to a very expensive solution, as DMD's with that feature size and number are known to have low yields, higher defect rates than can be typically tolerated for mass-consumer or business production and costs, a very high price point for systems in which they are employed now, such as digital cinema projectors marketed commercially by TI OEM's Barco, Christie, and NEC.

While it is an intuitively easy step to go from flat-optic projection technologies for optical see-through HMDS, such as Lumus, BAE, and others, where occlusion is neither a design objective nor possible within the scope and capabilities of these approaches, to essentially duplicating that approach and to modulate the real image, and then combine the two images using a conventional optical setup such as Gao proposes, while relying on a high number of flat optical elements to effect the combination and to do so in a relatively compact space.

To conclude the background review, and returning to the current leaders in the two general categories of HMD, optical see-through HMDs and classical VR HMD's, the current state of the art may be summarized as follows, noting that other variants optical see-through HMD's and VR HMD's are both commercially available as well as subjects of intense research and development, with a significant volume of both commercial and academic work, including product announcements, publishing and patent applications that have escalated substantially since the break-through produces from Google, Glass, and the Oculus VR HMD, the Rift:
Google, with Glass, the commercially-leading mobile AR optical HMD, has, at the time of this writing, established a breakthrough public visibility for and dominant marketing position for the optical see-through HMD category.

However, they followed others to market who had already been developing and fielding products in the primarily defense/industrial sectors, including Lumus and BAE (Q-Sight holographic waveguide technology). Among other recent market and research stage entries are found companies such as as TruLife Optics, commercializing research out of the UK National Physical Reality, also in the domain of holographic waveguides, where they claim a comparative advantage.

For many military helmet-mounted display applications, and for Google's official primary use-case for Glass, again as analyzed in the preceding, super-imposition of text and symbolic graphical elements over the view-space, requiring only rough positional correlation, may be sufficient for many initial, simple mobile AR applications.

However, even in the case of information display applications, it is evident that the greater the density of tagged information to items and topography in the view-space facing (and ultimately, surrounding) the viewer, the greater the need for spatial order/layering of tags to match the perspective/relative location of the elements tagged.

Overlap—i.e., partial occlusion of tags by real elements in the field of view, and not just overlap of the tags themselves, thus by necessity becomes a requirement of even a “basic” informational-display-purposed optical view-through system, in order to manage visual clutter.

As tags must in addition reflect not just relative position of the tagged elements in a perspective view of the real space, but also a degree of both automated (based on pre-determined or software-calculated) priority and real-time, user assigned priority, size of tags and degree of transparency, to name but two major visual cues employed by graphical systems to reflect informational hierarchy, must be managed and implemented as well.

The question then immediately arises, in detailed consideration of the problems of semi-transparency and overlap/occlusion of tags and super-imposed graphical elements, how to deal with question of relative brightness of the live-elements which are passed-through the optical elements of these basic optical see-through HMDs (whether monocular reticle-type or binocular full glasses-type) and the super-imposed, generated video display elements, especially in brightly lit outdoor lighting conditions and in very dimly-lit outdoor conditions. Night-time usage, to fully extend the usefulness of these display types, is clearly an extreme case of the low-light problem.

Thus, as we move past the most limited use-case conditions of the passive optical-see-through HMD type, as information density increases—which will be expected as such systems become commercially-successful and normally-dense urban or suburban areas obtain tagging information from commercial businesses—and as usage parameters under bright and dim conditions add to the constraints, it is clear that “passive” optical see-through HMD's cannot escape, nor cope with, the problems and needs of any realistic practical implementation of mobile AR HMD.

Passive optical pass-through HMD's must then be considered an incomplete model for implementing mobile AR HMD and will become, in retrospect, seen as only a transitional stepping stone to an active system.
Oculus Rift VR (Facebook) HMD: Somewhat paralleling the impact of the Google Glass product-marketing campaign, but with the difference that Oculus had actually also led the field in solving and/or beginning to substantially solve some of the significant threshold barriers to a practical VR HMD (rather than following Lumus and BAE, in the case of Google), the Oculus Rift VR HMD at the time of this writing is the leading pre-mass-release VR HMD product entering and creating the market for widely-accepted consumer and business/industrial VR.

The basic threshold advances of the Oculus Rift VR HMD may be summarized in the following product feature list:
Significantly Widened Field of View, achieved by using a single currently 7″ diagonal display of 1080p resolution, positioned several inches from the users eyes, and divided into binocular perspective regions on the unitary display. Current FOV, as if this writing, is 100 degrees (improving their original 90 degrees), as compared to 45 degrees total, a common specification of pre-existing HMD's. Separate binocular optics implement the stereo-vision effect.
Significantly improved head-tracking, resulting in low lag; this is an improved motion-sensor/software advance, and taking advantage of miniature motion-sensor technology that had migrated from the Nintendo Wii, Apple and other fast-followers in mobile phone sensor technologies, Playstation PSP and now Vita, Nintendo DS now 3DS, and the Xbox Kinect system, among other handheld and handheld device products with built-in motion sensors for 3D-dimensional positional tracking (accelerometers, MEMS gyroscopes, etc.) Current head-tracking implements a multi-point infrared optical system, with an external sensor(s) working in concert.
Low latency, a combined result of improved head-tracking and fast-software-processor updating to an interactive game software system, although limited by the inherent response time of the display technology employed, originally LCD, which was replaced by somewhat faster OLED.
Low Persistence, which is a form of buffering to help keep the video stream smooth, working in combination with the higher-switching speed OLED display.
Lighter weight, reduced bulk, better balance, and overall improved ergonomics, by employing a ski-goggle form-factor/materials and mechanical platform.

To summarize the net benefit of combining these improvements, while the system as such may not have been structurally or operatively new in pattern, the net affect of improved components and a particularly effective design patent U.S. D701,206, as well as any proprietary software, has resulted in an breakthrough level of performance and validation of mass-market VR HMD.

Following their lead and adopting their approach, in many cases, with a few contemporaneous product programs in the case of others who have altered their designs based on the success of the Oculus VR Rift configuration, there have been a number of VR HMD product developers, both branded name companies and startups, which made product plan announcements following the original 2012 Electronic Expo demonstration and Kickstarter financing campaign by Oculus VR.

Among those fast-followers and others who evidently altered their strategies to follow the Oculus VR template, are Samsung, whose demonstrated development model as of this writing closely resembles the Oculus VR Rift design, and Sony's Morpheus. Startups which have gained notice in the field include Vrvana (formerly True Gear Player, GameFace, InfiniteEye, and Avegant.

None of these system configurations appear absolutely identical to Oculus VR, though some use 2 and others 4 panels, with the 4 panel system employed by InfiniteEye to widen the FOV to claimed 200+ degrees. Some use LCD and others use OLED. Optical sensors are employed to improve the precision and update speed of the head-tracking systems.

All of the systems are implemented for essentially in-place or highly-constrained mobility. The employ on-board and active-optical marker-based motion tracking systems designed for use in enclosed spaces, such as a living room, surgical theatre, or simulator stage.

The systems with the greatest difference from the Oculus VR scheme are Avegant's Glyph and the Vrvana Totem.

The Glyph actually implements a display solution which follows the previously established optical view-through HMD solution and structure, employing a Texas Instruments DLP DMD to generate a projected micro-image onto a reflective planar optic element, in configuration and operation the same as the planar optical elements of existing optical view-through HMDs, with the difference that a high-contrast, light absorbent backplane structure is employed to realize a reflective/indirect micro-projector display type, with an video image belonging in the general category of opaque, non-transparent display images.

Here, though, as has been established in the preceding in the discussions of the Gao disclosure, the limitations on increasing display resolution and other system performance beyond 1080p/2k, when employing a DLP DMD or other MEMS component are those of cost, manufacturing yield and defect rates, durability, and reliability in such systems.

In addition, limitations on image size/FOV from the limited expansion/magnification factor of the planar optic elements (gratings structures, HOE or other), which expands the SLM image size but and interaction/strain on the human visual system (HVS), especially the focal-system, present limitations on the safety and comfort of the viewer. User response to the employment of similar-sized but lower resolution images in the Google Glass trial suggest that further straining the HVS with a higher-resolution, brighter but equally small image area poses challenges to the HVS. Ophamologist Dr. Eli Peli, official consultant to Google, followed up an earlier warning in an interview with online site BetaBeat (May 19, 2014) to Google Glass users to anticipate some eye strain and discomfort with a revised warning (May 29, 2014) that sought to limit the cases and scope of potential usage. The demarcation was on eye muscles used in ways they are not designed or used to for prolonged periods of time, and proximate cause of this in the revised statement was the location of the small display image, forcing the user to look up. Other experts

However, the particular combination of eye-muscle usage required for focal usage on a small portion of the real FOV cannot be assumed to be identical to that required for eye-motion across an entire real FOV. The small, micro-adjustments of the focal muscles ipso facto are more constrained and restricted than the range of motion involved in scanning the natural FOV. Thus, the repetitive motion in constrictive ROM is, as is known to the field, not confined only to the direction of focus, although that will be expected, due to the nature of the HVS, to add to the over-strain beyond normal usage, but also to the constraints on range of motion and the requirements of making very small, controlled micro-adjustments.

The added complication is that the level of detail in the constrained eye-motion domain may begin to rapidly, as resolution increases in scenes with complex, detailed motion, exceed the eye fatigue from precision tool-work. No rigorous treatment of this issue has been reported by any developers of optical view-through systems, and these issues, as well as eye-fatigue, headaches, and dizziness problems that Steve Mann has reported over the years from using his EyeTap systems, (which were reportedly in-part improved by moving the image to the center of the field of view in the current Digital EyeTap update but which have not be systematically studied, either), have received only limited comment focused on only a portion of the issues and problems of eye-strain that can develop from near-work and “computer vision sickness.”

However, the limited public comment that Google has made available from Dr. Peli repeatedly asserts that, in general, that Glass as an optical view-through system is deliberately for occaisionaly, rather than prolongued or high-frequency viewing.

Another way to understand the Glyph scheme is that, a the highest level, follows the Mann Digital EyeTap system and structural arrangement, with the variation of implementation for light-isolated VR operation and the employing the lateral projected-planar deflection optical setup of the current optical-view through systems.

In the Vrvana Totem, the departure from the Oculus VR Rift is in adopting the scheme of Jon Barrilleaux's “indirect view display,” by adding binocular, conventional video cameras to allow toggling between a video-captured forward image capture and the generated simulation on the same optically-shrouded OLED display panel. Vrvana have indicated in marketing materials that they may implement this very basic “indirect view display,” exactly following the Barrilleaux-identified schematic and pattern, for AR. It is evident that virtually any of the other VR HMD's of the present Oculus VR generation could be mounted with such conventional cameras, albeit with impacts on weight and balance of the HMD, at a minimum.

It will be evident from the foregoing that little to no substantive progress has been made in the category of “vide see-through HMD” or in general, in the field of “indirect view display,” beyond the category of night-vision goggles, which as a sub-type has been well-developed, but which lacks any AR features other than provision, within the video processor methods known to the art, of adding text or other simple graphics to the live image.

In addition, with respect to the existing limitations to VR HMD's, all such systems employing OLED and LCD panels suffer from relatively low frame-rates, which contributes to motion lag and latency, as well as negative physiological affects on some users, belonging in the broad category of “simulator sickness.” It is noted as well that, in digital stereo-projection systems in cinemas, employing such commercially-available stereo systems as the RealD system, implemented for Texas Instruments DLP DMD-based projectors or Sony LCoS-based projectors, insufficiently high frame rate has also been reported as a contributing to a fraction of the audience, as high as 10% in some studies, experiencing headaches and related symptoms. Some of which are unique to those individuals, but for which a significant percentage are traceable to limitations on frame rate.

And, further, as noted, Oculus VR has implemented a “low persistence” buffering system in pat to compensate for the still insufficiently-high pixel switching/frame rate of the OLED displays which are employed at the time of this writing.

A further impact on the performance of existing VR HMD's is due to the resolution limitations of existing OLED and LCD panel displays, which in part contributes to the requirement of using 5-7″ diagonal displays and mounting them at a distance from the viewing optics (and viewers eyes) to achieve a sufficient effective resolution), contributes to the bulk, size and balance of existing and planned offerings, significantly larger, bulkier, and heavier than most other optical headwear products.

A potential partial improvement is expected to come from the employment of curved OLED displays, which may be expected to further improve FOV without adding bulk. But the expense of bringing to market, at sufficient volumes, requiring significant additional scale investments to fab capacity at acceptable yields, makes this prospect less practical for the near-term. And it would only partially address the problem of bulk and size.

For the sake of completeness, it is also necessary also to mention Video HMD's employed for viewing video content but not interactively or with any motion sensing capability, and thus without the capability for navigating a virtual or hybrid (mixed reality/AR) world. Such video HMD's have essentially improved over the past fifteen years, increasing in effective FOV and resolution and viewing comfort/ergonomics, and providing a development path and advances that current VR HMD's have been able to leverage and build upon for. But these, too, have been limited by the core performance of the display technologies employed, in pattern following the limitations observed for OLED, LCD and DMD-based reflective/deflective optical systems.

Other important variations on the projected image on transparent eyewear optic paradigm include those from Osterhoudt Design Group, Magic Leap, and Microsoft (Hololens).

While these variations possess some relative advantages or disadvantages—relative to each other and to the other prior art reviewed in detail in the preceding—they all retain the limitations of the basic approach.

Even more fundamentally and universally in-common, they are also limited by the basic type of display/pixel technologies employed, as the frame-rate/refresh of existing core display technologies, whether fast LC, OLED or MEMS, and whether employing a mechanical scanning-fiber input or other optics systems disclosed for conveying the display image to the viewing optics, all are still insufficient to meet the requirements of high-quality, easy-on-the-eyes (HVS), low power, high resolutions, high-dynamic range and other display performance parameters which separately and together contribute to realizing mass-market, high-quality enjoyable AR and VR.

To summarize the state of the prior art, with respect to the details covered in the preceding:
“High-acuity” VR has improved in substantially in many respects, from FOV, latency, head/motion tracking, lighter-weight, size and bulk.
But frame rate/latency and resolution, and to a significant corollary degree, weight, size and bulk, are limited by the constraints of core display technologies available.
And modern VR is restricted to stationary or highly-restricted and limited mobile use in small controlled spaces.
VR based on an enclosed version of the optical view-through system, but configured as a lateral projection-deflection system in which an SLM projects an image into the eye via a series of three optical elements, is limited in performance to the size of the reflected image, which is expanded but not much bigger than the output of the SLM (DLP DMD, other MEMS, or FeLCoS/LCoS), as compared to the total area of a standard eyeglass lens. Eye-strain risks from extended viewing of what is an extremely-intense version of “close-up work” and the demands this will make on the eye muscles is a further limitation on practical acceptance. And SLM-type and size displays are also limit a practical path to improved resolution and overall performance by the scaling costs of higher resolution SLM's of the technologies referenced.
Optical view-through systems generally suffer from the same potential for eye-strain by confinement of the eye-muscle usage to a relatively small area, and requiring relatively small and frequent eye-tracking adjustments within those constraints, and for more than brief period of usage. Google Glass was designed to reflect expectations of limited duration usage by positioning the optical element up, and out of the direct rest position of the eyes looking straight ahead. But users have reported eye-strain none-the-less, as has been widely document in the press by means of text and interviews from Google Glass Explorers.
Optical view-through systems are limited in overlaid, semi-transparent information density due to the need to organize tags with real-world objects in a perspective view. The demands of mobility and information density make passive optical-view through limited even for graphical information-display applications.
Aspects of “Indirect view display” have been implemented in the form of night-vision goggles, and Oculus VR competitor Vrvana has only made the suggestion of adapting its binocular video-camera equipped Totem for AR.
The Gao proposal, which although claimed to be an optical view-through display, is in reality more of “indirect view display,” with a quasi-view-through aspect, by means of the usage of an SLM device, functioning as such do in a modified for projection displays, for sampling a portion of a real wave-front and digitally altering portions of that wave-front.

The number of optical elements intervening in the optical routing of the initial wave-front portion (also, a point to be added here, much smaller than the optical area of a conventional lens in a conventional pair of glasses), which is seven or close to that number, introduces both opportunities for image aberration, artifacts, and losses, but requires a complex system of optical alignments in a field in which such complex free-space alignments of many elements are not common and when they are required, are expensive, hard to maintain, and not robust. The method by which the SLM is expected to manage the alteration of the wave-front of the real scene is also not specified nor validated for the specific requirement. Nor is the problem of coordinating the signal processing between 2-4 display-type devices (depending on monocular of binocular system), including determination of the exactly what pixels from the real-field are the calibrated pixels for the proper synthetic ones, in a context in which preforming calculations to create proper relationships between real and synthetic elements in perspective view is already extremely demanding, especially when the individual is moving in an information-dense, topographically complex environment. Mounted on a vehicle only compounds this problem further.

There are myriad additional problems for development of complete system, as compared to the task of building a optical set up as Gao proposes, or even of reducing it to a relatively compact-form factor. Size, balance, and weight are just one of many consequences to the number and by implication, necessary location of the various processing and optics arrays units, but as compared to the other problems and limitations cited, they are by relatively minor, though serious for the practical deployment of such a system to field use, either for military or ruggedized industrial usage or consumer usage.
A 100% “indirect-view display” will have similar demands in key respects to the Gao proposal, with the exception of the number of display-type units and particulars of the alignment, optical system, pixel-system matching, and perspective problems, and thus throws into question the degree to which all key parameters of such a system should require “brute force” calculations of the stored synthetic CG 3D mapped space in coordination with the real-time, individual perspective real-time view-through image. The problem become greater to the extent that the calculations must all be performed, with the video image captured by the forward video cameras, in the basic Barrilleaux and now possible Vrvana design, relayed to a non-local (to the HMD and/or t the wearer him/herself) processor for compositing with the synthetic elements.

What is needed for a truly mobile system, whether VR or AR, which implements both immersion and calibration to the real environment, is the following:
An ergonomic optics and viewing system that minimizes any non-normal demands on the human visual system. This is to enable more extended use, which is implied by mobile use.
A wide FOV, ideally including peripheral view, of 120-150 degrees.
High frame rate, ideally 60 fps/eye, to minimize latency and other artifacts that are typically due to the display.
High effective resolution, at comfortable distance of the unit from the face.

The effective resolution standard that may be used to gauge a maximum would either be effective 8k or “retina display.” This distance should be similar to that of conventional eyeglasses, which typically employ the bridge of the nose as a balance point. Collimation and optical path optics are necessary to establish a proper virtual focal plain that also implements this effective display resolution and actual distance of optical element(s) to the eye.
High dynamic range, matching as closely as possible the dynamic range of the live, real view.
On-board motion tracking to determine orientation of both head and body, in a known topography—whether known in advance or known just-in-time within the range of vision of the wearer. This may be supplemented by external systems, in a hybrid scheme.
A display-optics system which enables a fast compositing process, within the context of the human visual system, between the real scene wave-front and any synthetic elements. As many passive means should be employed as possible to minimize the burden on either on-board (to the HMD and wearer) and/or external processing systems.
A display-optics system that is relatively simple and rugged, with few optical elements, few active device elements, and simple active device designs which are both of minimal weight and thickness, and robust under mechanical and thermal stress.
Light weight, low bulk, balanced center of gravity, and form factor(s) which lend themselves to design configurations which are known to be acceptable to both specialized users, such as military and ruggedized-environment industrial users, ruggedizes sports applications, and general consume and business use. Such accepted from factors range from eyeglass manufacturers such as Oakley, Wiley, Nike, and Adidas, to slightly more specialized sport goggles manufacturers, such as Oakley, Adidas, Smith, Zeal and others.
A system which can toggle, variably, between a VR experience, while retaining full mobility, and a variable-occlusion, perspective-integrated hybrid viewing AR system.
A system which can both manage incoming wavelengths for the HVS and obtain effective information from those wavelengths of interest, via sensors, and hybrids of these. IR, visible and UV are typical wavelengths of interest.

### BRIEF SUMMARY OF THE INVENTION

Disclosed is a system and method for re-conceiving the process of capture, distribution, organization, transmission, storage, and presentation to the human visual system or to non-display data array output functionality, in a way that liberates device and system design from compromised functionality of non-optimized operative stages of those processes and instead de-composes the photonic-signal processing and array-signal processing stages into operative stages that permits the optimized function of devices best-suited for each stage, which in practice means designing and operating devices in frequencies for which those devices and processes work most efficiently and then undertaking efficient frequency/wavelength modulation/shifting stages to move back and forth between those “Frequencies of convenience,” with the net effect of further enabling more efficient all-optical signal processing, both local and long-haul.

The following summary of the invention is provided to facilitate an understanding of some of technical features related to signal processing, and is not intended to be a full description of the present invention. A full appreciation of the various aspects of the invention can be gained by taking the entire specification, claims, drawings, and abstract as a whole.

Enbodiments of this invention may involve decomposing the components of an integrated pixel-signal “modulator” into discrete signal processing stages and thus into a telecom-type network, which may be compact or spatially remote. The operatively most basic version proposes a three-stage “pixel-signal processing” sequence, comprising: pixel logic “state” encoding, which is typically accomplished in an integrated pixel modulator, which is separated from the color modulation stage, which is in turn separated from the intensity modulation stage. A more detailed pixel-signal processing system is further elaborated, which includes sub-stages and options, and which is more detailed and specifically-tailored to the efficient implementation of magneto-photonic systems, and consist in 1) an efficient illumination source stage in which bulk light, preferably non-visible near-IR, is converted to appropriate mode(s) and launched into channelized array and which supplies stage 2), pixel-logic processing and encoding; followed by 3) optional non-visible energy filter and recovery stage; 4) optional signal-modification stage to improve/modify attributes such as signal splitting and mode modification; 5) frequency/wavelength modulation/shifting and additional bandwidth and peak intensity management; 6) optional signal amplification/gain; 7) optional analyzer for completing certain MO-type light-valve switching; 8) optional configurations for certain wireless (stages) of Pixel-signal Processing and Distribution. In addition, a DWDM-type configuration of this system is proposed, which provides a version of and pathway to all-optical networks, with major attended cost and efficiencies to be gained thereby: specifically motivated and making more efficient the handling of image information, both live and recorded. And finally, new hybrid magneto-photonic devices and structures are proposed and others previously not practical for systems of the present disclosure enabled, to make maximal use of the pixel-signal processing system and around which such a system is optimally configured, including new and/or improved versions of devices based on the hybridization of magneto-optic and non-magneto-optic effects (such as slow light and inverse-magneto-optic effects), realizing new fundamental switches, and new hybrid 2D and 3D photonic crystal structure types which improve a many if not most MPC-type devices for all applications.

In the co-pending application by the inventor of the present disclosure, a new class of display systems is proposed, which de-compose the components of a typically integrated pixel-signal “modulator” into discrete signal processing stages. Thus, the basic logic “state” of what is typically accomplished in an integrated pixel modulator is separated from the color modulation stage which is separated from the intensity modulation stage. This may be thought of as a telecom signal-processing architecture applied to the problem of visible image pixel modulation. Typically, three signal-processing stages and three separate device components and operations are proposed, although additional signal-influencing operations may be added and are contemplated, including polarization characteristics, conversion from conventional signal to other forms such as polaritons and surface plasmons, superposition of signal (such as a base pixel on/off state superposed on other signal data), etc. Highly distributed video-signal processing architectures across broadband networks, serving relatively “dumb” display fixtures composed substantially of later stages of passive materials, is a major consequence, as well as compact photonic integrated circuit devices which implement discrete signal processing steps in series, on the same device or devices in intimate contact between separate devices, and in large arrays.

In the present disclosure of an improved and detailed version of a hybrid telecom-type, pixel-signal processing display system employing magneto-optic/magneto-photonic stages/devices in combination with other pixel-signal processing stages/devices, including especially frequency/wavelength modulation/shifting stages and devices, which may be realized in a robust range of embodiments, are also included improved and novel hybrid magneto-optic/photonic components, not restricted to classic or non-linear Faraday Effect MO effects but more broadly encompassing non-reciprocal MO effect and phenomena and combinations therefrom, and also including hybrid Faraday/slow-light effects and Kerr effect-based and hybrids of Faraday and MO Kerr effect-based devices and other MO effects; and also including improved “light-baffle” structures in which the path of the modulated signal is folded in-plane with the surface of the device to reduce overall device feature size; and also including quasi 2D and 3D photonic crystal structures and hybrids of multi-layer film PC and surface grating/poled PC; and also hybrids of MO and Mach-Zehnder interferometer devices.

Encompassing therefore both earlier MO-based devices as well as the improved devices disclosed herein, the present disclosure proposes a telecom-type or telecom-structured, pixel-signal processing system of the following process-flow of pixel signal processing (or, equally, PIC, sensor, or telecom signal processing) stages and thus, architectures (and variants thereof) characterizing the system of the present disclosure:

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an imaging architecture that may be used to implement embodiments of the present invention;

FIG. 2 illustrates an embodiment of a photonic converter implementing a version of the imaging architecture of FIG. 1 using a photonic converter as a signal processor;

FIG. 3 illustrates a general structure for a photonic converter of FIG. 2;

FIG. 4 illustrates a particular embodiment for a photonic converter;

FIG. 5 illustrates a generalized architecture for a hybrid photonic VR/AR system; and

FIG. 6 illustrates an embodiment architecture for a hybrid photonic VR/AR system.

### DETAILED DESCRIPTION OF THE INVENTION

Embodiments of the present invention provide a system and method for re-conceiving the process of capture, distribution, organization, transmission, storage, and presentation to the human visual system or to non-display data array output functionality, in a way that liberates device and system design from compromised functionality of non-optimized operative stages of those processes and instead de-composes the pixel-signal processing and array-signal processing stages into operative stages that permits the optimized function of devices best-suited for each stage, which in practice means designing and operating devices in frequencies for which those devices and processes work most efficiently and then undertaking efficient frequency/wavelength modulation/shifting stages to move back and forth between those “Frequencies of convenience,” with the net effect of further enabling more efficient all-optical signal processing, both local and long-haul. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another.

In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “functional device” means broadly an energy dissipating structure that receives energy from an energy providing structure. The term functional device encompasses one-way and two-way structures. In some implementations, a functional device may be component or element of a display.

As used herein, the term “display” means, broadly, a structure or method for producing display constituents. The display constituents are a collection of display image constituents produced from processed image constituent signals generated from display image primitive precursors. The image primitive precursors have sometimes in other contexts been referred to as a pixel or sub-pixel. Unfortunately the term “pixel” has developed many different meanings, including outputs from the pixel/subpixels, and the constituents of the display image. Some embodiments of the present invention include an implementation that separates these elements and forms additional intermediate structures and elements, some for independent processing, which could further be confused by referring to all these elements elements/structures as a pixel so the various terms are used herein to unambiguously refer to the specific component/element. A display image primitive precursor emits an image constituent signal which may be received by an intermediate processing system to produce a set of display image primitives from the image constituent signals. The collection of display image primitives producing an image when presented, by direct view through a display or reflected by a projection system, to a human visual system under the intended viewing conditions. A signal in this context means an output of a signal generator that is, or is equivalent to, a display image primitive precursor. Importantly, that as long as processing is desired, these signals are preserved as signals within various signal-preserving propagating channels without transmission into free space where the signal creates an expanding wavefront that combines with other expanding wave fronts from other sources that are also propagating in free space. A signal has no handedness and does not have a mirror image (that is there is not a reversed, upside-down, or flipped signal while images, and image portions, have different mirror images). Additionally, image portions are not directly additive (overlapping one image portion on another is difficult, if at all possible, to predict a result) and it can be very difficult to process image portions. There are many different technologies that may be used as a signal generator, with different technologies offering signals with different characteristics or benefits, and differing disadvantages. Some embodiments of the present invention allow for a hybrid assembly/system that may borrow advantages from a combination of technologies while minimizing disadvantages of any specific technology. Incorporated U.S. patent application Ser. No. 12/371,461, describes systems and methods that are able to advantageously combine such technologies and the term display image primitive precursor thus covers the pixel structures for pixel technologies and the sub-pixel structures for sub-pixel technologies.

As used herein, the term “signal” refers to an output from a signal generator, such as a display image primitive precursor, that conveys information about the status of the signal generator at the time that the signal was generated. In an imaging system, each signal is a part of the display image primitive that, when perceived by a human visual system under intended conditions, produces an image or image portion. In this sense, a signal is a codified message, that is, the sequence of states of the display image primitive precursor in a communication channel that encodes a message. A collection of synchronized signals from a set of display image primitive precursors may define a frame (or a portion of a frame) of an image. Each signal may have a characteristic (color, frequency, amplitude, timing, but not handedness) that may be combined with one or more characteristics from one or more other signals.

As used herein, the term “human visual system” (HVS) refers to biological and psychological processes attendant with perception and visualization of an image from a plurality of discrete display image primitives, either direct view or projected. As such, the HVS implicates the human eye, optic nerve, and human brain in receiving a composite of propagating display image primitives and formulating a concept of an image based on those primitives that are received and processed. The HVS is not precisely the same for everyone, but there are general similarities for significant percentages of the population.

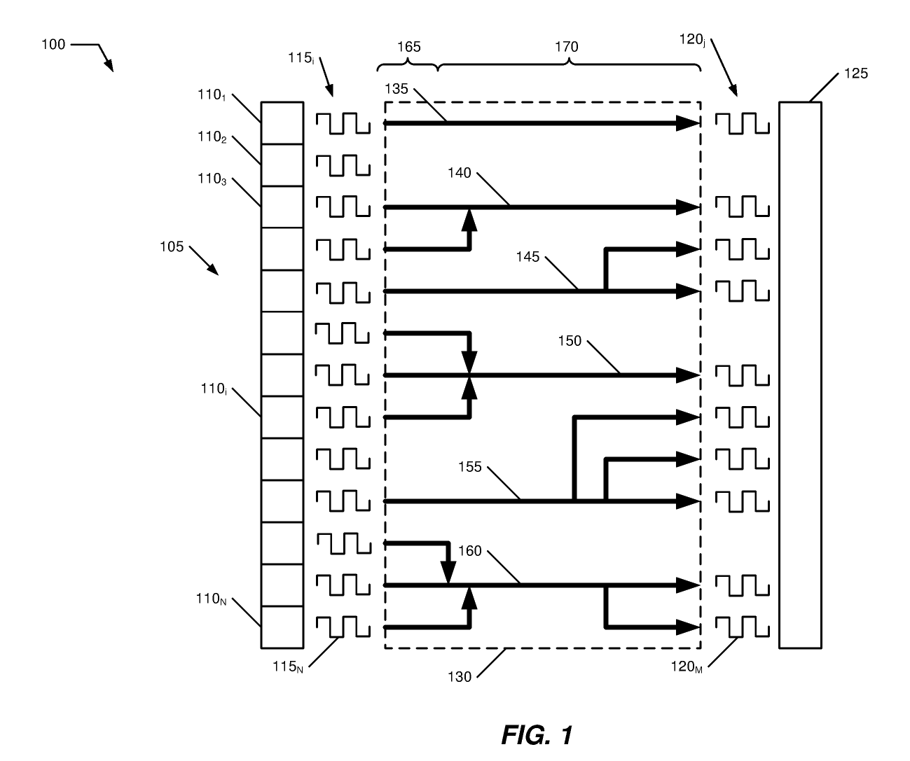

FIG. 1 illustrates an imaging architecture 100 that may be used to implement embodiments of the present invention. Some embodiments of the present invention contemplate that formation of a human perceptible image using a human visual system (HVS)—from a large set of signal generating structures includes architecture 100. Architecture 100 includes: an image engine 105 that includes a plurality of display image primitive precursors (DIPPs) 110ᵢ, i=1 to N (N may be any whole number from 1 to tens, to hundreds, to thousands, of DIPPs). Each DIPP 110i is appropriately operated and modulated to generate a plurality of image constituent signals 115ᵢ, i=1 to N (an individual image constituent signal 115ᵢ from each DIPP 110ᵢ). These image constituent signals 115ᵢ are processed to form a plurality of display image primitives (DIPs) 120ⱼ, j=1 to M, M a whole number less than, equal to, or greater than N. An aggregation/collection of DIPs 120ⱼ (such as 1 or more image constituent signals 115ᵢ occupying the same space and cross-sectional area) that will form a display image 125 (or series of display images for animation/motion effects for example) when perceived by the HVS. The HVS reconstructs display image 125 from DIPs 120ⱼ when presented in a suitable format, such as in an array on a display or a projected image on a screen, wall, or other surface. This is familiar phenomenon of the HVS perceiving an image from an array of differently colored or grey-scales shadings of small shapes (such as “dots”) that are sufficiently small in relation to the distance to the viewer (and HVS). A display image primitive precursor 110ᵢ will thus correspond to a structure that is commonly referred to as a pixel when referencing a device producing an image constituent signal from a non-composite color system and will thus correspond to a structure that is commonly referred to as a sub-pixel when referencing a device producing an image constituent signal from a composite color system. Many familiar systems employ composite color systems such as RGB image constituent signals, one image constituent signal from each RGB element (e.g., an LCD cell or the like). Unfortunately, the term pixel and sub-pixel are used in an imaging system to refer to many different concepts—such as a hardware LCD cell (a sub-pixel), the light emitted from the cell (a sub-pixel), and the signal as it is perceived by the HVS (typically such sub-pixels have been blended together and are configured to be imperceptible to the user under a set of conditions intended for viewing). Architecture 100 distinguishes between these various “pixels or sub-pixels” and therefore a different terminology is adopted to refer to these different constituent elements.

Architecture 100 may include a hybrid structure in which image engine 105 includes different technologies for one or more subsets of DIPPs 110. That is, a first subset of DIPPs may use a first color technology, e.g., a composite color technology, to produce a first subset of image constituent signals and a second subset of DIPPS may use a second color technology, different from the first color technology, e.g., a different composite color technology or a non-composite color technology) to produce a second subset of image constituent signals. This allows use of a combination of various technologies to produce a set of display image primitives, and display image 125, that can be superior than when it is produced from any single technology.

Architecture 100 further includes a signal processing matrix 130 that accepts image constituent signals 115ᵢ as an input and produces display image primitives 120ᵢ at an output. There are many possible arrangements of matrix 130 (some embodiments may include single dimensional arrays) depending upon fit and purpose of any particular implementation of an embodiment of the present invention. Generally, matrix 130 includes a plurality of signal channels, for example channel 135—channel 160. There are many different possible arrangements for each channel of matrix 130. Each channel is sufficiently isolated from other channels, such as optical isolation that arises from discrete fiber optic channels, so signals in one channel do not interfere with other signals beyond a crosstalk threshold for the implementation/embodiment. Each channel includes one or more inputs and one or more outputs. Each input receives an image constituent signal 115 from DIPP 110. Each output produces a display image primitive 120. From input to output, each channel directs pure signal information, and that pure signal information at any point in a channel may include an original image constituent signal 115, a disaggregation of a set of one or more processed original image constituent signals, and/or an aggregation of a set of one or more processed original image constituent signals, each “processing” may have included one or more aggregations or disaggregations of one or more signals.

In this context, aggregation refers to a combining signals from an S_{A} number, S_{A}>1, of channels (these aggregated signals themselves may be original image constituent signals, processed signals, or a combination) into a T_{A} number (1≤T_{A}<S_{A}) of channels and disaggregation refers to a division of signals from an S_{D} number, S_{D}≥1, of channels (which themselves may be original image constituent signals, processed signals, or a combination) into a T_{D} number (S_{D}<T_{D}) of channels. S_{A} may exceed N, such as due to an earlier disaggregation without any aggregation and S_{D} may exceed M due a subsequent aggregation. Some embodiments have S_{A}=2, S_{D}=1 and T_{D}=2. However, architecture 100 allows many signals to be aggregated which can produce a sufficiently strong signal that it may be disaggregated into many channels, each of sufficient strength for use in the implementation. Aggregation of signals follows from aggregation (e.g., joining, merging, combining, or the like) of channels or other arrangement of adjacent channels to permit joining, merging, combining or the like of signals propagated by those adjacent channels and disaggregation of signals follows from disaggregation (e.g., splitting, separating, dividing, or the like) of a channel or other channel arrangement to permit splitting, separating, dividing or the like of signals propagated by that channel. In some embodiments, there may be particular structures or element of a channel to aggregate two or more signals in multiple channels (or disaggregate a signal in a channel into multiple signals in multiple channels) while preserving the signal status of the content propagating through matrix 130.

There are a number of representative channels depicted in FIG. 1. Channel 135 illustrates a channel having a single input and a single input. Channel 135 receives a single original image constituent signal 115ₖ and produces a single display image primitive 120ₖ. This is not to say that channel 135 may not perform any processing. For example, the processing may include a transformation of physical characteristics. The physical size dimensions of input of channel 135 is designed to match/complement an active area of its corresponding/associated DIPP 110 that produces image constituent signal 115ₖ. The physical size of the output is not required to match the physical size dimensions of the input—that is, the output may be relatively tapered or expanded, or a circular perimeter input may become a rectilinear perimeter output. Other transformations include repositioning of the signal—while image constituent signal 115₁ may start in a vicinity of image constituent signal 115₂, display image primitive 1201 produced by channel 135 may be positioned next to a display image primitive 120ₓ produced from a previously “remote” image constituent signal 115ₓ. This allows a great flexibility in interleaving signals/primitives separated from the technologies used in their production. This possibility for individual, or collective, physical transformation is an option for each channel of matrix 130.

Channel 140 illustrates a channel having a pair of inputs and a single output (aggregates the pair of inputs). Channel 140 receives two original image constituent signals, signal 1153 and signal 1154 for example, and produces a single display image primitive 120₂, for example. Channel 140 allows two amplitudes to be added so that primitive 120₂ has a greater amplitude than either constituent signal. Channel 140 also allows for an improved timing by interleaving/multiplexing constituent signals; each constituent signal may operate at 30 Hz but the resulting primitive may be operated at 60 Hz, for example.

Channel 145 illustrates a channel having a single input and a pair of outputs (disaggregates the input). Channel 140 receives a single original image constituent signal, signal 115₅, for example, and produces a pair of display image primitives—primitive 120₃ and primitive 1204. Channel 145 allows a single signal to be reproduced, such as split into two parallel channels having many of the characteristics of the disaggregated signal, except perhaps amplitude. When amplitude is not as desired, as noted above, amplitude may be increased by aggregation and then the disaggregation can result in sufficiently strong signals as demonstrated in others of the representative channels depicted in FIG. 1.

Channel 150 illustrates a channel having three inputs and a single output. Channel 150 is included to emphasize that virtually any number of independent inputs may be aggregated into a processed signal in a single channel for production of a single primitive 1205, for example.

Channel 155 illustrates a channel having a single input and three outputs. Channel 150 is included to emphasize that a single channel (and the signal therein) may be disaggregated into virtually any number of independent, but related, outputs and primitives, respectively. Channel 155 is different from channel 145 in another respect—namely the amplitude of primitives 120 produced from the outputs. In channel 145, each amplitude may be split into equal amplitudes (though some disaggregating structures may allow for variable amplitude split). In channel 155, primitive 120₆ may not equal the amplitude of primitive 120₇ and 120₈ (for example, primitive 120₆ may have an amplitude about twice that of each of primitive 120₇ and primitive 120₈ because all signals are not required to be disaggregated at the same node). The first division may result in one-half the signal producing primitive 120₆ and the resulting one-half signal further divided in half for each of primitive 120₇ and primitive 120₈.

Channel 160 illustrates a channel that includes both aggregation of a trio of inputs and disaggregation into a pair of outputs. Channel 160 is included to emphasize that a single channel may include both aggregation of signals and disaggregation of signal. A channel may thus have multiple regions of aggregations and multiple regions of disaggregation as necessary or desirable. Matrix 130 is thus a signal processor by virtue of the physical and signal characteristic manipulations of processing stage 170 including aggregations and disaggregations.

In some embodiments, matrix 130 may be produced by a precise weaving process of physical structures defining the channels, such as a Jacquard weaving processes for a set of optical fibers that collectively define many thousands to millions of channels.

Broadly, embodiments of the present invention may include an image generation stage (for example, image engine 105) coupled to a primitive generating system (for example, matrix 130). The image generation stage includes a number N of display image primitive precursors 110. Each of the display image primitive precursors 110, generate a corresponding image constituent signal 115ᵢ. These image constituent signals 115ᵢ are input into the primitive generating system. The primitive generating system includes an input stage 165 having M number of input channels (M may equal N but is not required to match—in FIG. 1 for example some signals are not input into matrix 130). An input of an input channel receives an image constituent signal 115ₓ from a single display image primitive precursor 110ₓ. In FIG. 1, each input channel has an input and an output, each input channel directing its single original image constituent signal from its input to its output, there being M number of inputs and M number of outputs of input stage 165. The primitive generating system also includes a distribution stage 170 having P number of distribution channels, each distribution channel including an input and an output. Generally M=N and P can vary depending upon the implementation. For some embodiments, P is less than N, for example, P=N/2. In those embodiments, each input of a distribution channel is coupled to a unique pair of outputs from the input channels. For some embodiments, P is greater than N, for example P=N*2. In those embodiments, each output of an input channel is coupled to a unique pair of inputs of the distribution channels. Thus the primitive generating system scales the image constituent signals from the display image primitive precursors—in some cases multiple image constituent signals are combined, as signals, in the distribution channels and other times a single image constituent signal is divided and presented into multiple distribution channels. There are many possible variations of matrix 130, input stage 165, and distribution stage 170.

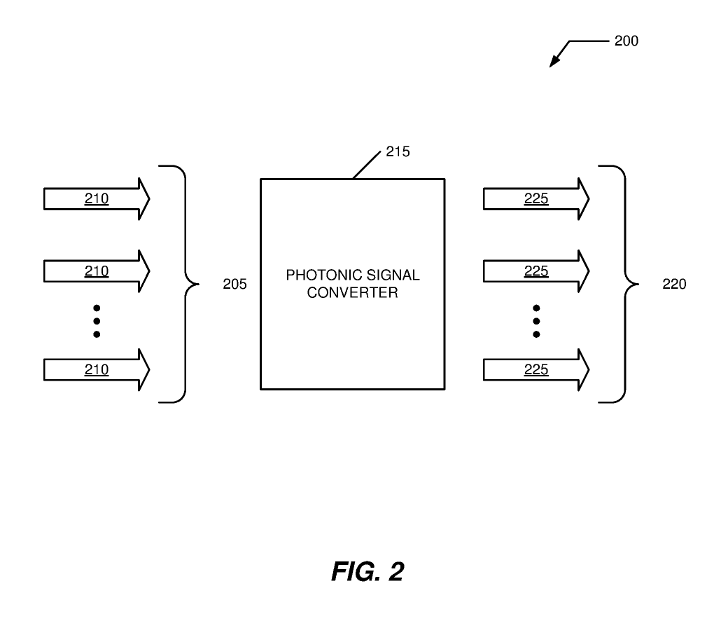

FIG. 2 illustrates an embodiment of an imaging system 200 implementing a version of the imaging architecture of FIG. 1. Systems 200 includes a set 205 of encoded signals, such as a plurality of image constituent signals (at IR/near IR frequencies) that are provided to a photonic signal converter 215 that produces a set 220 of digital image primitives 225, preferably at visible frequencies and more particularly at real-world visible imaging frequencies.

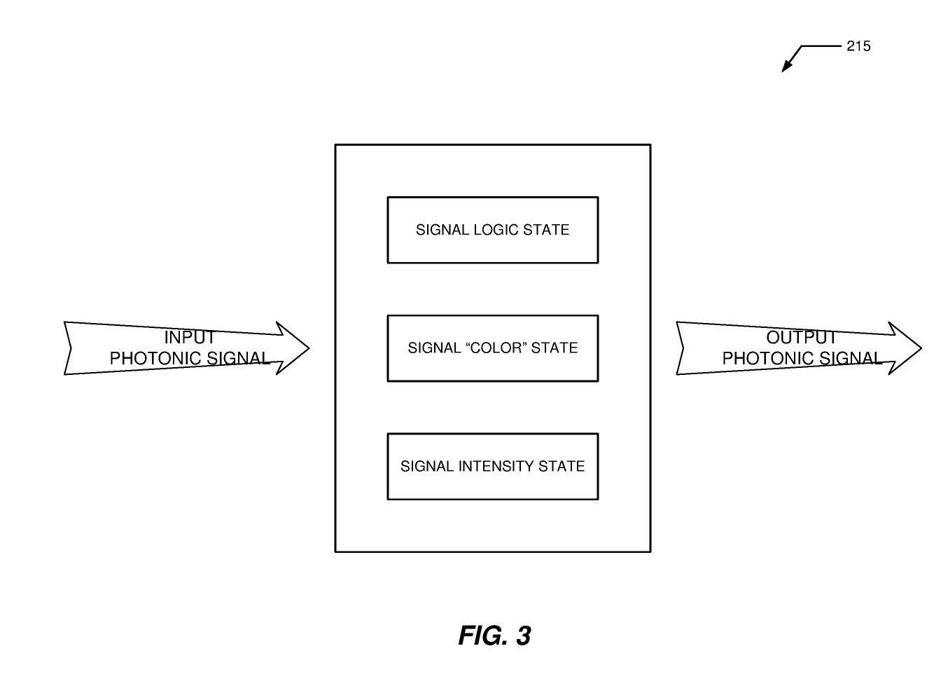

FIG. 3 illustrates a general structure for photonic signal converter 215 of FIG. 2. Converter 215 receives one or more input photonic signals and produces one or more output photonic signals. Converter 215 adjusts various characteristics of the input photonic signal(s), such as signal logic state (e.g., ON/OFF), signal color state (IR to visible), and/or signal intensity state.

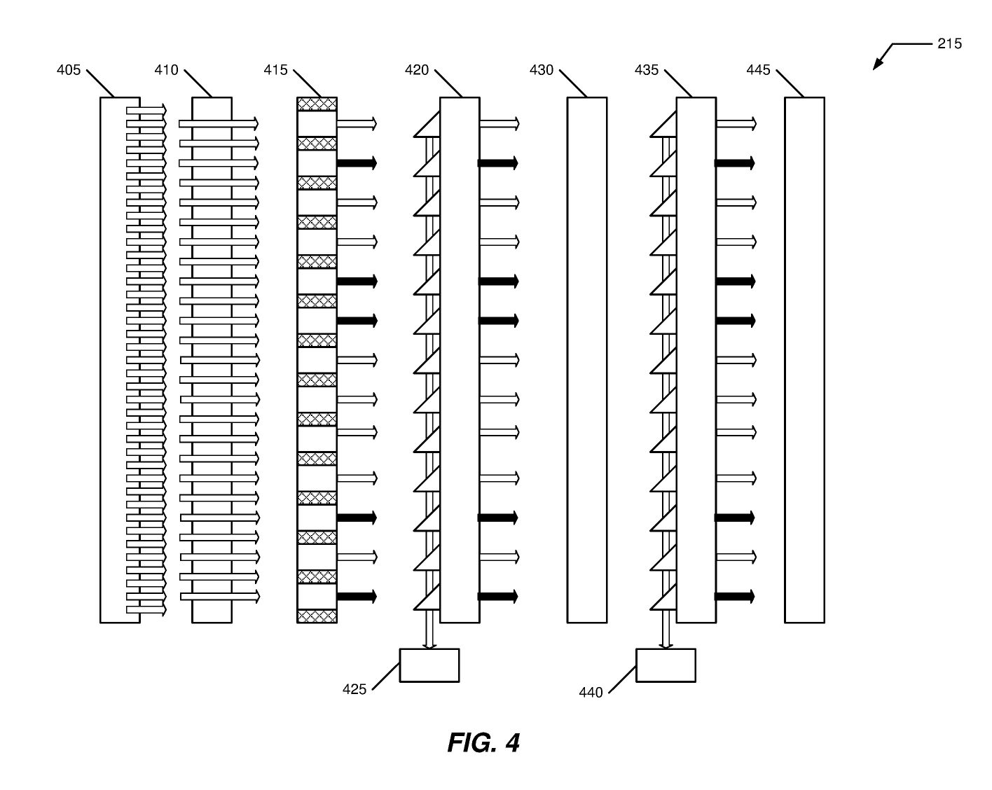

FIG. 4 illustrates a particular embodiment for a photonic converter 400. Converter 405 includes an efficient light source 405. Source 405 may, for example, include an IR and/or near-IR source for optimal modulator performance in subsequent stages (e.g., LED array emitting in IR and/or near-IR). Converter 400 includes an optional bulk optical energy source homogenizer 410. Homogenizer 410 provides a structure to homogenize polarization of light from source 405 when necessary or desirable. Homogenizer 410 may be arranged for active and/or passive homogenization.

Converter 400 next, in an order of light propagation from source 405, includes an encoder 415. Encoder 415 provides logic encoding of light from source 405, that may have been homogenized, to produce encoded signals. Encoder 405 may include hybrid magneto-photonic crystals (MPC), Mach-Zehnder, transmissive valve, and the like. Encoder 415 may include an array or matrix of modulators to set the state of a set of image constituent signals. In this regard, the individual encoder structures may operate equivalent to display image primitive precursors (e.g., pixels and/or sub-pixels, and/or other display optical-energy signal generator.

Converter 400 includes an optional filter 420 such as a polarization filter/analyzer (e.g., photonic crystal dielectric mirror) combined with planar deflection mechanism (e.g., prism array/grating structure(s)).

Converter 400 includes an optional energy recapturer 425 that recaptures energy from source 405 (e.g., IR-near-IR deflected energy) that is deflected by elements of filter 420.

Converter 400 includes an adjuster 430 that modulates/shifts wavelength or frequency of encoded signals produced from encoder 415 (that may have been filtered by filter 420). Adjuster 430 may include phosphors, periodically-poled materials, shocked crystals, and the like.) Adjuster 430 takes IR/near-IR frequencies that are generated/switched and converts them to one or more desired frequencies (e.g., visible frequencies). Adjuster 430 is not required to shift/modulate all input frequencies to the same frequency and may shift/modulate different input frequencies in the IR/near-IR to the same output frequency. Other adjustments are possible.

Converter 400 optionally includes a second filter 435, for example for IR/near-IR energy and may then optionally include a second energy recapturer 440. Filter 435 may include photonic crystal dielectric mirror) combined with planar deflection structure (e.g., prism array/grating structure(s)).

Converter 400 may also include an optional amplifier/gain adjustment 445 for adjusting a one or more parameters (e.g., increasing a signal amplitude of encoded, optionally filtered, and frequency shifted signal). Other, or additional, signal parameters may be adjusted by adjustment 445.

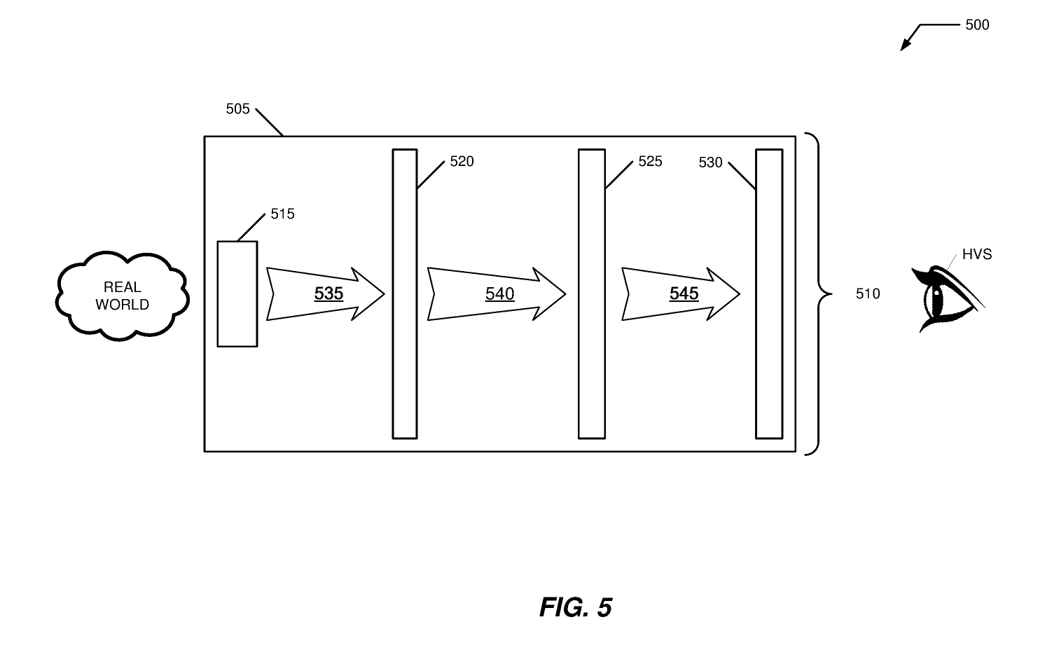

FIG. 5 illustrates a generalized architecture 500 for a hybrid photonic VR/AR system 505. Architecture 500 exposes system 505 to ambient real world composite electromagnetic wave fronts and produces a set of display image primitives 510 for a human visual system (HVS). Set of display image primitives 510 may include or use information from the real world (an AR mode) or the set of display image primitives may include information wholly produced by a synthetic world (a VR mode). System 505 may be configured to be selectively operable in either or both modes. Further, system 500 may be configured such that a quantity of real world information used in the AR mode may be selectively varied. System 505 is robust and versatile.

System 505 may be implemented in many different ways. One embodiment produces image constituent signal from the synthetic world and interleaves the synthetic signals, in an AR mode, with image constituent signals produced from the real world (“real world signals”). These signals may be channelized, processed, and distributed as described in incorporated patent application Ser. No. 12/371,461 using a signal processing matrix of isolated optic channels. System 505 includes a signal processing matrix that may incorporate various passive and active signal manipulation structures in addition to any distribution, aggregation, disaggregation, and/or physical characteristic shaping.

These signal manipulation structures may also vary based upon a particular arrangement and design goal of system 505. For example, these manipulation structures may include a real world interface 515, an augmenter 520, a visualizer 525, and/or an output constructor 530.

Interface 515 includes a function similar to that of a display image primitive precursor in converting the complex composite electromagnetic wave fronts of the real world into a set of real world image constituent signals 535 that are channelized and distributed and presented to augmenter 520.

As described herein, system 505 is quite versatile and there are many different embodiments. Characteristics and functions of the manipulation structures may be influenced by a wide range of considerations and design goals. All of these cannot be explicitly detailed herein but some representative embodiments are set forth. As described in the incorporated patent applications and herein, architecture 500 is enabled to employ a combination of technologies (e.g., hybrid) that each may be particularly advantageous for one part of the production of set of DIPs 510 to produce an overall result that is superior than relying on a single technology for all parts of the production.

For example, the complex composite electromagnetic wave fronts of the real world include both visible and invisible wavelengths. Since set of DIPs 510 also include visible wavelengths, it may be thought that signals 535 must be visible as well. As explained herein, not all embodiments will be able to achieve superior results when signals 535 are in the visible spectrum.

System 505 may be configured for use including visible signals 535. There are advantages for some embodiments to provide signals 535 using wavelengths that are not visible to the HVS. As used herein, the following ranges the electromagnetic spectrum are relevant:
a) Visible radiation (light) is electromagnetic radiation with a wavelength between 380 nm and 760 nm (400-790 terahertz) that will be detected by the HVS and perceived as visible light;
b) Infrared (IR) radiation is invisible (to HVS) electromagnetic radiation with a wavelength between 1 mm and 760 nm (300 GHz-400 THz) and includes far-infrared (1 mm-10 μm), mid-infrared (10-2.5 μm), and near-infrared (2.5 μm-750 nm).
c) Ultraviolet (UV) radiation is invisible (to HVS) electromagnetic radiation with a wavelength between 380 nm-10 nm (790 THz-30 PHz)

Interface 515 of a non-visible real-world signal embodiment produces signals 535 in the infrared/near-infrared spectrum. For some embodiments, it is desirable that the non-visible signals 535 are produced using a spectrum map that maps particular wavelengths or bands of wavelengths of the visible spectrum to predetermined particular wavelengths or bands of wavelengths in the infrared spectrum. This offers an advantage of allowing signals 535 to be efficiently processed within system 505 as infrared wavelengths and includes an advantage of allowing system 505 to restore signals 535 to real-world colors.

Interface 515 may include other functional and/or structural elements such as a filter to remove IR and/or UV components from the received real-world radiation. In some applications, such as for a night-vision mode using IR radiation, interface 515 will exclude an IR filter or will have an IR filter that allows some IR radiation of the received real-world radiation to be sampled and processed.

Interface 515 will also include real-world sampling structures to convert the filtered received real-world radiation into a matrix of processed real world image constituent signals (similar to a matrix of display image primitive precursors) with these processed real world image constituent signals channelized into a signal distribution and processing matrix.

The signal distribution and processing matrix may also include frequency/wavelength conversion structures to provide the processed real world image constituent signals in the IR spectrum (when desired). Depending upon what additional signal operations are performed later in system 505 and which encoding/switching technology is implemented, interface 515 may also preprocess selected characteristics of the filtered real world image constituent signals, such as including a polarization filtering function (e.g., polarization-filter the IR/UV filtered real world image constituent signals or polarization-filter, sort, and polarization homogenize, and the like).

For example, with system 505 including a structure or process for modifying signal amplitude based upon polarization, interface 515 may prepare signals 535 appropriately. In some implementations, it may be desirable to have a default signal amplitude at a maximum value (e.g., default “ON”), in other implementations it may be desirable to have a default signal amplitude at a minimum (e.g., default “OFF”) and others may be have some channels that provide defaults in different conditions and not all in a default ON or a default OFF. Setting polarization states of signals 535, whether visible or not, is one role of interface 515. Other signal properties, for all signals 535 or for a select subset of signals 535 may also be set by interface 515 as determined by design goals, technology, and implementation details.

Channelized image constituent signals 535 of the real world are input into augmenter 520. Augmenter 520 is a special structure in system 505 for further signal processing. This signal processing may be multifunction that operates on signals 535, some or all may be considered “pass-through” signals based upon how augmenter 520 operates upon them. These multiple functions may include: a) manipulating signals 535, such as, for example, independent amplitude control of each individual real world image constituent signal, setting/modifying frequency/wavelength, and/or logic state, and the like, b) producing a set of independent synthetic world image constituent signals with desired characteristics, and c) interleaving, at a desired ratio, some or all of the “passed through” real world image constituent signals with the produced set of synthetic world image constituent signals to produce a set of interleaved image constituent signals 540.

Augmenter 520 is a producer of the set of synthetic world image constituent signals in addition to a processor of received image constituent signals (e.g., real world). System 505 is configured such that all signals may be processed by augmenter 520. There may be many different ways to implement augmenter 520, for example when augmenter 520 is a multi-layer optical device composite defining a plurality of radiation valving gates (each gate related to one signal), some gates, configured for possible pass through, receive, individually, some of the real world signals for controllable pass through and some gates configured for production of the synthetic world signals receive a background radiation, isolated from the pass through signals, for production of the synthetic world image constituent signals. The gates for the production of the synthetic world in such an implementation thus create the synthetic world signals from the background radiation.

As illustrated, architecture 500 includes multiple, e.g., two, independent sets of display image primitive precursors that are selectively and controllably processed and merged. Interface 515 functions as one set of display image primitive precursors and augmenter 520 functions as a second set of display image primitive precursors. The first set produces image constituent signals from the real world and the second set produces image constituent signals from the synthetic world. In principle, architecture 500 permits additional sets of display image primitive precursors (1 or more making a total of three or more display image primitive precursors) to be available in system 505 that can make additional channelized set(s) of image constituent signals available to augmenter 520 for processing.

In one way of considering architecture 500, augmenter 520 defines a master set of display image primitive precursors that produces the interleaved signals 540 wherein some of the interleaved signals were initially produced by one or more preliminary sets of display image precursors (e.g., interface 515 producing real world image constituent signals) and some are produced directly by augmenter 520. Architecture 500 does not require that all display image primitive precursors employ the same or complementary technologies. By providing all constituent signals in an organized and predetermined format (e.g., in independent channels and in a common frequency range compatible with signal manipulations such as, for example, signal amplitude modulation by augmenter 520), architecture 500 may provide a powerful, robust, and versatile solution to one or more of the range of drawbacks, limitations, and disadvantages to current AR/VR systems.

The channelized signal processing and distribution arrangement, as noted herein, may aggregate, disaggregate, and/or otherwise process individual image constituent signals as the signals propagate through system 505. A consequence of this is that the number of signal channels in signals 540 may be different from a sum of the number of pass through signals and the number of generated signals. Augmenter 520 interleaves a first quantity of real world pass through signals with a second quantity of synthetic signals (for the pure VR mode of system 505, the first quantity is zero). Interleaved in this context includes, broadly, that both types of signals are present and is not meant to require that each real world pass through signal be present in a channel that is physically adjacent to another channel including a synthetic world signal. Routing is independently controllable via the channel distribution properties of system 505.

Visualizer 525 receives interleaved signals 520 and outputs a set of visible signals 545. In system 505, synthetic world image constituent signals of signals 540 were produced in a non-visible range of the electromagnetic spectrum (e.g., IR or near IR). In some implementations, some or all of the real world signals 535 passed through by augmenter 520 had been converted to a non-visible range of the electromagnetic spectrum (which may also be overlapping or wholly or partially included in the range for the synthetic world signals). Visualizer 525 performs frequency/wavelength modulation and/or conversion of non-visible signals. When the signals, synthetic and real-world, are defined and produced using a false color map of the non-visible, appropriate colors are restored to the frequency-modified real world signals and the synthetic world may be visualized in terms of real world colors.

Output constructor 530 produces the set of display image primitives 510 from visible signals 545 for perception by the HVS, whether for example by direct view or projection. Output constructor 530 may include consolidation, aggregation, disaggregation, channel rearrangement/relocation, physical characteristic definition, ray shaping, and the like among other possible functions. Constructor 530 may also include amplification of some or all of visible signals 545, bandwidth modification (e.g., aggregation and time multiplexing of multiple channels having signals with a preconfigured timing relationship—that is they may be produced out of phase and combined as signals to produce a stream of signals at a multiple of the frequency of any of the streams), and other image constituent signal manipulations. Two streams at 180 degree phase difference relationship may double the frequency of each streams. Three streams at 120 degree phase relationship may triple the frequency, and so fourth for N=1 or more multiplexed streams. And merged streams that are in phase with each other may increase the signal amplitude (e.g., two in-phase streams may double the signal amplitude, and the like).

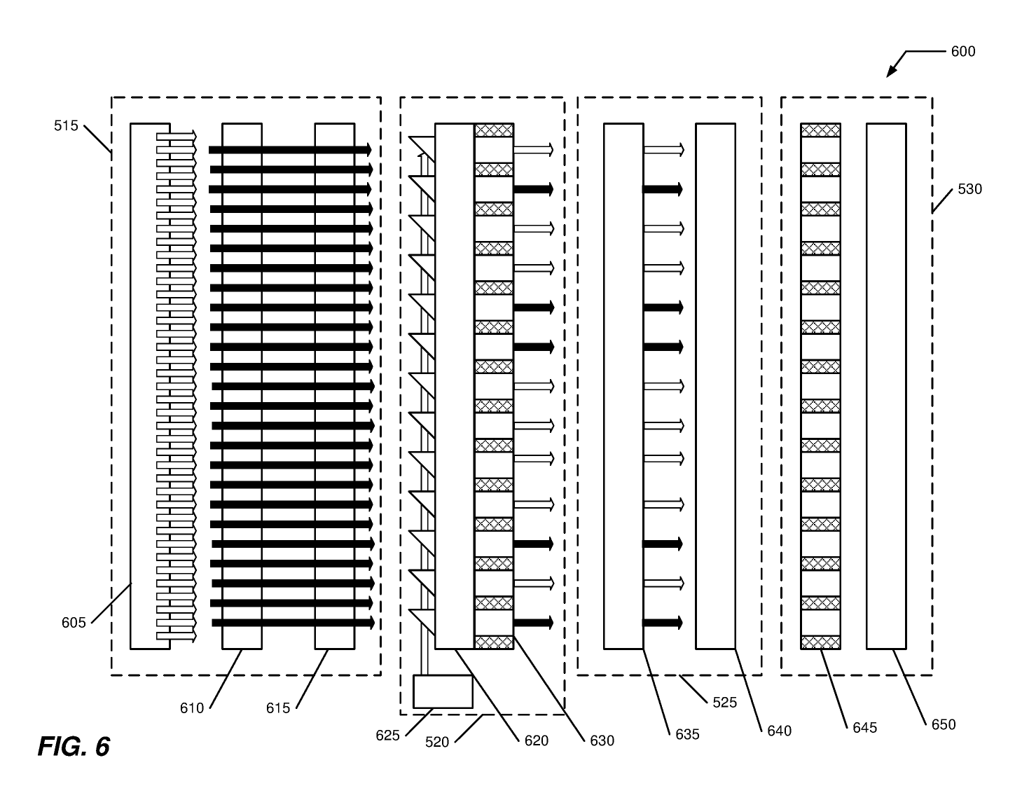

FIG. 6 illustrates a hybrid photonic VR/AR system 600 implementing an embodiment of system 500. System 600 includes dashed boxes mapping corresponding structures between system 600 and system 505 of FIG. 5.

System 600 includes an optional filter 605, a “signalizer” 610, a realworld signal processor 615, radiation diffuser 620 powerered by a radiation source 625 (e.g., IR radiation), a magneto photonic encoder 630, a frequency/wavelength converter 635, signal processor 640, signal consolidator 645, and output shaper optics 650. As noted herein, there are many different implementations and embodiments, some of which include differing technologies with different requirements. For example, some embodiments may use radiation in the visible spectrum and not require elements for wavelength/frequency conversions. For a pure VR implementation, the real world signal handling structures are not required. In some cases, minimial post visualization consolidation and shaping is needed or desired. Architecture 500 is very flexible and may be adapted to the preferred set of technologies.

Filter 605 removes unwanted wavelengths from ambient real world illumination incident on interface 515. What is unwanted depends on the application and design goals (e.g., night vision goggles may want some or all IR radiation while other AR systems may desire to remove UV/IR radiation.

Signalizer 610 functions as a display image primitive precursor to convert the filtered incident realworld radiation into real world image constituent signals and to insert individual signals into optically isolated channels of a signal distributor stage. These signals may be based upon a composite or non-composite imaging model.

Processor 615 may include a polarization structure to filter polarization and/or filter, sort, and homogenize polarization, a wavelength/frequency converter when some or all of the real world pass through image constituent signals are going to be converted to a different frequency (e.g., IR).

Diffuser 620 takes radiation from radiation source and sets up a background radiation environment for encoder 630 to generate synthetic world image constituent signals. Diffuser 620 maintains the background radiation isolated from the real world pass through channels.

Encoder 630 concurrently receives and processes the real world pass through signals (e.g., it is capable of modulating these signals among other things) and produces the synthetic world signals. Encoder 630 interleaves/alternates signals from the real world and from the synthetic world and maintains them in optically isolated channels. In FIG. 6, the real world signals are depicted as filled-in arrows and the synthetic world signals are depicted as unfilled arrows to illustrate the interleaving/alternating. FIG. 6 is not meant to imply that encoder 630 is required to reject a significant portion of the real world signals. Encoder 630 may include a matrix of many display image primitive precursor-type structures to process all the real world signals and all the synthetic world signals.

Converter 635, when present, converts the non-visible signals to visible signals. Converter 635 may thus process synthetic world signals, real world signals, or both. In other words, this conversion may be enabled on individual ones of the signal distribution channels.

Signal processor 640, when present, may modify signal amplitude/gain, bandwidth, or other signal modification/modulation.

Signal consolidator 645, when present, may organize (e.g., aggregate, disaggregate, route, group, cluster, duplicate, and the like) signals from visualizer 525.

Output shaper optics 650, when present, performs any necessary or desirable signal shaping or other signal manipulation to produce the desired display image primitives to be perceived by the HVS. This may include direct view, projection, reflection, a combination, and the like. The routing/grouping may enable 3D imaging or other visual effect.

System 600 may be implemented as a stack, sometimes integrated, of functional photonic assemblies that receive, process, and transmit signals in discrete optically isolated channels from a time that they are produced until, and if, they are included in a display image precursor for propagation to the HVS as part of other signals in other display image precursors.

The field of the present invention is not single, but rather combines two related fields, augmented reality and virtual reality, but addressing and providing an integrated mobile device solution that solves critical problems and limitations of the prior art in both fields. A brief review of the background of these related fields will make evident the problems and limitations to be solved, and set the stage for the proposed solutions of the present disclosure.

Two standard dictionary definitions of these terms (source: Dictionary.com) are as follows:

VIRTUAL REALITY: “A realistic simulation of an environment, including three-dimensional graphics, by a computer system using interactive software and hardware. Abbreviation: VR”

AUGMENTED REALITY: “An enhanced image or environment as viewed on a screen or other display, produced by overlaying computer-generated images, sounds, or other data on a real-world environment. AND: “A system or technology used to produce such an enhanced environment. Abbreviation: AR”

It is evident from the definitions, though non-technical, and to those skilled in these related fields, that the essential difference lies in whether the simulated elements are a complete and immersive simulation, screening completely even a partial direct view of reality, or the simulated elements are super-imposed over an otherwise clear, unobstructed view of reality.

Slightly more technical definitions is provided under the Wikipedia entry for the topic, which may be considered well-represented of the field, given the depth and range of contributions to the editing of the pages.

Virtual reality (VR), sometimes referred to as immersive multimedia, is a computer-simulated environment that can simulate physical presence in places in the real world or imagined worlds. Virtual reality can recreate sensory experiences, including virtual taste, sight, smell, sound, touch etc.

Augmented reality (AR) is a live direct or indirect view of a physical, real-world environment whose elements are augmented (or supplemented) by computer-generated sensory input such as sound, video, graphics or GPS data.

Inherent but only implicit in these definitions is the essential attribute of a mobile point of view. What differentiates Virtual or Augmented reality from the more general class of computer simulation, with or without any combination, fusion, synthesis, or integration with “real-time,” “direct” imaging of reality, either local or remote, is that the simulated or hybrid (augmented or “mixed”) reality “simul-real” images, is that the point of view of the viewer moves with the viewer as the viewer moves in the real world.

This disclosure proposes that this more precise definition is needed to distinguish between stationary navigation of immersively-displayed and experienced simulated worlds (simulators), and mobile navigation of simulated worlds (virtual reality). A sub-category of simulators then would be “personal simulators,” or at most, “partial virtual reality,” in which a stationary user is equipped with an immersive HMD (head mounted display) and haptic interface (e.g., motion-tracked gloves), which enable a partial “virtual-reality-like” navigation of a simulated world.

A CAVE system, would, on the other hand, qualify schematically as a limited virtual reality system, as navigation past the dimensions of the CAVE would only be possible by means of a moveable floor, and once the limits of the CAVE itself were reached, what would follow would be another form of “partial virtual reality.”

Note the difference between a “mobile” point of view and a “movable” point of view. Computer simulations, such as video games, are simulated worlds or “realities” but unless the explorer of that simulated world is personally in motion, or directing the motion of another person or robot, then all that can be said (though this one of the major accomplishments of computer graphics in the last forty years, simply “building” simulated environments which are, in software, explorable) is that the simulated world is “navigable.”

For a simulation to be either a virtual or hybrid (the author's preferred term) reality, an essential, defining characteristic is that there is a mapping of the simulation, whether entirely synthetic or hybrid, to a real space. Such a real space may be as basic as a room inside a laboratory or soundstage, and simply a grid that maps and calibrates, in some ratio, to the simulated world.

This differentiation is not evaluative, as a partial VR which provides real-time natural interface (head-tracking, haptic, auditory, etc.) without being mobile or mapping to an actual, real topography, whether natural, man-made, or hybrid, is not fundamentally less valuable than a partial VR system which simulates physical interaction and provides sensory immersion. But, without a podiatric feedback system, or more universally, a full-body, range-of-motion feedback system, and/or a dynamically-deformable mechanical interface-interaction surface which supports the users simulated but (to their senses) full-body movement over any terrain, any stationary, whether standing, sitting, or reclining, VR system is by definition, “partial.”

But, in the absence of such an ideal full-body physical interface/feedback system, limiting VR to a “full” and fully-mobile version would limit the terrains of the VR world to that which can be found in the real world, modified or built from scratch. Such a limitations would severely limit the scope and power of virtual reality experience in general.

But, as will be evident in the forthcoming disclosure, this differentiation makes a difference, as it sets the “bright line” for how existing VR and AR systems differ and their limitations, as well as providing background to inform the teaching of the present disclosure.

Having established the missing but essential characteristic and requirement of a simulation to be a complete “virtual reality,” the next step is to identify the implicit question of by what means is a “mobile point of view” realized. The answer is, to provide a view of the simulation which is mobile requires two components, themselves realized by a combination of hardware and software: a moving image display means, by which the simulation can be viewed, and motion-tracking means, which can track the movement of the device which includes the display in 3 axes of motion, which means to measure position over time of a 3-dimensional viewing device from a minimum of three tracking points (two, if the measurements the device is mapped so that a the third position on a third axis can be inferred), and in relation to a 3-axis frame of reference, which can be any arbitrary 3D coordinate system mapped to a real space, although for practical purposes of mechanically navigating the space, the 2 axes will form a plane that is a ground plane, gravitationally level, and the third axis, the Z, is normal to that ground plane.

The solutions to practically achieving this positional orientation, accurately and frequently as a function of time, requires a combination of sensors and software, and the advances in these solutions represents a major vector in the development of the field of both VR and AR hardware/software mobile viewing devices and systems.

These being relatively new fields, in terms of the time-frame between the earliest experiments and present-day, practical technologies and products, it is sufficient to make note of the origins and then the current state-of-the-art in both categories of mobile visual simulation systems, with exceptions only made for particular innovations in the prior art which are of significance to the development of the present disclosure or in relation to significant points of difference or similarity which serve to better explain either the current problems in the field or what distinguishes the solutions of the present disclosure from the prior art.

The period from 1968 through the late nineties spans a period of many innovations in related simulation and simulator, VR and AR fields, in which many of the key problems in achieving practical VR and AR found initial or partial solutions.

The seminal experiments and experimental head-mounted display systems of Ivan Sutherland and his assistant Bob Sprouell from 1968 are commonly considered to mark the origin of these related fields, although earlier work, essentially conceptual development had preceded this, the first experimental implementation of any form of AR/VR achieving immersion and navigation.

The birth of stationary simulator systems may be traced to the addition of computer-generated imaging to flight simulators, which is generally recognized to have begun in the mid-late 1960's. This was limited to the use of CRT's, displaying a full-focus image at the distance of the CRT from the user, until 1972, when the Singer-Link company debuted a collimated projection system which projected a distant-focus image through a beam-splitter-mirror system, which improved the field of view to about 25-35 degrees per unit (100 degrees with three units employed in a single-pilot simulator).

This benchmark was only improved by the Rediffusion Company in 1982, with the introduction of a wide-field of view system, the Wide Angle Infinity Display System, which realized 150 and then eventually 240 degree FOV through the use of multiple projectors and a large, curved collimating screen. It was at this stage where stationary simulators might be described as finally achieving a significant degree of real immersion in a virtual reality, with the use of an HMD to isolate the viewer and eliminate visual cue distractions from the periphery.

But at the time the Singer-Link Company was introducing its screen collimation system for simulators, as stepping-stones to a VR-type experience, the first very-limited commercial helmet-mounted displays were first being developed for military use, which integrated a reticle-based electronic targeting system with motion-tracking of the helmet itself. These initial developments are generally recognized to have been achieved in rudimentary form by the South African Air Force in the 1970's (followed by the Israeli Air Force between then and the mid-seventies), and may be said to be the start of a rudimentary AR or mediated/hybrid reality system.

These early, graphically-minimal but still seminal helmet-mounted systems, which implemented a limited compositing of positionally-coordinated targeting information overlaid on a reticle and user-actuated motion-tracked targeting, was followed by the invention by Steve Mann of the first “mediate reality” mobile view-through system, the first generation “EyeTap,” which superimposed graphics on glasses.

Later versions by Mann have employed an optical recombination system, based on a beam-splitter/combiner optic merging real and processed-imagery. This work preceded later work by Chunyu Gao and Augmented Vision Inc, which essentially proposes a dual Mann system, combining processed real image and a generated image optically, where Mann's system accomplished both processed-real and generated electronically. In Man's system, real-view through imagery is retained, but in Gao's system all view-through imagery is processed, eliminating any direct view-through imagery even as an option. (Chunyu Gao, US Patent Application 20140177023, filed Apr. 13, 2013). The “light-path folding optics” structures and methods specified by Gao's system are found in other optical HMD systems.

By 1985, Jaron Lanier and VPL Reseearch was formed to develop HMD's and the “data glove,” so there were, by the 1980's three major development paths for simulation, VR and AR, with Mann, Lanier, and the Redefussion Company, among a very active field of development, credited with some of the most critical advances and establishing of some basic solution-types, which in most cases persist to the present day and state of the art.

Sophistication of computer generated imaging (CGI), continued improvement in game machines (hardware and software) with real-time, interactive CG technology, larger system integration among multiple systems, and extension of both AR, and to a more limited degree, VR mobility were among the major development trends of the 1990's

What was both a limited form of mobile VR and a new kind of simulator was the CAVE system, developed at the Electronic Visualization Laboratory at the University of Illinois, Chicago, and debuted to the world in 1992. (Carolina Cruz-Neira, Daniel J. Sandin, Thomas A.

DeFanti, Robert V. Kenyon and John C. Hart. “The CAVE: Audio Visual Experience Automatic Virtual Environment”, Communications of the ACM, vol. 35(6), 1992, pp. 64-72.) Instead of Lanier's HMD/data glove combination, the CAVE combined a WFOV multi-wall simulator “stage” with haptic interfaces.

Concurrently, a form of stationary partial-AR was being developed at the Armstrong US Air Force Research Lab by Louis Rosenberg, with his “Virtual Fixtures” system (1992), while Jonathan Waldern's stationary “Virtuality” VR systems, which have been recognized as under initial development from as early as 1985 through 1990, were to debut commercially in 1992 as well.

Mobile AR, integrated into a multi-unit mobile vehicle “wargame” system, combining real and virtual vehicles in an “augmented simulation” (“AUGSIMM”) was to see its next major advance in the form of the Loral WDL, demonstrated to the trade in 1993. Writing afterwards in 1999, “Experiences and Observations in Applying Augmented Reality to Live Training,” a project participant, Jon Barrilleaux of Peculiar Technologies, commented on the findings of the final 1995 SBIR report, and noted what are, even up to the present time, continued issues facing mobile VR and (mobile) AR:

AR vs. VR Tracking

In general, commercial products developed for VR have good resolution but lack the absolute accuracy and wide area coverage necessary for AR, much less for their use in AUGSIM.

VR applications—where the user is immersed in a synthetic environment—are more concerned with relative tracking than in absolute accuracy. Since the user's world is completely synthetic and self-consistent the fact that his/her head just turned 0.1 degrees is much more important than knowing within even 10 degrees that it is now pointing due North.

AR systems, such as AUGSIM, do not have this luxury. AR tracking must have good resolution so that virtual elements appear to move smoothly in the real world as the user's head turns or vehicle moves, and it must have good accuracy so that virtual elements correctly overlay and are obscured by objects in the real world.

As computational and network speeds continued to improve during the nineties, new projects in open-air AR systems were initiated, including at the US Naval Research Laboratory, with the BARS system, “BARS: Battlefield Augmented Reality System,” Simon Julier, Yohan Baillot, Marco Lanzagorta, Dennis Brown, Lawrence Rosenblum; NATO Symposium on Information Processing Techniques for Military Systems, 2000. From the Abstract: “The system consists of a wearable computer, a wireless network system and a tracked see-through Head Mounted Display (HMD). The user's perception of the environment is enhanced by superimposing graphics onto the user's field of view. The graphics are registered (aligned) with the actual environment.”

Non-military-specific developments were underway as well, including the work of Hirokazu Kato, the ARToolkit, at the Nara Institute of Science and Technology and later published and further developed at HITLab, which introduced a software development suite and protocol for viewpoint tracking and virtual object tracking.

These milestones are frequently cited as most significant during this period, although other researchers and companies were active in the field.

While military funding for large-scale development and testing of AR for training-simulation is well-documented, and the need for such obvious, other system-level designs and system demonstrations were underway concurrently with military-funded research efforts.

Among the most important non-military experiments was the AR version of the video game Quake, ARQuake, a development initiated and led by Bruce Thomas at the Wearable Computer Lab at the University of South Australia, and published in “ARQuake: An Outdoor/Indoor Augmented Reality First Person Application,” 4th International Symposium on Wearable Computers, pp 139-146, Atlanta, Ga., October 2000; (Thomas, B., Close, B., Donoghue, J., Squires, J., De Bondi, P., Morris, M., and Piekarski, W.). From the Abstract: “We present an architecture for a low cost, moderately accurate six degrees of freedom tracking system based on GPS, digital compass, and fiducial vision-based tracking.”

Another system which began design development in 1995 was one developed by the author of the present disclosure. Initially intended to realize a hybrid of open-air AR and television programing, dubbed “Everquest Live,” the design was further developed through the late nineties, with the essential elements finalized by 1999, when a commercial effort to fund the original video game/tv hybrid was launched, and which by then included another version, for use in a high-end themed resort development. By 2001, it was being disclosed on a confidential basis to companies including the Ridley and Tony Scott companies, in particular their joint venture, Airtightplanet (other partners including Renny Harlin, Jean Giraud, and the European Heavy Metal), for which the author of the present disclosure served as an executive overseeing operations and to which he brought the then “Otherworld” and “Otherworld Industries” project and venture as a proposed joint venture for investment and collaboration with ATP.

The following is a summary of the system design and components as they were finalized by 1999/2000:

EXCERPT FROM “OTHERWORLD INDUSTRIES BUSINESS PROPOSAL DOCUMENT” (archive document version, 2003); Technical Backgrounder: Proprietary Integration of State of the Art Technologies “Open-field” Simulation and Mobile Virtual Reality: Tools, Facilities and Technologies:

This is only a partial list and summary of relevant techniques, that together form the backbone of a proprietary system. Some technology components are proprietary, some from outside vendors. But the unique system that combines the proven components will be absolutely proprietary—and revolutionary:

Interacting with a VR-Altered World:

1) Mobile Military-grade VR equipment for immersion of the guest/participants and actors in the VR-augmented landscape of the OTHERWORLD. While their “adventure” (that is, their every motion as they explore the OTHERWORLD around the resort) is being captured in real-time by the mobile motion-capture sensors and digital cameras (with automatic matting technology), guest/players and employee/actors can see each other through their visors along with overlays of computer simulation imagery. Visors are either binocular, semi-transparent flat panel displays, or binocular, but opaque flat panel displays with binocular cameras affixed to the front.

These “synthetic elements,” superimposed by the flat panel displays in the field of view, can include altered portions of the landscape (or the entire landscape, altered digitally). In effect, those portions of “synthetic” landscape that replace what is really there are generated based on original 3D photographic “captures” of every part of the resort. (See #7 below). As accurate, photo-based geometric “virtual spaces” in the computer, it is possible to digitally alter them in any way, while maintaining the photo-real quality and geometric/spatial accuracy of the original capture. This makes for accurate combination of live digital photography of the same space and altered digital portions.

Other “synthetic elements” superimposed by the flat panel display include people, creatures, atmospheric FX, and “magic” which are computer generated or altered. These appear as realistic elements of the field of view through the displays (transparent or opaque).

Through use of positioning data, motion-capture data of the guests/players and employee/actors, and real-time matting of the same by multiple digital cameras, all of which are calibrated to the previously “captured” versions of each area of the resort (see #4 & 5 below), synthetic elements can be matched with absolute accuracy, in real time, to the real elements shown through the display.

Thus a photo-real computer-generated dragon can appear to pass behind a real tree, come back around, and then fly up and land on top of the real castle of the resort—which the dragon can then “burn” with computer-generated fire. In the flat panel display (semi-transparent or opaque), the fire appears to leave the upper portion of the castle “blackened.” This effect is achieved because through the visor, the upper portion of the castle has been “matted-over” by a computer altered version of a 3D “capture” of the castle in the system's file.

2) Physical Electro-optic-mechanical Gear for combat between real people and virtual people, creatures and FX. “Haptic” interfaces that provide motion-sensor and other data, as well as vibrational and resistance feedback, allow real-time interaction of real people with virtual people, creatures, and magic. For example, a haptic device in the form of a “prop” sword haft provides data while the guest/player is swinging it, and physical feedback when the guest/player appears to “strike” the virtual ogre, to achieve the illusion of combat. All of this is combined in real-time and displayed through the binocular flat panel displays.

3) Open-field Motion-capture equipment. Mobile and fixed motion capture equipment rigs, (similar to those used for The Matrix movies), are deployed throughout the resort grounds. Data points on the themed “gear” worn by guest/players and empolyee/actors are tracked by cameras and/or sensors to provide motion data for interaction with virtual elements in the field of view displayed on the binocular flat-panels in the VR visor.

The output from the motion-capture data makes possible (with sufficient computational rendering capacity and employment of motion-editing and motion-libraries) CGI altered versions of guests/players and employee/actors along the principle of the Gollum character in the second and third films of The Lord of the Rings.

4) Augmentation of Motion-capture Data with LAAS & GPS data, live laser range-finding data and triangulation techniques (including from Moller Aerobot UAV's). Additional “positioning data” allow for even more effective (and error-correcting) integration of live and synthetic elements.

From a news release by a UAV manufacturer:

July 17th. One week ago a contract was given to Honeywell for the initial network of Local Area Augmentation System (LAAS) stations, and a few test stations are already in operation. This system will make it possible to guide aircraft accurately to touchdown at airports (and vertiports) with an accuracy of inches. The LAAS system is expected to be operational by 2006.

5) Automatic Real-time Matting of Open-field “Play.” In combination with the motion-capture data allowing interaction with simulated elements, resort guest/participants will be digitally imaged with P24 (or equivalent) digital cameras, working with proprietary Automatte software, to automatically isolate (matte) the proper elements from the field of view to be integrated with synthetic elements. This technique will be one of a suite used to ensure proper separation of foreground/background when superimposing digital elements.

6) Military-grade Simulation Hardware and Technology combined with state-of-the-art Game Engine Software. Combining the data from the motion-capture system, haptic devices for interacting with “synthetic” elements like prop swords, synthetic elements and live elements (matted or complete), is integrated by military simulation software and game engine software.

These software components provide AI code to animate synthetic people and creatures (AI—or artificial intelligence—software such as the Massive software used to animate the armies in The Lord of the Rings movies), generate realistic water, clouds, fire, etc, and otherwise integrate and combine all elements, just as computer games and military simulation software do.

7) Photo-based capture of real locations to create the realistic digital virtual sets with image-based techniques, pioneered by Dr. Paul Debevec (basis of the “bullet-time” FX for The Matrix).

The “base” virtual locations (interiors and exteriors of the resort) are indistinguishable from the real world, as they are derived from photographs and the real lighting of the location when “captured.” A small set of high-quality digital images, combined with data from light probes and laser-range finding data, and the appropriate “image-based” graphics software are all that are needed to recreate a photo-real virtual 3D space in the computer that matches the original exactly.

Though the “virtual sets” are captured from the real castle interiors and the exterior locations in the surrounding countryside, once digitized these “base” or default versions, with the lighting parameters and all the other data from the exact time when originally captured, can be altered, including the lighting, with elements added that don't exist in the real world, and with the elements that do exist altered and “dressed” to create a fantasy version of our world.

When guest/players and employee/actors cross the “gateways” at various points in the resort (the “gateways” are the effective “crossing points” from “Our World” to the “Otherworld”), a calibration procedure takes place. Positioning data from the guest/player or employee/actor at the “gateway” are taken at that moment to “lock” the virtual space in the computer to the coordinates of the “gateway.” The computer “knows” the coordinates of the gateway points with respect to its virtual version of the entire resort, obtained through the image-based “capture” process described above.

Thus, the computer can “line up” its virtual resort with what the guest/player or employee/actor sees before they put in the VR goggles. And therefore, through a semi-transparent version of the binocular flat panel displays, if the virtual version were superimposed over the real resort, the one would match up with the other very precisely.

Alternatively, with an “opaque” binocular flat panel display goggle or helmet, the wearer could confidently walk with the helmet on, seeing only the virtual version of the resort in front of him, because the landscape of the virtual world would match exactly the landscape he is actually walking on.

Of course, what could be shown to him through the goggles would be an altered red sky, boiling storm clouds that aren't really there, and a castle parapet with a dragon perched on top, having just “set fire” to the castle battlements.

As well as an army of 1000 Orcs charging down the hill in the distance!

8) Supercomputer Rendering and Simulation Facility at the Resorts. A key resource that will make possible the extremely high-quality, near feature-film quality simulations will be a supercomputer rendering and simulation complex in situ at each resort.

The improvement in graphics and game play on standalone computer game consoles (Playstation 2, Xbox, GameCube), as well as computer games for desktop computers, is well-known.

Consider, however, that that improvement in the gaming experience is based on the improvement of the processors and supporting systems of a single console or personal computer. Imagine then putting the capacity of a supercomputing center behind the gaming experience. That alone would be a quantum leap in the quality of graphics and gameplay. And that is only one aspect of the mobile VR adventuring that will be the Otherworld experience.

As will be evident from a review of the foregoing, and which should be evident to those skilled in the relevant arts, which are the fields of VR, AR, and simulation more broadly, individual hardware or software systems that are proposed to improve the state-of-the-art must take into account the broader system parameters and make explicit those assumptions about those system parameters, to be properly evaluated.

The substance thus of the present proposal, the focus of which is a hardware technology system that falls under the category of portable AR and VR technologies, and is in fact of fusion of both, but which is in its most preferable versions a wearable technology, and in the preferred wearable version, is an HMD technology, only makes a complete case for being a superior solution by consideration or re-consideration of the entire system of which it is a part. Thus the need for presentation of this history of the larger VR, AR and simulation systems, because there is a tendency in proposals for and commercial offerings of new HMD technologies, for instance, to be too narrow, and not take into account, nor review, the assumptions, requirements, and new possibilities at the system level.

A similar historical review of the major milestones in the evolution of HMD technologies is not necessary, as it is the broader history at the system level that will be necessary to provide a framework that can be drawn upon to help explain the limitations of the prior art and status quo of the prior art in HMD's, and the reasons for the proposed solutions and why the proposed solution solves the identified problems.

What is sufficient to understand and identify the limitations of the prior art in HMD's begins with the following.

In the category of head mounted displays (which, for the purposes of the present disclosure, subsumes helmet-mounted displays), there have been identified up to now two main sub-types: VR HMD's and AR HMD's, following the implications of those definitions already provided herein, and within the category of AR HMD's, two categories have been employed to differentiate the types are either “video see-through” or “optical see-through” (more often simply termed “optical HMD.”

In VR HMD displays, the user views a single panel or two separate displays. The typical shape of such HMD's typically is that of a goggle or face-mask, although many VR HMD's have the appearance of a welder's helmet with a bulky enclosed visor. To ensure optimal video quality, immersion and lack of distraction, such systems are fully-enclosed, with the periphery around the displays a light-absorbent material.

The author of the present disclosure had previously proposed two types of VR HMD's, in the incorporated U.S. Provisional Application “SYSTEM, METHOD AND COMPUTER PROGRAM PRODUCT FOR MAGNETO-OPTIC DEVICE DISPLAY”. One the two simply proposed a replacing a conventional direct-view LCD with a wafer-type embodiment of the primary object of that application, the first practical magneto-optic display, whose superior performance characteristics include extremely high frame rate, among other advantages for an improved display technology overall, and in that embodiment, for an improved VR HMD.

The second version contemplated, according to the teachings of the disclosure, a new kind of remotely-generated image display, which would be generated, for instance, in a vehicle cockpit, and then transmitted, via fiber-optic bundle, and then distributed, through a special fiber-optic array structure (structures and methods for which were disclosed in the application), building on the experience of fiber-optic faceplates with a new approach and structure for remote image-transport via optical fiber.

While the core MO technology was not productized for HMD's initially, but rather for projection systems, these developments are of relevance to some aspects of the present proposal, and in addition are not generally known to the art. The second version, in particular, disclosed a method that was made public in advance of other, more recent proposals using optical fiber to convey a video image from image engine not integrated into or near the HMD optics.

A crucial consideration of the practicality of a fully-enclosed VR HMD to mobility, beyond a tightly controlled stage environment with even floors, is that for locomotion to be safe, the virtual world being navigated has to map 1:1, within a deviation safe to human locomotion, to a real surface topography or motion path.

However, as has been observed and concluded by researchers such as Barrilleaux from the Loral WDL, the developers of BARS, and consistently by other researchers in the field over the past nearly quarter century of development, for AR systems qua systems to be practical, a very close correspondence must be obtained between the virtual (synthetic, CG-generated imagery) and the real-world topography and built-environment, including (as is not surprising from the development of systems by the military for urban warfare) the geometry of moving vehicles.

Thus, it is more the general case that for either VR or AR to be enabled in mobile form, there must be a 1:1 positional correspondence between any “virtual” or synthetic elements and any real-world elements.

In the category of AR HMD's, the distinction between “video see-through” and “optical see-through” is the distinction between the user looking directly through a transparent or semi-transparent pixel array and display, which is disposed directly in front of the viewer, as part of the glasses optic itself, and looking through a semi-transparent projected image on an optic element also disposed directly in front of the viewer, generated from a (typically directly adjacent) micro-display and conveyed through forms of optical relay to the facing optic piece.

The main and possibly only partly-practical type of direct view-through display a transparent or semi-transparent display system has (historically) been an LCD configured without an illumination backplane—therefore, specifically, the AR video view-through glasses hold a viewing optic(s) which includes a transparent optical substrate onto which has been fabricated a LCD light modulator pixel array.

For applications similar to the original Mann “EyeTap”, in which text/data are displayed either directly or projected on the facing optics, calibration to real-world topography and objects is not required, though some degree of positional correlation is helpful for contextual “tagging” of items in the field of view with information text. Such is the stated primary purpose of the Google Glass product, although as the drafting of this disclosure, a great many developers are focused on development AR-type applications which super-impose more than text on the live scene.

A major problem of such “calibration” to topography or objects in the field of view of the user of either a video or optical see-through system, other than a loose proximate positional correlation in an approximate 2D plane or rough viewing cone, is the determination of relative position of objects in the environment of the viewer. Calculation of perspective and relative size, without significant incongruities, cannot be performed without either reference and/or roughly real-time spatial positioning data and 3D mapping of the local environment.

A key aspect of perspective, from any viewing point, in addition to relative size, is realistic lighting/shading, including drop shadows, depending on lighting direction. And finally, occlusion of objects from any given viewing positioning, is a key optical characteristic of perceived perspective and relative distance and positioning.

No video see-through or optical see-through HMD exists or can be designed in isolation from the question of how such data is provided to enable, in either video or optical view-through-type systems, or indeed for mobile VR-type systems, dimensional viewing of the wearers surroundings, essential so safe locomotion or path-finding. Will such data be provided externally, locally, or a combination of sources? If in part local and part of the HMD, how does this affect the design and performance of the total HMD system? What affect, if any, does this question have on the choice between video and optical-see-through, given weight, balance, bulk, data processing requirements, lag between components, among other implications and affected parameters, and on the choice of display and optical components in detail?

Among the technical parameters and problems to be solved during the evolution and advances in VR HMD's, have been included principally the problems of increasing field of view, reducing latency (lag between motion-tracking sensors and changes in the virtual perspective), increasing resolution, frame-rate, dynamic range/contrast, and other general display quality characteristics, as well as weight, balance, bulk, and general ergonomics. The details of image collimation and other display optics have improved to effectively address the problem of “simulator sickness” that was a major issue from the early days.

Display, optics and other electronics weight and bulk have tended to diminish over time with the improvements in these general categories of technologies, as well as weight, size/bulk and balance.

Stationary VR gear has generally been employed for night-vision systems in vehicles, including aircraft; mobile night-vision goggles, however, can be considered a form of mediated viewing similar to mobile VR, because essentially what the wearer is viewing is a real scene (IR-imaged) in real-time, but through a video screen(s), and not in a form of “view-through.”

This sub-type is similar to what Barrilleaux defined, in the same referenced 1999 retrospective, as an “indirect view display.” He offered his definition with respect to a proposed AR HMD in which there is no actual “view-through,” but rather what is viewed is exclusively a merged/processed real/virtual image on a display, presumably as contained as any VR-type or night-vision system.

A night vision system, however, is not a fusion or amalgam of virtual-synthetic landscape and real, but rather a direct-transmitted video image of IR sensor data as interpreted, through video signal processing, as a monochrome image of varying intensity, depending on the strength of the IR signature. As a video image, it does lend itself to real-time text/graphics overlay, in the same simple form in which the Eyetap was originally conceived, and as Google has stated is the intended primary purpose for its Glass product.

The problem of how and what data to extract live or provide from reference, or both, to either a mobile VR or mobile AR system, or now including this hybrid live processed video-feed “indirect view display” that has similarities to both categories, to enable an effective integration of the virtual and the real landscape to provide a consistent-cued combined view is a design parameter and problem that must be taken into account in designing any new and improved mobile HMD system, regardless of type.

Software and data processing for AR has been advanced to deal with these issues, building on the early work of the system developers referenced already. And example of this is the work of Matsui and Suzuki, of Canon Corporation, as disclosed in their pending U.S. patent application, “Mixed reality space image generation method and mixed reality system,”

(US Patent Application 20050179617, filed Sep. 29, 2004). Their Abstract:

“A mixed reality space image generation apparatus for generating a mixed reality space image formed by superimposing virtual space images onto a real space image obtained by capturing a real space, includes an image composition unit (109) which superimposes a virtual space image, which is to be displayed in consideration of occlusion by an object on the real space of the virtual space images, onto the real space image, and an annotation generation unit (108) which further imposes an image to be displayed without considering any occlusion of the virtual space images. In this way, a mixed reality space image which can achieve both natural display and convenient display can be generated.”

The purpose of this system was designed to enable combination of a fully-rendered industrial product, such as a camera, to be superimposed on a mockup (stand-in prop); both a pair of optical view-through HMD glasses and the mockup are equipped with positional sensors. A real-time pixel-by-pixel look-up comparison process is employed to matte out the pixels from the mockup so that the CG-generated virtual model can be superimposed on a composited video feed (buffer-delayed, to enable the layering with a slight lag). Annotation graphics are also added by the system. Computer graphics. The essential sources of data to determine matting and thus ensure correct and not erroneous occlusion in the composite is the motion sensor on the mockup and the pre-determined lookup table that compares pixels to pull a hand matte and a mockup matte.

While this system does not lend itself to generalization for mobile AR, VR, or any hybrids, it is an example of an attempt to provide a simple, though not entirely automatic, system for analyzing a real 3D space and positioning virtual objects properly in perspective view.

In the domain of video or optical see-through HMD's, little progress has been made in designing a display or optics and display system which can implement, even under the assumption of an ideally calculated mixed-reality perspective view delivered to the HMD, a satisfactory, realistic and accurate merged perspective view, including the handling of the proper order of perspective an proper occlusion of merged elements from any given viewer position in real-space.

One system claiming the most effective solution, even if partial, to this problem, and perhaps the only integrated HMD system (as opposed to software/photogrammetrics/data-processing and delivery systems designed to solve those issues in some generic fashion, independent of HMD), has been referenced in the preceeding already, which is the proposal of Chunyu Gao in US Patent Application 20140177023, “APPARATUS FOR OPTICAL SEE-THROUGH HEAD MOUNTED DISPLAY WITH MUTUAL OCCLUSION AND OPAQUENESS CONTROL CAPABILITY.”

Gao begins his survey of the field of view-through HMDS for AR with the following observations:

There are two types of ST-HMDs: optical and video (J. Rolland and H. Fuchs, “Optical versus video see-through head mounted. displays,” In Fundamentals of Wearable Computers and Augmented Reality, pp. 113-157, 2001.). The major drawbacks of the video see-through approach include: degradation of the image quality of the see-through view; image lag due to processing of the incoming video stream; potentially loss of the see-through view due to hardware/software malfunction. In contrast, the optical see-through HMD (OST-HMD) provides a direct view of the real world through a beamsplitter and thus has minimal affects to the view of the real world. It is highly (preferred in demanding applications where a user's awareness to the live environment is paramount.

However, Gao's observations of the problems with video see-through are not qualified, in the first instance, by specification of prior art video see-through as being exclusively LCD, nor does he validate the assertion that LCD must (comparatively, and to what standard is also omitted) degrade the see-through image. Those skilled in the art may recognize that this view, of a poor-quality image, is derived from the results achieved in early view-through LCD systems, prior to the recent acceleration of advances in the field. It is not ipso-facto true nor evident that an optical see-through system, with the employment of by comparison many optical elements and the impacts of other display technologies on the re-processing or mediation of the “real” “see-through image”, by comparison to either state-of-the-art LCD or other video view-through display technologies, will relatively degrade the final result or be inferior to a proposal such as Gao's.

Another problem with this unfounded generalization is the presumption of lag in this category of see-through, as compared to other systems which also must process an input live-image. In this case, comparison of speed is a result of detailed analysis of the components and their performance, in aggregate, of competing systems. And finally, the conjecture of “potentially loss of see-through view to hardware/software” is essentially gratuitous, arbitrary, and not validated either by any rigorous analysis of comparative system robustness or stability, either between video and optical see-through schemes generally, or between particular versions of either and their component technologies and system designs.

Beyond the initial problem of faulty and biased representation of the comparatives in the fields, there are the qualitative problems of the solutions proposed themselves, including the omission and lack of consideration of the proposed HMD system as a complete HMD system, including as a component in a wider AR system, with the data acquisition, analysis and distribution issues that have been previously referenced and addressed. An HMD can not be allowed to treat as a “given” a certain level and quality of data or processing capacity for generation of altered or mixed images, when that alone is a significant question and problem, which the HMD itself and its design can either aid or hinder, and which simply cannot be offered as a given.

In addition, omitted from the specification of problem-solution are the complete dimension of the problem of visual integration of real and virtual in a mobile platform.

To take the disclosure and the system it teaches, specifically:

As has been described earlier in this background, the Gao proposal is to employ two display-type devices, as the specification of the spatial light modulator which will selectively reflect or transmit the live image is essentially the specification of an SLM for the same purposes as they are in any display application, operatively.

Output images from the two devices are then combined in a beam-splitter, combiner, which is assumed, without any specific explanation other than a statement about the precision of such devices, while line-up on a pixel-by-pixel basis.

However to accomplish this merger of two pixelated arrays, Gao specifies a duplication of what he refers to as “folded optics,” but is nothing essentially other than a dual version of the Mann Eyetap scheme, requiring in total two “folding optics” elements (e.g., planar grating/HOE or other compact prism or “flat” optics, one each for each source, plus two objective lens (one for wave-front from the real view, one at the other end for focus of the conjoined image, and a beam-splitter combiner).

Thus, multiple optical elements (for which he offers a variety of conventional optics variations), are required to: 1) collect light of the real scene via a first reflective/folding optic (planar-type grating/mirror, HOE, TIR prism, or other “flat” optics) and from there to the objective lens, pass it to the next planar-type grating/mirror, HOE, TIR prism, or other “flat” optics to “fold” the light path again, all of which is to ensure that the overall optical system is relatively compact and contained in a schematic set of two rectangular optical relay zones; from the folding optics, the beam is passed through the beam-splitter/combiner to the SLM; which then reflects or transmits, on a pixelated (sampled) basis, and thus passes the variably (variation from the real image contrast and intensity to modify grey scale, etc) modulated, now pixellated real-image back to the beam splitter/combiner. While the display generates, in sync, the virtual or synthetic/CG image, presumably also calibrated to ensure ease of integration with the modified, pixelated/sampled real wave-front, and is passed through the beam-splitter to integrate, pixel-for-pixel, with the multi-step, modified and pixelated sample of the real scene, from thence through an eyepiece objective lens, and then back to another “folding optics” element to be reflected out of the optical system to the viewers eye.

In total, for the modified, pixelated-sampled portion of the real image wave-front, passes through seven optical elements, not including the SLM, before it reaches the viewers eye; the display-generated synthetic image, only pass-through two.

While the problems of accurate alignments of optical image combiners, down to the pixel level, whether it is reflected light gathered from an image sample interrogated by laser or combining images generated small-featured SLM/display devices, maintaining alignments, especially under conditions of mechanical vibration and thermal stress, is considered non-trivial in the art.

Digital projection free-space optical beam-combining systems, which combine the outputs of high-resolution (2k or 4k) red, green and blue image engines (typically, images generated by DMD or LCoS SLM's are expensive achieving and maintaining these alignments are non-trivial. And some designs are simpler than in the case of the 7-element let of the Gao scheme.

In addition, these complex, multi-engine, multi-element optical combiner systems are not nearly as compact as is required for an HMD.

Monolithic prisms, such a the T-Rhomboid combiner developed and marketed by Agilent for the life-sciences market, have been developed specifically to address the problems that free-space combiners have exhibited in existing applications

And while companies such as Microvision and others have successfully deployed their SLM-based, originally-developed for micro-projection technology into HMD platforms, these optical setups are typically substantially less complicated than the Gao proposal.

In addition, it is difficult to determine what the basic rationale is for two image processing steps and calculation iterations, on two platforms, and why that is required to achieve the smoothing and integration of the real and virtual wave-front inputs, implementing the proper occlusion/opaquing of the combined scene elements. It would appear that Gao's biggest concern and problem to be solved is the problem of the synthetic image competing, with difficulty, against the brightness with the real image, and that the main task of the SLM thus seems to bring down, selectively, the brightness of portions of the real scene, or the real-scene overall. In general, it is also inferred that, while bringing down the intensity of an occluded real-scene element, for instance by minimizing the duration of a DMD mirror in reflective position in a time-division multiplexing system, the occluded pixel would simply be left “off,” although this is not specified by Gao, nor are the details of how the SLM will accomplish its image-altering function related.

Among the many parameters that will have to be both calculated, calibrated and aligned, include determination of the exactly what pixels from the real-field are the calibrated pixels to the synthetic ones. Without exact matching, ghost overlaps and mis-alignments and occlusions will multiply, particularly in a moving scene. The position of the reflective optical element that passes the real-scene wave-front portion to the objective lens has a real perspective position in relation to the scene which is, first, not identical to the perspective position of the viewer in the scene, as it is not flat nor positioned at dead center, and it is only a wave-front sample, not what the position. And furthermore, when mobile, also moving, and also not known to the synthetic image processing unit in advance. The number of variables in this system is extremely large by virtue of these facts alone.

If they were, and the objective of this solution made more specific, it might become clear that there may be simpler methods for accomplishing this than the use of a second display (in a binocular system, adding a total of 2 displays, the specified SLM's).

Second, it is clear on inspection of the scheme that if any approach would, by virtue of the durability of such a complex system with multiple, cumulative alignment tolerances, the accumulation of defects from original parts and wear-and-tear over time in the multi-element path, mis-alignment of the merged beam form the accumulated thermal and mechanical vibration effects, and other complications arising from the complexity of a seven-element plus optical system, it is this system that inherently poses a probably degradation, especially over time, of the exterior live image wave-front.

In addition, as has been noted at some length previously, the problem of computing the spatial relationship among real and virtual elements is a non-trivial one. Designing a system which must drive, from those calculations, two (and in a binocular system), four display-type devices, most likely of different types (and thus with differing color gamut, frame-rate, etc.), adds complication to an already demanding system design parameter.

Furthermore, in order to deliver a high-performance image without ghosting or lag, and without inducing eyestrain and fatigue to the visual system, a high frame rate is essential. However with the Gao system, the system design becomes slightly more simplified only with use of view-through, rather than reflective, SLM's; but even with the faster FeLCoS micro-displays, the frame rate and image speed is still substantially less than that of the MEMS device such as TI's DLP (DMD).

However, as higher resolution for HMD's is also desired, at the very least to achieve wider FOV, a recourse to a high-resolution DMD such as TI's 2k or 4k device means recourse to a very expensive solution, as DMD's with that feature size and number are known to have low yields, higher defect rates than can be typically tolerated for mass-consumer or business production and costs, a very high price point for systems in which they are employed now, such as digital cinema projectors marketed commercially by TI OEM's Barco, Christie, and NEC.

While it is an intuitively easy step to go from flat-optic projection technologies for optical see-through HMDS, such as Lumus, BAE, and others, where occlusion is neither a design objective nor possible within the scope and capabilities of these approaches, to essentially duplicating that approach and to modulate the real image, and then combine the two images using a conventional optical setup such as Gao proposes, while relying on a high number of flat optical elements to effect the combination and to do so in a relatively compact space.

To conclude the background review, and returning to the current leaders in the two general categories of HMD, optical see-through HMDs and classical VR HMD's, the current state of the art may be summarized as follows, noting that other variants optical see-through HMD's and VR HMD's are both commercially available as well as subjects of intense research and development, with a significant volume of both commercial and academic work, including product announcements, publishing and patent applications that have escalated substantially since the break-through from Google, Glass, and the Oculus VR HMD, the Rift:
Google, with Glass, the commercially-leading mobile AR optical HMD, has, at the time of this writing, established a breakthrough public visibility for and dominant marketing position for the optical see-through HMD category.

However, they followed others to market who had already been developing and fielding products in the primarily defense/industrial sectors, including Lumus and BAE (Q-Sight holographic waveguide technology). Among other recent market and research stage entries are found companies such as as TruLife Optics, commercializing research out of the UK National Physical Reality, also in the domain of holographic waveguides, where they claim a comparative advantage.

For many military helmet-mounted display applications, and for Google's official primary use-case for Glass, again as analyzed in the preceding, super-imposition of text and symbolic graphical elements over the view-space, requiring only rough positional correlation, may be sufficient for many initial, simple mobile AR applications.

However, even in the case of information display applications, it is evident that the greater the density of tagged information to items and topography in the view-space facing (and ultimately, surrounding) the viewer, the greater the need for spatial order/layering of tags to match the perspective/relative location of the elements tagged.

Overlap—i.e., partial occlusion of tags by real elements in the field of view, and not just overlap of the tags themselves, thus by necessity becomes a requirement of even a “basic” informational-display-purposed optical view-through system, in order to manage visual clutter.

As tags must in addition reflect not just relative position of the tagged elements in a perspective view of the real space, but also a degree of both automated (based on pre-determined or software-calculated) priority and real-time, user assigned priority, size of tags and degree of transparency, to name but two major visual cues employed by graphical systems to reflect informational hierarchy, must be managed and implemented as well.

The question then immediately arises, in detailed consideration of the problems of semi-transparency and overlap/occlusion of tags and super-imposed graphical elements, how to deal with question of relative brightness of the live-elements which are passed-through the optical elements of these basic optical see-through HMDs (whether monocular reticle-type or binocular full glasses-type) and the super-imposed, generated video display elements, especially in brightly lit outdoor lighting conditions and in very dimly-lit outdoor conditions. Night-time usage, to fully extend the usefulness of these display types, is clearly an extreme case of the low-light problem.

Thus, as we move past the most limited use-case conditions of the passive optical-see-through HMD type, as information density increases—which will be expected as such systems become commercially-successful and normally-dense urban or suburban areas obtain tagging information from commercial businesses—and as usage parameters under bright and dim conditions add to the constraints, it is clear that “passive” optical see-through HMD's cannot escape, nor cope with, the problems and needs of any realistic practical implementation of mobile AR HMD.

Passive optical pass-through HMD's must then be considered an incomplete model for implementing mobile AR HMD and will become, in retrospect, seen as only a transitional stepping stone to an active system.
Oculus Rift VR (Facebook) HMD: Somewhat paralleling the impact of the Google Glass product-marketing campaign, but with the difference that Oculus had actually also led the field in solving and/or beginning to substantially solve some of the significant threshold barriers to a practical VR HMD (rather than following Lumus and BAE, in the case of Google), the Oculus Rift VR HMD at the time of this writing is the leading pre-mass-release VR HMD product entering and creating the market for widely-accepted consumer and business/industrial VR.

The basic threshold advances of the Oculus Rift VR HMD may be summarized in the following product feature list:
Significantly Widened Field of View, achieved by using a single currently 7″ diagonal display of 1080p resolution, positioned several inches from the users eyes, and divided into binocular perspective regions on the unitary display. Current FOV, as if this writing, is 100 degrees (improving their original 90 degrees), as compared to 45 degrees total, a common specification of pre-existing HMD's. Separate binocular optics implement the stereo-vision effect.
Significantly improved head-tracking, resulting in low lag; this is an improved motion-sensor/software advance, and taking advantage of miniature motion-sensor technology that had migrated from the Nintendo Wii, Apple and other fast-followers in mobile phone sensor technologies, Playstation PSP and now Vita, Nintendo DS now 3DS, and the Xbox Kinect system, among other handheld and handheld device products with built-in motion sensors for 3D-dimensional positional tracking (accelerometers, MEMS gyroscopes, etc.) Current head-tracking implements a multi-point infrared optical system, with an external sensor(s) working in concert.
Low latency, a combined result of improved head-tracking and fast-software-processor updating to an interactive game software system, although limited by the inherent response time of the display technology employed, originally LCD, which was replaced by somewhat faster OLED.
Low Persistence, which is a form of buffering to help keep the video stream smooth, working in combination with the higher-switching speed OLED display.
Lighter weight, reduced bulk, better balance, and overall improved ergonomics, by employing a ski-goggle form-factor/materials and mechanical platform.

To summarize the net benefit of combining these improvements, while the system as such may not have been structurally or operatively new in pattern, the net effect of improved components and a particularly effective design patent U.S. D701,206, as well as any proprietary software, has resulted in an breakthrough level of performance and validation of mass-market VR HMD.

Following their lead and adopting their approach, in many cases, with a few contemporaneous product programs in the case of others who have altered their designs based on the success of the Oculus VR Rift configuration, there have been a number of VR HMD product developers, both branded name companies and startups, which made product plan announcements following the original 2012 Electronic Expo demonstration and Kickstarter financing campaign by Oculus VR.

Among those fast-followers and others who evidently altered their strategies to follow the Oculus VR template, are Samsung, whose demonstrated development model as of this writing closely resembles the Oculus VR Rift design, and Sony's Morpheus. Startups which have gained notice in the field include Vrvana (formerly True Gear Player, GameFace, InfiniteEye, and Avegant.

None of these system configurations appear absolutely identical to Oculus VR, though some use 2 and others 4 panels, with the 4 panel system employed by InfiniteEye to widen the FOV to claimed 200+ degrees. Some use LCD and others use OLED. Optical sensors are employed to improve the precision and update speed of the head-tracking systems.

All of the systems are implemented for essentially in-place or highly-constrained mobility. The employ on-board and active-optical marker-based motion tracking systems designed for use in enclosed spaces, such as a living room, surgical theatre, or simulator stage.

The systems with the greatest difference from the Oculus VR scheme are Avegant's Glyph and the Vrvana Totem.

The Glyph actually implements a display solution which follows the previously established optical view-through HMD solution and structure, employing a Texas Instruments DLP DMD to generate a projected micro-image onto a reflective planar optic element, in configuration and operation the same as the planar optical elements of existing optical view-through HMDs, with the difference that a high-contrast, light absorbent backplane structure is employed to realize a reflective/indirect micro-projector display type, with an video image belonging in the general category of opaque, non-transparent display images.

Here, though, as has been established in the preceding in the discussions of the Gao disclosure, the limitations on increasing display resolution and other system performance beyond 1080p/2k, when employing a DLP DMD or other MEMS component are those of cost, manufacturing yield and defect rates, durability, and reliability in such systems.

In addition, limitations on image size/FOV from the limited expansion/magnification factor of the planar optic elements (gratings structures, HOE or other), which expands the SLM image size but and interaction/strain on the human visual system (HVS), especially the focal-system, present limitations on the safety and comfort of the viewer. User response to the employment of similar-sized but lower resolution images in the Google Glass trial suggest that further straining the HVS with a higher-resolution, brighter but equally small image area poses challenges to the HVS. Ophamologist Dr. Eli Peli, official consultant to Google, followed up an earlier warning in an interview with online site BetaBeat (May 19, 2014) to Google Glass users to anticipate some eye strain and discomfort with a revised warning (May 29, 2014) that sought to limit the cases and scope of potential usage. The demarcation was on eye muscles used in ways they are not designed or used to for prolonged periods of time, and proximate cause of this in the revised statement was the location of the small display image, forcing the user to look up. Other experts

However, the particular combination of eye-muscle usage required for focal usage on a small portion of the real FOV cannot be assumed to be identical to that required for eye-motion across an entire real FOV. The small, micro-adjustments of the focal muscles ipso facto are more constrained and restricted than the range of motion involved in scanning the natural FOV. Thus, the repetitive motion in constrictive ROM is, as is known to the field, not confined only to the direction of focus, although that will be expected, due to the nature of the HVS, to add to the over-strain beyond normal usage, but also to the constraints on range of motion and the requirements of making very small, controlled micro-adjustments.

The added complication is that the level of detail in the constrained eye-motion domain may begin to rapidly, as resolution increases in scenes with complex, detailed motion, exceed the eye fatigue from precision tool-work. No rigorous treatment of this issue has been reported by any developers of optical view-through systems, and these issues, as well as eye-fatigue, headaches, and dizziness problems that Steve Mann has reported over the years from using his EyeTap systems, (which were reportedly in-part improved by moving the image to the center of the field of view in the current Digital EyeTap update but which have not be systematically studied, either), have received only limited comment focused on only a portion of the issues and problems of eye-strain that can develop from near-work and “computer vision sickness.”

However, the limited public comment that Google has made available from Dr. Peli repeatedly asserts that, in general, that Glass as an optical view-through system is deliberately for occaisionaly, rather than prolongued or high-frequency viewing.

Another way to understand the Glyph scheme is that, a the highest level, follows the Mann Digital EyeTap system and structural arrangement, with the variation of implementation for light-isolated VR operation and the employing the lateral projected-planar deflection optical setup of the current optical-view through systems.

In the Vrvana Totem, the departure from the Oculus VR Rift is in adopting the scheme of Jon Barrilleaux's “indirect view display,” by adding binocular, conventional video cameras to allow toggling between a video-captured forward image capture and the generated simulation on the same optically-shrouded OLED display panel. Vrvana have indicated in marketing materials that they may implement this very basic “indirect view display,” exactly following the Barrilleaux-identified schematic and pattern, for AR. It is evident that virtually any of the other VR HMD's of the present Oculus VR generation could be mounted with such conventional cameras, albeit with impacts on weight and balance of the HMD, at a minimum.

It will be evident from the foregoing that little to no substantive progress has been made in the category of “vide see-through HMD” or in general, in the field of “indirect view display,” beyond the category of night-vision goggles, which as a sub-type has been well-developed, but which lacks any AR features other than provision, within the video processor methods known to the art, of adding text or other simple graphics to the live image.

In addition, with respect to the existing limitations to VR HMD's, all such systems employing OLED and LCD panels suffer from relatively low frame-rates, which contributes to motion lag and latency, as well as negative physiological affects on some users, belonging in the broad category of “simulator sickness.” It is noted as well that, in digital stereo-projection systems in cinemas, employing such commercially-available stereo systems as the RealD system, implemented for Texas Instruments DLP DMD-based projectors or Sony LCoS-based projectors, insufficiently high frame rate has also been reported as a contributing to a fraction of the audience, as high as 10% in some studies, experiencing headaches and related symptoms. Some of which are unique to those individuals, but for which a significant percentage are traceable to limitations on frame rate.

And, further, as noted, Oculus VR has implemented a “low persistence” buffering system in pat to compensate for the still insufficiently-high pixel switching/frame rate of the OLED displays which are employed at the time of this writing.

A further impact on the performance of existing VR HMD's is due to the resolution limitations of existing OLED and LCD panel displays, which in part contributes to the requirement of using 5-7″ diagonal displays and mounting them at a distance from the viewing optics (and viewers eyes) to achieve a sufficient effective resolution), contributes to the bulk, size and balance of existing and planned offerings, significantly larger, bulkier, and heavier than most other optical headwear products.

A potential partial improvement is expected to come from the employment of curved OLED displays, which may be expected to further improve FOV without adding bulk. But the expense of bringing to market, at sufficient volumes, requiring significant additional scale investments to fab capacity at acceptable yields, makes this prospect less practical for the near-term. And it would only partially address the problem of bulk and size.

For the sake of completeness, it is also necessary also to mention Video HMD's employed for viewing video content but not interactively or with any motion sensing capability, and thus without the capability for navigating a virtual or hybrid (mixed reality/AR) world. Such video HMD's have essentially improved over the past fifteen years, increasing in effective FOV and resolution and viewing comfort/ergonomics, and providing a development path and advances that current VR HMD's have been able to leverage and build upon for. But these, too, have been limited by the core performance of the display technologies employed, in pattern following the limitations observed for OLED, LCD and DMD-based reflective/deflective optical systems.

Other important variations on the projected image on transparent eyewear optic paradigm include those from Osterhoudt Design Group, Magic Leap, and Microsoft (Hololens).

While these variations possess some relative advantages or disadvantages—relative to each other and to the other prior art reviewed in detail in the preceding—they all retain the limitations of the basic approach.

Even more fundamentally and universally in-common, they are also limited by the basic type of display/pixel technologies employed, as the frame-rate/refresh of existing core display technologies, whether fast LC, OLED or MEMS, and whether employing a mechanical scanning-fiber input or other optics systems disclosed for conveying the display image to the viewing optics, all are still insufficient to meet the requirements of high-quality, easy-on-the-eyes (HVS), low power, high resolutions, high-dynamic range and other display performance parameters which separately and together contribute to realizing mass-market, high-quality enjoyable AR and VR.

To summarize the state of the prior art, with respect to the details covered in the preceding:
“High-acuity” VR has improved in substantially in many respects, from FOV, latency, head/motion tracking, lighter-weight, size and bulk.
But frame rate/latency and resolution, and to a significant corollary degree, weight, size and bulk, are limited by the constraints of core display technologies available.
And modern VR is restricted to stationary or highly-restricted and limited mobile use in small controlled spaces.
VR based on an enclosed version of the optical view-through system, but configured as a lateral projection-deflection system in which an SLM projects an image into the eye via a series of three optical elements, is limited in performance to the size of the reflected image, which is expanded but not much bigger than the output of the SLM (DLP DMD, other MEMS, or FeLCoS/LCoS), as compared to the total area of a standard eyeglass lens. Eye-strain risks from extended viewing of what is an extremely-intense version of “close-up work” and the demands this will make on the eye muscles is a further limitation on practical acceptance. And SLM-type and size displays are also limit a practical path to improved resolution and overall performance by the scaling costs of higher resolution SLM's of the technologies referenced.
Optical view-through systems generally suffer from the same potential for eye-strain by confinement of the eye-muscle usage to a relatively small area, and requiring relatively small and frequent eye-tracking adjustments within those constraints, and for more than brief period of usage. Google Glass was designed to reflect expectations of limited duration usage by positioning the optical element up, and out of the direct rest position of the eyes looking straight ahead. But users have reported eye-strain none-the-less, as has been widely document in the press by means of text and interviews from Google Glass Explorers.
Optical view-through systems are limited in overlaid, semi-transparent information density due to the need to organize tags with real-world objects in a perspective view. The demands of mobility and information density make passive optical-view through limited even for graphical information-display applications.
Aspects of “Indirect view display” have been implemented in the form of night-vision goggles, and Oculus VR competitor Vrvana has only made the suggestion of adapting its binocular video-camera equipped Totem for AR.
The Gao proposal, which although claimed to be an optical view-through display, is in reality more of “indirect view display,” with a quasi-view-through aspect, by means of the usage of an SLM device, functioning as such do in a modified for projection displays, for sampling a portion of a real wave-front and digitally altering portions of that wave-front.

The number of optical elements intervening in the optical routing of the initial wave-front portion (also, a point to be added here, much smaller than the optical area of a conventional lens in a conventional pair of glasses), which is seven or close to that number, introduces both opportunities for image aberration, artifacts, and losses, but requires a complex system of optical alignments in a field in which such complex free-space alignments of many elements are not common and when they are required, are expensive, hard to maintain, and not robust. The method by which the SLM is expected to manage the alteration of the wave-front of the real scene is also not specified nor validated for the specific requirement. Nor is the problem of coordinating the signal processing between 2-4 display-type devices (depending on monocular of binocular system), including determination of the exactly what pixels from the real-field are the calibrated pixels for the proper synthetic ones, in a context in which preforming calculations to create proper relationships between real and synthetic elements in perspective view is already extremely demanding, especially when the individual is moving in an information-dense, topographically complex environment. Mounted on a vehicle only compounds this problem further.

There are myriad additional problems for development of complete system, as compared to the task of building a optical set up as Gao proposes, or even of reducing it to a relatively compact-form factor. Size, balance, and weight are just one of many consequences to the number and by implication, necessary location of the various processing and optics arrays units, but as compared to the other problems and limitations cited, they are by relatively minor, though serious for the practical deployment of such a system to field use, either for military or ruggedized industrial usage or consumer usage.
A 100% “indirect-view display” will have similar demands in key respects to the Gao proposal, with the exception of the number of display-type units and particulars of the alignment, optical system, pixel-system matching, and perspective problems, and thus throws into question the degree to which all key parameters of such a system should require “brute force” calculations of the stored synthetic CG 3D mapped space in coordination with the real-time, individual perspective real-time view-through image. The problem become greater to the extent that the calculations must all be performed, with the video image captured by the forward video cameras, in the basic Barrilleaux and now possible Vrvana design, relayed to a non-local (to the HMD and/or t the wearer him/herself) processor for compositing with the synthetic elements.

What is needed for a truly mobile system, whether VR or AR, which implements both immersion and calibration to the real environment, is the following:
An ergonomic optics and viewing system that minimizes any non-normal demands on the human visual system. This is to enable more extended use, which is implied by mobile use.
A wide FOV, ideally including peripheral view, of 120-150 degrees.
High frame rate, ideally 60 fps/eye, to minimize latency and other artifacts that are typically due to the display.
High effective resolution, at comfortable distance of the unit from the face. The effective resolution standard that may be used to gauge a maximum would either be effective 8k or “retina display.” This distance should be similar to that of conventional eyeglasses, which typically employ the bridge of the nose as a balance point. Collimation and optical path optics are necessary to establish a proper virtual focal plain that also implements this effective display resolution and actual distance of optical element(s) to the eye.
High dynamic range, matching as closely as possible the dynamic range of the live, real view.
On-board motion tracking to determine orientation of both head and body, in a known topography—whether known in advance or known just-in-time within the range of vision of the wearer. This may be supplemented by external systems, in a hybrid scheme.
A display-optics system which enables a fast compositing process, within the context of the human visual system, between the real scene wave-front and any synthetic elements. As many passive means should be employed as possible to minimize the burden on either on-board (to the HMD and wearer) and/or external processing systems.
A display-optics system that is relatively simple and rugged, with few optical elements, few active device elements, and simple active device designs which are both of minimal weight and thickness, and robust under mechanical and thermal stress.
Light weight, low bulk, balanced center of gravity, and form factor(s) which lend themselves to design configurations which are known to be acceptable to both specialized users, such as military and ruggedized-environment industrial users, ruggedizes sports applications, and general consume and business use. Such accepted from factors range from eyeglass manufacturers such as Oakley, Wiley, Nike, and Adidas, to slightly more specialized sport goggles manufacturers, such as Oakley, Adidas, Smith, Zeal and others.
A system which can toggle, variably, between a VR experience, while retaining full mobility, and a variable-occlusion, perspective-integrated hybrid viewing AR system.
A system which can both manage incoming wavelengths for the HVS and obtain effective information from those wavelengths of interest, via sensors, and hybrids of these. IR, visible and UV are typical wavelengths of interest.

The system proposed by the present disclosure solves the problems and meet the ultimate goals for functionality in augmented and virtual reality both, tasks and standards for which the prior art is fundamentally limited and inadequate

The present disclosure incorporates and implements features of telecom-structured and pixel-signal processing systems and hybrid magneto-photonics (pending U.S. patent application Ser. No. [2008]______ and Photonic Encoder Ser. No. ______, by the same inventor), and with a preferred pixel-signal processing sub-type of the Hybrid MPC Pixel Signal Processing, Display and Network of pending U.S. patent application Ser. No. ______, by the same inventor). Addressing and powering of devices, especially of arrays, is preferably that of pending U.S. patent application Ser. No. ______, Wireless Addressing and Powering of Arrays, and preferred embodiments of the hybrid MPC-type system are also found in pending U.S. patent application Ser. No. ______, 3D fab and systems therefrom.

The present application incorporates these pending applications entirely by reference.

However, while establishing the genus's of the system type and that of key sub-systems, as well as preferred versions and embodiments of sub-systems, that is not to say that the details of the present proposal are all contained in the referenced applications and that the present application is simply a combination of those systems, structures, and methods.

Rather, the present proposal sets forth new and improved systems and sub-systems that in most or many cases fall within those referenced (and generally new) categories and classes, with their detailed disclosures of components, systems, sub-systems, structures, processes, and methods, while, by virtue of a unique combination of those and other classes of constituting elements, also thereby realizes a unique new type of mobile AR and VR system, with a preferred embodiment as a wearable system, and of wearable systems, head-mounted being the most preferable.

Specification of the proposed system is best commenced by organizing the overall structure and operational structure by breaking-out (listing) the major sub-systems, and then afterwards providing details of those sub-systems, in a hierarchical out-line form.

Major Subsystems:

I. Telecom-System-type Architecture for Display with Pixel-Signal Processing Platform, and Preferred Hybrid MPC Pixel-signal Processing, including Photonic Encoding Systems and Devices.

II. Sensor System for Mobile AR and VR

III. Structural and Substrating System

What is implemented by these major sub-systems is a novel integrated, dual “generative” and variably-direct transmissive direct-view hybrid display system:

I. Telecom-System-type Architecture for Display with Pixel-Signal Processing Platform, and Preferred Hybrid MPC Pixel-signal Processing, including Photonic Encoding Systems and Devices:

It is an objective of the present disclosure to employ, to the greatest degree possible, a passive optical system and components to help minimize the demand on active device systems for processing sensor data, especially in real-time, and for computation of computer-generated imagery and of computation of 3D, perspective-view integration of real and synthetic/digital or stored digital image information.

The following breakdown of the structural/operational-structural stages, sub-systems, components, and elements of the image processing and pixel-image display generation system will include specification of how this objective is implemented. Taking the structure, components and operational-stages of the system in order, from external image wave-front interception to conveyance of a final, intermediated-image to the HVS (for simplicity, the order is arbitrarily set from left to right (see FIG. 1):

A. General Case—Major Elements of the System:

1. IR/near-IR and UV filtering Stage and Structure (IR and near-IR filtering is dispensed with in versions of the system implemented for night-vision systems).

2. POLARIZATION FILTERING, to reduce incoming pass-through illumination intensity, an option for which there are some benefits and advantages, or POLARIZATION FILTERING/SORTING INTO CHANNELS, POLARIZATION ROTATION, AND CHANNEL RECOMBINATION to preserve maximum input or pass-through illumination stage, an option for which there are other benefits and advantages.

3. PIXELLIZATION or SUB-PIXELIZATION OF THE REAL-WORLD PASS-THROUGH ILLUMINATION AND CHANNELS IMPLEMENTING THESE.

4. INTEGRATING PASS-THROUGH CHANNELS WITH AN ARRAY OF INTERNALLY-GENERATED SUB-PIXELS, COMBINED IN A CONSOLIDATED ARRAY, to realize an optimal augmented/hybrid/mixed reality or virtual reality image display presentation.

i. TWO PREFERRED OVERALL SCHEMES AND STRUCTURAL/ARCHITECTURES FOR TREATING AND PROCESSING PASS-THROUGH (REAL WORLD) ILLUMNATION: While other permutations and versions are enabled by the general features of the present disclosure, the primary differences of the two preferred embodiments essentially differ in the processing of the incoming natural light, and the channel(s) in the structured optics which convey that light, through subsequent processing stages, to the output surface of the inward/viewer facing composite optics surfaces—in one case, all real-world, pass-through illumination is down-converted to IR and/or near IR “false colors” for efficient processing; in another case, the real-world, pass-through visible frequency illumination is processed/controlled directly, without frequency/wavelength shifting.

ii. GENERATED/“ARTIFICIAL” SUB-PIXELS IN CONSOLIDATED ARRAYS: this preferably a hybrid-magneto-photonic, pixel-signal processing and photonic encoding system. The same overall method, sequence and process is applied to the pass-through light channels in the version and case in which all the pass-through light is down-converted to IR and/or near-IR.

B. Detailed Disclosures

1. IR/near-IR and UV filtering Stage and Structure: A wearable HMD “glasses” or “visor” has a first optical element, which in preferred form is a binocular element, either left and right separate elements or one visor-like connected element, which intercepts the view-through, real-world wave-front(s) of optical rays emanating from the external world relatively forward of the viewer/wearer.

This first element is a composite or structured (e.g., either a substrate/structural optic on which is deposited layers of materials/films or which is itself a periodic or non-periodic but complex-2D or 3D structured material, or hybrid of composite and directly-structured), which implements IR and/or near-IR filtering and

UV filtering. Again, and more specifically, these may be gratings/structures (photonic crystal structures) and or bulk films whose chemical composition implements reflection and/or absorption of the unwanted frequencies. These options for materials structuring are well-known to the relevant arts, with many options commercially available.

In some embodiments, for night vision applications especially, IR filtering is eliminated and some elements of the sequence of functional stages are altered in order, eliminated or modified, following the pattern and structure of the present disclosure. Details of this category and version of embodiment are treated latterly in the following.

2. POLARIZATION FILTERING (to knock down incoming pass-through illumination intensity) or POLARIZATION FILTERING/SORTING INTO CHANNELS, POLARIZATION ROTATION, AND CHANNEL RECOMBINATION TO PRESERVE MAXIMUM INPUT or PASS-THROUGH ILLUMNATION STAGE: A similar filter, which optimally follows the first filters in optical line-up sequence, the next element to the relative right of FIG ______), is either a polarization filter OR polarization sorting stage. This may be again a bulk “polaroid” or polarizer film or deposited material, and/or a polarization grating structure or any other polarization filtering structure and/or material which offers the best combination of practical features and benefits for any given embodiment, i.e., in terms of efficiency, cost of manufacture, weight, durability and other parameters for which optimization trade-offs may be required.

3. Polarization filtering option, results: After this sequence of optical elements disposed across the entire extent of the optical/optical structural elements, the incident wave-front has been frequency-bracketed, and it has been polarization-mode bracketed and sorted/separated by mode. For visible light frequencies, the net brightness per mode channel has been reduced by the magnitude of the polarization filtering means, which for sake of simplicity, reflecting the current efficiency of periodic gratings-structured materials, is practically becoming close to 100% filtering efficiency meaning, that roughly 50% of the light is eliminated per channel.

4. Polarization filtering, sorting, one-channel rotation, and re-combination, results: Taking for example two separated/sorted channels together, the combined intensity will be close to but not exactly the intensity of the original incident light before filtering/separation/sorting.

5. Benefits and significance: As a consequence of these filterings, which also may be implemented on the same layer/material structure, or sequentially through separate layers/material structures, the HVS is 1) protected from bad UV 2) brightness is reduced, 3) IR and near IR is removed (except for night vision applications, for which the visible spectra will be at a minimum and filtering of visible will not be needed). Benefits/features 2 & 3 have great significance for the next stages of the system and the system as a whole, and will receive further elaboration in the following.

6. PIXELLIZATION or SUB-PIXELIZATION OF THE REAL-WORLD PASS-THROUGH ILLUMINATION AND CHANNELS IMPLEMENTING THESE: A sub-pixel subdivision of the incoming wave-front, an optical passive or active structure or operative stage implemented along with the preceding, and preferably following, as it will tend to reduce fabrication expense. This subdivision may be implemented by a wide variety of methods known to the art, as well as others yet to be devised, and including deposition of differential index bulk materials, employing photochemical resist-mask-etch processes or materials fabrication of nano-particles in colloidal solution via electro-static/van der Waals Force-based methods and other self-assembly methods; focused ion bam etching, or embossing, and via etching, cutting and embossing methods in particular, fabrication of capillary micro-hole arrays implementing wave-guiding by modified total index of refraction, or fabrication of other periodic structures implementing a photonic-crystal Bragg-grating type structure, or other periodic gratings or other structures fabricated in a bulk material. Alternatively, or in combination with the referenced or other methods known or which may be devised in the future, a sub-pixel sub-division/guiding material-structure to form an array over the area of the macro-optic/structure element, may be fabricated by assembly of constituent parts, such as optical fibers and other optical-element precursors, including by methods disclosed elsewhere by the author of the present disclosure, as well as methods proposed by Fink and Bayindir, for fiber-device-structured preform assembly, or fused glass or composites assembly methods.

Certain specified details and requirements of different embodiments and versions of the present system, as applies to this structural/operative stage of the system, will be covered at the appropriate later stages of the following structural/operative breakdown of the system.

7. INTEGRATING PASS-THROUGH CHANNELS WITH INTERNALLY-GENERATED SUB-PIXELS IN A CONSOLIDATED ARRAY: But, in addition to providing the means to sub-divide the incoming wave-front(s) from the forward field of view into portions suitable to controlled optical path control, and subsequently, for further passive and/or active filtering and/or modification, it is of great importance to specify at this point that there are two types of pixel/subpixel components of the total view-field array provided to the viewer using the system of the present proposal, and two differing, “branched” processing sequences and operative structures, en route to the final pixel presentation to the viewer. And that it is one of the first stages and requirements for the present compound structure and sequence(s) of operative processes that pixel-by-pixel, and sub-pixel-by-sub-pixel, light-path control is implemented, at their appropriate stages.

8. TWO PIXEL-SIGNAL COMPONENT TYPES—PASS-THROUGH AND GENERATED OR ARTIFICIAL: At the pixel-signal-processing, pixel-logic-state-encoding stage, as following the referenced disclosures, we now take the two pixel types, or more accurately, two pixel-signal component types, separately.

9. TWO PREFERRED OVERALL SCHEMES AND STRUCTURAL/ARCHITECTURES FOR TREATING ANDN PROCESSING PASS-THROUGH (REAL WORLD) ILLUMNATION: While other permutations and versions are enabled by the general features of the present disclosure, the primary differences of the two preferred embodiments essentially differ in the processing of the incoming natural light, and the channel(s) in the structured optics which convey that light, through subsequent processing stages, to the output surface of the inward/viewer facing composite optics surfaces—in one case, all real-world, pass-through illumination is downconverted to IR and/or near IR “false colors” for efficient processing; in another case, the real-world, pass-through visible frequency illumination is processed/controlled directly, without frequency/wavelength shifting.

a. In one preferred version, the visible light channel(s), which have been UV and IR filtered and polarization mode-sorted (and optionally, filtered to knock down the overall intensity of the pass-through illumination), are frequency-shifted to IR or near-IR but in either case non-visible frequencies, implementing a “false color” range of the same proportional band positioning width and intensity. The HVS would detect and see nothing after the photonic pixel signal processing method of frequency/wavelength modulation and down-shifting. The subsequent photonic pixel signal processing of these channels then is essentially the same as is proposed for the generated pixel-signal channels, as disclosed in the following section.

b. In another preferred embodiment, the pass-through channels are not frequency/wavelength modulated and down-converted to invisible IR and/or near IR. In this configuration, the preferred default configuration and pixel-logic state of the pass-through channels is “on,” e.g—in the case of a conventional linear Faraday-rotation switching scheme for pixel-state-encoding/modulation is employed, including input and output polarization filtering means, for any given polarization model-sorted sub-channel, the analyzer (or output polarization means) will be essentially identical to the input polarization means, such that when the operative linear Faraday-effect pixel logic state encoder is addressed and activated, the operation is to reduce the intensity pass-through channel. Details of some of the features and requirements of this embodiment are disclosed in subsequent sections, following the details provided for operative function and structure of generated channels).

If polarization filtering is combined with this preferred embodiment and variation, rather than mode sorting and implementation of separate mode channels which are then combined into a consolidated channel by polarization rotation means to preserve as much as the original pixelated pass-through illumination as possible, such as by means of passive components (e.g., half-wave plates) and/or active magneto-optic or other mode/polarization angle modulation means, then the overall brightness of the pass-through illumination will be reduced by typically around 50%, which in some instances will be more preferred given the relative visible-range performance as of the present writing of magneto-optic materials, as a preferred class and method.

The background pass-through illumination brightness maxima therefore being reduced proportionally, it may be correspondingly easier for the sub-system which provides the “generated” (artificial, non-pass-through) sub-pixel channels and related methods and apparatus to match and integrate and harmonize the generated image elements within a generally comfortable and realistic overall illumination range for the “augmented reality” imagery and view.

Alternatively, the pass-through channels can be configured in a default “off” configuration, such that if employing the typical linear Faraday-rotator scheme, the input polarization means (polarizer) and output means (analyzer) are opposite or “crossed.” As frequency-dependent MO materials (or other photonic modulation means, to the extent that the employ frequency dependent/performance determined materials) continue to improve, it may become advantageous to adopt this default configuration, in which the pass-through illumination intensity base-state is increased and managed, from default “off” or near-zero or effectively zero intensity, by the subsequent photonic pixel-signal processing steps and methods.

c. While downconverting to IR is proposed as preferred, given common materials-system dependence of performance optimization at IR and near-IR of photonic modulation means and methods, UV is also an included option and may in the future be employed in some cases to shift input visible illumination to a convenient non-visible spectral domain for intermediate processing before final output.

10. GENERATED/“ARTIFICAL” SUB-PIXELS IN CONSOLIDATED ARRAYS: First, we consider the image generation pixel-signal component, or in other words, the pixel-signal-processing structure, operative sequence, which is preferably a hybrid-magneto-photonic, pixel-signal processing and photonic endcoding system.

a. In the most common configuration of the proposed image collection/processing/display sub-system of the overall system for full mobile AR in daylight conditions, the next structure, process and element in the sequence is an optical IR and/or near-IR planar illumination dispersion structure and pixel-signal processing stage.

b. For this structure and operative process, an optical surface and structure (a film deposited or mechanically laminated to a structural/substrate, or a patterning or deposition of materials, or combination of methods known to the art, on the substrate directly) evenly distributes IR and/or near-IR illumination evenly across the full optical area of the 100+ FOV binocular lens or continuous visor-type form-factor. The IR and/or near IR illumination is distributed evenly by such means as: 1) a combination of leaky-fiber disposed on the X-Y plane of the structure, either all in the X or Y directions or in a grid. Leaky fiber, such has been developed and is commercially-available by companies such as Physical optics, leaks illumination transmitted substantially through the fiber core transversely in a substantially even fashion over a specified design distance, combined with a diffusion layer, such as non-periodic 3D bump structured film (embossed non-periodic micro-surface) commercially available from Luminit, Inc., and/or other diffusion materials and structures known to the art; 2) side illumination from IR and/or Near IR LED edge arrays or IR and/or Near IR edge laser arrays, such as VCSEL arrays, projecting to intercept as bulk illumination, such planar sequential beam expander/spreader optics as planar periodic gratings structures, including holographic element (HOE) structures, such as is commercially available from Lumus, BAE and other commercial suppliers referenced herein and in the previous referenced pending applications, and other backplane diffusion structures, materials and means; and in general, other display backplane illumination methods, means and structures known to the art and which may be developed in the future.

c. The purpose of this stage/structure in the sequence of operations and pixel-signal processing is to launch IR and/or near IR backplane illumination which is confined to the relative interior of the compound optical/materials structure as proposed thus far, with the IR and/or near-IR filter(s) reflecting the injected IR and/or near-IR illuminiation to the illumination layer/structure.

d. It is of importance to note the fact, even if obvious, that the IR and/or near IR is non-visible to the HVS.

e. The illumination source of the IR and/or Near IR may be LED, laser (such as VCSEL array), or hybrid of both, or other means known to the art or which may be developed in the future.

f. The injected IR and/or near-IR illumination is also of a single polarization mode, preferable plane polarized light.

g. This may be accomplished by a polarization harmonization means, by splitting the IR and/or near-IR LED and/or laser and/or other illumination source(s) with a polarization splitter or filter/reflector sequence, such as a fiber-optic splitter, and passing one of the plane-polarized components through either a passive and/or active polarization rotation means, such as a bulk magneto-optic or magneto-photonic rotator, or a sequence of passive means, such as a combination of half-wave plates, or a hybrid of these. A polarization filter, such as an efficient grating or 2D or 3D periodic photonic crystal-type structure set at an angle to the incident light may bounce the rejected light into the polarization rotation optical sequence and channel, which then re-combines with the unaltered portion of the original illumination. In a waveguide, planar or fiber-optic, in which the polarization modes (plane polarized) are separated, one branch passes through the polarization harmonization means and then rejoins the other branch subsequently.

h. The source illumination may also be constrained in its own structure to produce only light plane-polarized at a given angle or range.

i. The light may be generated and/or harmonized locally, in the HMD, or remotely from the HMD (such as a wearable vest with electrical power storage means) and conveyed via fiber-optics to the HMD. In the HMD, the illumination and/or harmonization stage and structures/means may be immediately adjacent to the compound optical structure described, or somewhere else in the HMD and conveyed optically, by optical fiber if more remote and/or via planar waveguides if closer.

j. The preceding structure and structure of operation and process thus far, and as well be in the following, is an example of pixel-signal processing as disclosed in the referenced applications, among the features of which is de-composition of the pixel-signal characteristics generation and transport process into optimized stages employing best-of-breed methods, and operating typically at wavelengths optimized for that type of process, in particular with reference to the pixel-state-logic encoding stage and process. Many MO and EO and other optical-interaction phenomenon work optimally for most materials systems in the IR or Near-IR frequency band regime. The overall system, method, structures, structure of operation and processes, as well as details of each, including essential and optional elements, are disclosed in the referenced applications.

k. Pixel-signal-processing, pixel-logic-stage encoding stage—modulator arrays:

l. Following the illumination and harmonization stage, the IR and/or near/IR illumination passes through a pixel.-signal-stage-logic encoding process, operation, structure and means, preferably for this disclosure, a modulation means falling in the category of magneto-optic modulation methods. Of those, one preferred method is based on the Faraday effect. Details of this means and method are disclosed in the referenced U.S. patent application “Hybrid MPC Pixel-signal processing”.

m. In a binary pixel-signal-logic state system, the “on” state is encoded by rotating the angle of polarization of the incoming plane-polarized light, such that when that light passes through a later stage of the pixel-signal processing system, a subsequent and opposite polarization filtering means (known as an “analyzer,”), the light will pass through the analyzer.

n. In an MO (or sub-type, MPC) pixel-signal-logic-stage encoding system of this type, the light passes through a medium or structure and material subjected to a magnetic field, uniform/bulk or structured photonic crystal or meta-material, typically solid, (although it may also pass through an encapsulated cavity containing a gas or rarified vapor, or liquid), which possess an effective figure of merit which measures the efficiency of the medium or material/structure to enable the rotation of the angle of polarization.

o. Details of the preferred types and options for this preferred type of pixel-signal-processing-logic stage encoding stage and means are found in the referenced pending applications, and further variations may be found in the prior art, or may be developed in the future.

p. Other aspects of the preferred, and referenced class, of hybrid MPC pixel-signal processing system that require highlighted specification include:

q. The hybrid MPC pixel-signal-processing system implements a memory or “latching,” no-power until the pixel-logic state requires changing system. This is accomplished by means of the following tuning and implementation of magneic “remanence” methods, known to the art, in which the magnetic materials are fabricated, either in bulk processing (e.g., Integrated Photonics commercially available latching LPE thick MO Bi-YIG film [REFERENCE pull from our other disclosures]; and/or implement of the Levy et al permanent domain latching periodic 1D gratings [REFERENCE pull from our other disclosures]; or composite magnetic materials, combining a relatively “harder” magnetic material in juxtaposition/mixing with an optimized MO material, such that an applied field latches the low-coercivity, rectilinear hysteresis curve material, which as an intermediate, maintains the magneticization (latching) of the MO/MPC material. The intermediate material may surround the MO/MPC material, or it may be mixed or structured in a periodic structure which is transparent to the transmission frequency [here, IR or near/IR]. This third composite method was first proposed by the author of the present disclosure in the 2004 U.S. Provisional application Ser. No. ______, later included in U.S. Pat. No. ______/U.S. patent application Ser. No. ______. Later, Belotelov et al, while being funded by the company formed on the basis of the 2004 disclosure, would come to refer to this composites method as “exchange-coupled” structures, and would be implemented in the company's designs for specific 1D multi-layer magneto-photonic crystals, in which different MO materials of relative hardness were employed in a less-efficient variant of the 2004 composites approach.

r. Combinations of these methods are also possible design options.

s. The benefit of this “memory pixel” in the hybrid MPC regime is the same of bi-stable pixel switches such as electrophoretic or “E-Ink” monochrome displays. As a non-volatile (relatively, at least, depending on design of hysteresis profile and choice of materials) memory, an image will remain formed as long as there is an IR or near-IR illumination source being “transported” and “processed” in the pixel-signal-processing channel and system.

t. A second essential aspect and element of the preferred pixel-signal-processing, pixel-logic-encoding stage and method is efficient generation of the magnetic field which switches the magnetic state of the sub-pixel (being the fundamental primitive of color systems such as RGB, so for convenience when discussing the conventional components of a final color pixel, the naming convention is retained more generally, and distinctions made when needed). To ensure that there is no magnetic cross-talk, it is preferable that the field-generation structure (e.g., “coil”) be disposed in the path of the pixel transmission axis, rather than on the sides. This reduces the required field strength and, by placing no field generating means at the edge, makes management of the magnetic flux lines, by means of either (magnetically) impermeable materials in the surrounding materials/matrix, or implementation of periodic structures which, as in the case of the Levy et al method of domain continuation, confines the flux lines to the modulation region. Transparent materials may include such available materials as ITO and other newer and forthcoming conductive materials which are transparent to the relevant frequencies. And/or, other materials, which are not necessarily transparent in bulk but which, in a periodic structure of the appropriate periodic element size, geometry, and periodicity, such as metals, may also be deposited or formed in the modulation region/sub-pixel transmission path.

u. This method was first proposed by the author of the present disclosure in the 2004 internal design document for the same company to which was assigned the 2004 US Provisional application Ser. No. ______, and which was later disclosed in US patent application Ser. No. ______. Subsequently, in 201+, researchers at NHK employed his method, which was proposed in general for MO and MPC devices, for a Kerr rotator, using ITO in the path of the pixel ______ [REFERENCE SE TO LOOK UP]

v. A third significant element of the preferred hybrid MPC pixel-signal processing solution for the pixel-signal-processing sub-system is the method of addressing an array of the sub-pixels. The preferred method, as referenced in the preceding, is found in pending U.S. patent application, Wireless Addressing and Power of Device Arrays. For the present application, wireless addressing may be sufficient to consolidate the powering of the wireless array (sub-pixel) element, given the low power requirements, dispensing with a wireless power method via low-frequency magnetic resonance, although micro-ring-resonators may be more efficient, depending on materials choices and design details, than powering through micro-antennas. Wireless powering of the HMD or wearable device as whole, however, is a preferred method of powering the overall unit while reducing mead-mounted weight and bulk, especially when combined with local high-power density meta-capacitor systems, or other capacity technologies, that can be powered-up by the wireless low-frequency pack. A basic low-frequency magnetic resonance solution is available from Witricity, Inc. For more complex systems, reference is made to the U.S. patent application Ser. No. ______, Wireless Power Relay.

w. Other preferred methods of addressing and powering of the array/matrix include voltage-based spin-wave addressing, a variant not specified in the referenced application and thus novel to the present proposal, though applicable to the original referenced Hybrid MPC Pixel-Signal Processing application Ser. No. ______ and other form-factors and use-cases of same. High-speed current-based backplane/active matrix solutions developed for other display technologies, such as OLED, are also available options.

x. Other, less preferred pixel-signal processing, pixel-logic encoding technologies and methods will also benefit, depending on other specific design choices, from the wireless addressing and powering method, as well as the voltage-based spin-wave method.

y. Such other pixel-signal-processing-pixel-logic-encoding means, including Mach-Zehnder interferometer-based modulators, whose efficiencies are typically also frequency-materials system based and most efficient in IR and/or near-IR, may also be employed, though less preferable, as well as any number of other pixel-signal-logic encoding means design in a configuration and/or materials system optimized for the most efficient frequencies for that class of means, according to the teachings of the referenced applications.

z. It is also essential to the preferred embodiment of the proposed system to identify the dual sub-pixel array system, following the referenced [2008] U.S. patent application Telecom-structured Pixel signal Processing methods, with this particular variation and optimized version disclosed herein for the present application, as well as other non-HMD and non-wearable display system applications which have similar operating requirements or desired benefits.

aa. Following the pixel-signal-processing, pixel-logic-state-encoding stage of the operative structure and process is an optional signal gain stage. The cases when this option is relevant will be covered at what will be an evident point in the following presentation.

bb. Wavelength/frequency shifting stage: for the present particular version of the preferred Hybrid MPC Pixel-signal Processing system, a frequency upconverting stage follows, employing a preferred nano-phosphor and/or quantum-dot (e.g., QD Vision) augmented phosphor color system (although a periodically-poled device/materials systems is also specified as an option in the referenced disclosures). Commercially available basic technologies include from suppliers such as GE, Cree, and a wide range of other vendors known to commercial practice.

cc. It will now be evident to those skilled in the art that what is being done is dividing or separating the up-conversion process that typically occurs at the illumination stage, and delaying it until after several other stages, optimized for operation on IR and/or Near-IR frequencies and for other reasons, are completed.

dd. Thus, a color system is fully-implemented, by optimization of nano-phosphor/quantum-dot augmented phosphor materials/structural formulations tuned to a color system such as the RGB sub-pixel color system. Again, these re-thinking of the concept and operation of display systems is found in the referenced applications disclosed in much greater detail.

ee. A virtue of the employing the hybrid MPC pixel-signal processing method is the high-speed of the native MPC modulation speed, which has been demonstrated as sub-10 ns for a significant period of time, and sub-ns is currently the relevant benchmark. The speed of the phospher excitation-emission response is comparably fast, if not as fast, but in aggregate and net, the total full-color modulation speed is sub 15 ns and theoretically will be optimized to an even lower net-time-duration measurement.

ff. A variant on the proposed structure adds a band-filter to each of the IR and/or near-IR sub-pixel channels which will, at the end of the processing sequence, be either “on” or “off” for upscaling to R, G, or B. This variant, while adding the complexity of a filter element, may be preferred if 1) the hybrid MPC stage itself, in composition of materials, is an array of tailored materials which respond more efficiently to different sub-bands in the IR and/or near-IR domain, even thought his is not likely to be the case, due to the almost 100% transmission efficiency and very-low-power polarization rotation of even bulk LPE MO films commercially available in that wavelength domain, or much more likely, 2) if the efficiency of different nano-phosphor and/or quantum-dot augmented nano-phoshpor/phosphor materials formulations is significantly great enough that a more precisely bracketed IR and/or near-IR frequency band for each ultimate R, G and B sub-pixel constituent is merited. The design trade-off will come down to the cost/benefit analysis of the adding complication of an added layer/structure/desposition pass for the band-bracketing vs. the efficiency gain from the ability to use frequency/wavelength-shifting materials which are more “tuned” to the a different portions of non-visible input illumination spectra.

gg. Following this color processing stage, a sub-pixel group realized from the initial IR and/or near-IR illumination source continues through the consolidated optical pixel channel. In the absence of any other constituent final pixel component being added, the output pixel will be, as may be required, depending on design choices for the modulation and color stage component dimensions, optional pixel-expansion, preferably by diffusion means, including those referenced and as disclosed in the referenced applications, may be necessary (pixel spot-size reduction being far less likely, which requires an optical focusing or other method, as known to the relevant arts and as disclosed in certain of the referenced applications, especially [2008].

hh. For the purposes of realizing a virtual focal plane at the appropriate distance from the viewers eyes, collimating optical elements, including lenslet arrays, optical fiber arrays embedded in textile-composites with the fibers disposed parallel to the optical transmission axis; “flat” or planar inverse-index meta-material structures, and other optical methods known to the art, are employed. Preferably, all elements are fabricated or realized in composite layers on the macro-optical element/structure, rather than requiring additional bulk optical eyepiece elements/structures. Further questions of fiber-type methods vs. laminate composites or deposition-fabricated multi-layer structures, or combinations/hybrids of more than one, are treated in the following section under structural/mechanical systems.

ii. As previously noted, the pixel-signal-processing-pixel-logic array functional/optical/structural element which implements the disclosed pixel-signal-processing-pixel-logic structure and operative stage, including the preferred hybrid MO/MPC methods and operative structures is not a bulk device operating across the entire field of the incident wave-front(s) which have been previously filtered, but is (as will be expected to those skilled in the art) a pixelated array.

jj. Each final pixel may include at least two pixel components, (beyond the color-system RGB sub-pixels described in the foregoing): one, the components, disposed in an array, which do generate the ab-initio video image, which may include simple text and digital graphics, but for the full purpose of the present system, is capable of generating a high-resolution image from either CGI or relatively remote live or archived digital imagery, or composites and hybrids of same. This is as described in the foregoing.

ll. PASS-THROUGH REAL-WORLD ILLUMNATION AND PIXELLATED ARRAY—DETAILED PROVISIONS FOR THE CASE OF OPEARTING ON VISIBLE FREQUENCY PASS-THROUGH (i.e, not down-converted to IR/near-IR): Returning to the transmission and processing of real-world, non-generated light rays from the field of view through the structured and operative optics and photonics structures and stages;

a. Co-located on the addressing array along with these IR and/or near-IR driven sub-pixel clusters is another set of either pixels or other sub-pixel components, which in fact are the final pixel channel components which originate from the live field of view forward of the viewer and wearer of the HMD. These are the “pass-through,” fully addressable components of the final pixels.

b. These channels originate from the front compound optical element/structure which as specified, is sub-divided into pixels.

c. These optical channels convey the wave-front portions, with low-loss of wave-front by employing available efficient methods of division. Surface lenslet arrays or mirror-funnel arrays may be employed in combination with the proposed subdivision methods, enabling very close-to-edge-to-edge ray capture efficiency, such that the captured wave-front portion is then coupled efficiently to the relative “core” of the subdivided/pixelated guidance optic/array structure. Thus, whether a conventional step-index coupling method is used, or MTIR micro-hole-array, or true photonic crystal structure, or a hybrid of more than one method, the area of the pixelated array formation devoted to the coupling means will receive a minimized percentage of wave-front, minimizing loss.

d. Efficient wave-front capture, routing, and guided/pixelated segmentation requires, for certain versions and operating modes of the present system, broadband optical elements that focus and/or reflect visible AND IR and/or near-IR frequencies—and, as will be seen, this is despite the proposal to implement the IR and/or near-IR filter as the initial and first optical filtering structure and means in the optical line-up and sequence.

a. In most configurations, the IR and near-IR illumination stage there will be, interspersed through that stage, guiding structures for the “pass-through” captured illumination which are transparent to IR and/or near-IR, but provide visible frequency light-guiding/path confinement, so that IR and/or near-IR can be evenly distributed while not interfering with the channelized “pass-through” pixel components.

b. Once the guided incoming wave-front-portion channels reach the pixel-signal-processing, pixel-state-encoding stage, if there is a single formation of bulk MO or multi-layer MPC film or periodically structured grating (or 2D or 3D periodic structure) of an otherwise “bulk” film, if the efficiency of that material or structured material(s) is optimized for IR and/or near-IR, then a parallel pixel-signal-processing, pixel-logic-state structure will be implemented in exactly the same way, but with much less efficiency.

c. However, as broad-band MO materials, both in bulk formulation and as structured photonic-crystal materials, fabricated by various means, the efficiency, while not currently equal to that of the of optimized MO/MPC materials/structured materials for IR and near-IR, will continue to improve. In earlier work led by the author of the present disclosure, in 2005, new MO and MPC materials were modeled and fabricated which, for the first time, not only demonstrated significantly improved transmission/Faraday rotation pairing for the green band regime, but demonstrated the first non-negligible, and in fact significant and acceptable and competitive for display applications, performance in the blue band.

Fabrication of such materials, however, tends to be more expensive, and if different materials are deposited, as “filmlets”, for the “generative” pixel components and for the pass-through pixel components, this increases the complexity and expense of the fabrication process. But such a configuration would improve the efficiency, all things being equal, of the pixel-logic state encoding of the “pass-through” components of the final, consolidated pixels.

d. In the absence of the deposition or formation of “tailored” MO-category materials (this logic also applies to less-preferred modulation systems whose max efficiency, like MO/MPC, is frequency-dependent, and instead employment of a single formulation, all things being equal, the intensity of a pass-through final-pixel component will be less, to the degree that the modulation means is less efficient.

e. Typically, for the pass-through system, it would be assumed that no phosphor-type or other wavelength/frequency shifting means would be employed. However, to the degree that the native MO/MPC materials may be less efficient, different formulations of band-optimization materials may be employed in this case, to address, to some degree, deficiencies in the materials performance at the pixel-logic-stage encoding stage.

f. In addition, and as is proposed for low-light or night-vision operation, an optional “gain” stage, as proposed as an option for some applications in the referenced applications (U.S. patent application Ser. No. ______ Pixel Signal Processing ______ and U.S. patent application Hybrid MPC Pixel signal processing Ser. No. ______), in which an energized gain material is pumped to implement an energy gain in the gain medium, either optically, electrically, sonically, mechanically, or magnetically, as detailed in the referenced applications, and by other methods as may be known to the art or devised in the future, to augment the intensity of the transmitted “pass-through” component of the final pixel as it passes through the gain medium. It is not preferred that this is a variable, addressable stage, but rather a blanket gain-increase setting, if this design option is chosen.

g. In addition, once the guided incoming wave-front-portion channels reach the pixel-signal-processing, pixel-state-encoding stage, as indicated, there are is an optional, but for low-light and night-vision applications, valuable optional configuration of the overall pixel-signal processing and optical channel management system.

h. In this variant, in which the IR filter is removable, it is the goal to pass IR and/or near-IR light from the incoming real-world wave-front to the active modulating array sequence, so that the incoming “real” IR is passed through the pixel-signal-processing modulator and directly, to the extent that IR output is visible in the field of view, generated an analogous color (monochrome or false-color IR gradient) image for the viewer, without requiring the intermediation of a sensor array.

i. And, as indicated, a gain stage may be implemented to boost the intensity of the pass-through IR (+near IR, if beneficial) to the wavelength/frequency shifting stage.

j. In addition, a base IR and/or near-IR background illumination, modulated intensity to set an appropriate base level, may be turned on through the normal full-color operating mode, to the degree that the input IR radiation does not reach a threshold to activate the wavelength/frequency shifting stage and media.

k. The removal/deactivation of the IR filtering means may be implemented mechanically, if a passive optical element deployed in a hinged or cantilevered-hinged device, which can be “flipped up”; or as an active component, de-activated, such as in an electrophoretic-type-activated bulk, encapsulated layer, in which (as proposed here) electro-statically (mechanically) rotates a plurality of relatively flat filtering micro-elements, such that the minimum angle of incidence is passed and the plurality of rotated elements no longer filters the IR). Other passive or active activation/removal methods maybe employed.

l. The IR filter and polarization filter, for low light or night-vision operations, may both removed, depending on whether the generative system is employed “actively,” not just to generate a threshold, and superimpose data over some portions of the incident real IR wave-front portions in the pixelated array. If employed actively, the preferred digital pixel-signal processing system, to maximize efficiency of the generative source, requires the initial polarization filter to implement the optical switch/modulator which encodes the pixel-logic-state in the signal.

m. The disadvantage for the pass-through system is that it reduces the intensity of the incoming IR and/or near-IR.

n. An alternative embodiment of the present system, which is designed to address this problem, disposes a gain stage prior to the pixel-signal-processing, pixel-logic-state-encoding stage, to boost the incoming signal.

o. The efficiency of gain media with non-coherent, non-collimated “natural” light must be taken into account in the design parameters of this and any system which employs an energized gain medium with “natural” incident light inputs.

p. In a second alternative, a three-component system is implemented, which includes component sub-channesl for the generative means, an incident visible light component, and an incident IR component which has not been polarization filtered. A pixelated poliarziation filter element, which leaves this third sub-channel/component without a polarizsation filter element, must be implemented to realize this variant.

q. For the more basic, integrated two component optional system type, which has this type of low-light night-vision operating mode requirement, an additional optical element is required at the initial incoming wave-front input and channelization/pixilation stage.

r. While the incoming IR (and near-IR, if needed) maybe divided between a sub-channel directed to the normally “generative” source component of the final viewable pixel and the pass-through channel which guides the entire visible light-portion of the incident incoming wave-front to that source component of the final viewable pixel, there is no particular efficiency gain for sending any IR and/or near-IR to the visible light sub-channel and source for the final pixel.

s. Rather, in sequence after the lenslet or alternative optical capture means for maximizing the capture of the incoming real wave-front, or integrated with the lenslet, is a frequency splitter. One method is to implement opposing filters, one band-filter for visible light, allowing only IR and/or near-IR light, and an adjacent filter for IR and/or near-IR light. Various geometric arrangements of such opposing filters provide differing advantages, including both planar or both set at opposing 45 degree angles offset from the central focal point of the incident wave-front optical capture structure, to enable a focused (from the lenslet or other optical element or means, including reverse index meta-material “flat” lens) composite visible/IR-near-IR beam to first separate one band-range, while reflecting the other to the opposite filter surface—and vice-versa, for the portion of the focal beam that may first impinge on the filter structure that is further from the central focal point. Grating structures are a preferred method of implementing the dual-filter-splitter arrangement, but other methods are known to the art as well, based on bulk-materials formulations, which may be deposited, by various methods known to the art and to be developed, in sequential stages to implement the two filtering surfaces. (NB that UV is filtered before this stage, but preferably after the IR. In some arraignments, the IR and polarizer phases are first and second the UV filter is third; in others, IR is followed by UV and then polarizer. Different arrangements have different value for different use cases, and different impacts on fabrication cost and particular sequences of processes).

12. Combination of Pass-Through and Generated/Artificial Pixel/Sub-Pixel Arrays:

The two component optical channels are, as has been indicated, co-located and output together preferably into/at a pixel harmonizing means (diffusion and/or other mixing method and as may be available by other methods known to the art, or which will be devised in the future), such that the generative source is combined with the pass-through source and, just as with RGB sub-pixels of a conventional color-vision artificial additive color display system, form a final composite pixel. Which is then, as has been indicated and as is detailed in the referenced applications, further pixel-beam-shaped and, in particular, collimated and otherwise optically directed for formation of an image at a virtual focal plane which is most effective and easiest on the HVS, given the close-to-the-face ergonomic design goals that are also part of the objectives of the present disclosure.

a. Operation of the basic integrated, two-component system, with a “generative” component (itself composed of RGB sub-pixels) and a variable “pass-through” component—first, in its primary operating mode, and the second, configured for the optional low-light night-vision mode:

On a bright, sunny day outdoors, the wearer of the proposed form of HMD views an integrated binocular (two separate lens-form-factor device structures) or an connected visor, which presents to him/her an image formed by integration of a pixel array, itself formed by integration of two input components, a generative high-performance pixel and a pass-through, variable intensity wave-front portion of the “window on the world” facing the viewer:

b. A composite color component for the final integrated pixel, this one formed by the “generative” pixel component, which begins as a non-visible IR and/or near-IR “interior,” “injected” rear illumination, which is turned on or off, for each sub-pixel, at sub 10-ns speeds (and currently, sub 1-ns). That IR and/or near-IR sub-pixel then activates a composite phosphor material/structure, employing best current materials and systems available for producing the widest possible gamut.

c. Once the state of the sub-pixel is set, with that very short pulse, the “memory” switch maintains its on state until its state changes, without application of constant power to the switch.

d. Thus, the generative component is a high frame-rate, hi dynamic range, low-power, broad color gamut pixel switching technology.

e. The second component of the composite pixel is the pass-through component, which begins as an efficient high-percentage of the sub-divided portion of the overall wave-front impinging on the forward optical surface of the present HMD, incoming from the facing direction of the wearer. These wave-front portions are filtered for UV and IR, in normal mode, as well as polarization sorted or filtered (which is chosen will depend on the design strategy selected, either reduced real-world illumination base or maximized base). With reduced base, i.e., polarization filtering, this results in reducing the overall brightness of the visible field of view substantially (on the order of ⅓ to ½, depending on the composition of polarization modes incident and the efficiency of the polarizer.

f. In bright daylight especially, but in general under all lighting conditions other than extremely low to no light, a reduction in pass-through intensity makes it easier for the generative system to “compete” and match or exceed the illumination levels of an incoming wave-front portion. Thus, by a passive optical means that is accomplished by a component of the system doing double-duty, or producing a double-benefit: it is a required component of the preferred modulation system (polarization modulation-based) which implements the pixel-logic-state encoding, and it also reduces the power requirements and simplifies the process of calibrating, coordinating and compositing the values of the generative system with the pass-through system.

g. This system design features take advantage of the fact that that for most people, bright lighting conditions outdoors are managed by using polarizing sunglasses. An indoors, overly bright emissive or transmissive displays are known to produce eye-strain, so reducing even indoor lighting levels, overall, results in the much simpler problem of boosting the illumination levels, relatively little, with the generative system, without again creating a “competing light environment” in the field of view. The combination of reduced natural pass-through lighting (which can optionally be boosted by the optional, though less efficient than with LED or certainly with laser light, gain stages) and a generative system which adds graphics or synthetic elements to portions of the scene results in a more harmonized, and lower-intensity baseline than otherwise. (The generative system—that part of the integrated array—does not necessarily AR mode generate an entire FOV, though in full VR mode it can).

h. Assuming calculated coordinating and compositing of the synthetic and real elements in perspective view of the user—an aspect which is addressed next in the sensing and computational system—a hybrid of generative and pass-through source can easily and rapidly, with no visible lag and no appreciable latency at the display-level, generate a hybrid, mobile AR/mixed-reality view.

i. With the pass-through pixel components sub-channels designed in a default “off” scheme (i.e., polarizer and analyzer in the preferred polarization modulation form are “crossed” rather than the same), and conveying no pass-through wave-front portions, the mobile HMD, given calibration with the real landscape and motion tracking, can function in mobile VR mode. As will be seen, in combination with the proposed sensor and related processing systems, the HMD can function as Barrilleaux's “indirect view display,” with the pass-through turned off.

j. With the generative system turned off, and in particular if the added expense and complexity of optimized visible frequency MO/MPC materials-structures, a variable pass-through system without generative/augmented channels adding pixel illumination/image primitive information) can also be implemented.

In the reverse configuration of the “indirect view display,” as will be seen during the specification of the proposed sensor and related processing systems, if a further variant of the present system is adopted, and the “pass-through” channel filter-subdivided (following the pattern of the IR/near-IR and visible spectrum filter-splitter) into RGB subpixel channels, each with its own pixel-signal-logic-state encoding modulator, the variable-transmission means of the pass-through system can be augmented into being a direct-view system. Its disadvantage will be in dynamic range, and without a generative means to supplement, a relatively low-light limitation by comparison; furthermore, such a variant (mode or system which simply eliminates the generative structures) will not have the benefit of a dual array which can be addressed by a parallel processing system, simplifying bottlenecks in performing scene-integration-compositing and perspective calculations. In addition, such a system, based on different tuned, and visible-spectrum optimal MO/MPC materials/structures, will be more expensive and perform less efficiently than the IR/near-IR-based generative system.

k. The optimized system is one which combines an efficient generative component with a variable intensity, but lower-light level overall, pass-through component.

l. The preferred wireless addressing and powering further reduces power, heat, weight and bulk from the functional device part of the intelligent structure system.

m. In very low light or night-vision mode, for a system in which the IR filter can be removed or turned off, IR (and near-IR, if desired) passed-through the pixel-state system without loss and, with the optional gain stage boosting the IR signal strength, and/or the IR/near-iR interior-injected illumination component raising the threshold/base intensity, on top of which the incoming pixelated IR strength will be added/superposed, the IR/near-IR pass-through the wavelength/frequency shifting means (preferred phosphor-type system) and, with either the system set to monochrome or false-color, a direct-view low-light or night vision system is realized. With the polarization filter in place, the generative system can operate and add graphics and full imagery, compensating for the reduced intensity of the incoming IR with either a signal from an auxiliary sensor system (see following), or simply adding a base level, as proposed in the other configuration, to ensure that the energy input into the wavelength/frequency shift is enough to produce a sufficient output.

II. Sensor Systems for Mobile AR and VR:

Following the general case of this proposal, in which no structure which displays an image does so without a sensor system that optimizes and harmonizes that synthetic, generated imagery with the general interior (and, in some cases, exterior lighting conditions, which may-pass-through, as may be desired or required for efficiency considerations), according to the varied cases of the referenced disclosure; nor without taking into account the user's position, viewing direction, and in general motion tracking.

1. In the preferred version of the present system, as least some device components do double duty as structural elements; but in those cases where that is not at all possible, to any appreciable degree, the other elements of the, which integrate sensing with the other functional purposes, are in combination especially what differentiates the device as an integrated, holistic system. (

2. In the system of the present disclosure which in optimal form holistic, implementing motion-tracking sensors such as are known to the art including accelerometers, digital gyroscopic sensors, optical tracking and other systems, in the form of not large individual macro-cameras systems, but rather multiple distributed arrays of sensors, is the preferred implementation, in order to realize the benefits of distributed, native and local processing, and the additional specific benefits of image-based/photogrammetry methods for capturing, in real time, the “global” lighting conditions, as well as extracting, in real time, geometric data to enable local updating to stored positional/geodetic/topographical data, to accelerate calibration of synthetic image elements and their effective perspective view rendering and integration and composition into a hybrid/mixed view scene.

3. As disclosed in the referenced applications, and to briefly expand, among “image-based” and photogrammetric methods of especially use and proven real-time information gathering value are light-field methods, as exemplified by the commercially available Lytro system, which from a multi-sampled (and optimally, a distributed sensor array) space, is able to in real-time image-sample a space and then, after inputing/capturing sufficient initial data, generated a view-morphed 3D space. A virtual camera then, in real-time, at a given resolution, be positioned at varying positions in the 3D space as extracted from the photogrammetric data.

4. Other image-based methods can be employed in concert and combination with the Lytro light-field method, to extra local geometric/topographical data, to enable calibrated perspective mage compositing, including occlusion and opacity (using the integrated dual generative and pass-through components of the preferred proposed display sub-system). Such methods, providing sampling of an entire FOV in real-time to obtain lighting parameters to match shading/lighting of CGI or even simple graphical/text elements, as well as live-updating of the navigated real-world 3D topographical space, as opposed to simply performing separate calculations on disconnected, unrelated pixel points from files, GPS, and conventional motion sensors only. General corrections can be applied to lighting and relative position/geometry, by means of parametric sampling, reducing calculation burdens significantly.

5. In combination with “absolute” positioning of a user by means of GPS and other mobile-network triangulation from signal methods, in combination with motion sensor tracking of HMD and of any haptic interface, as well as including image-based mapping of the user's body from the live-updated image-based photogrammetric systems, and then relying on the relative positional and topographical parameters obtained rom fast-real time image-based methods, employing multiple small sensors and cameras.

6. In relation to this, the Bayindir/Fink “optical fabric” camera, developed at MIT, is an example of validation of a particular physical method of implementing a distributed array. Whether following the fiber-device and intelligent textile-composites methods, as proposed by the inventor of the present disclosure, or the simpler MIT fiber-device fab methods and optical fabrics implementation, or other fiber-device intelligent/active/photonic textiles methods, a distributed textile-composite camera array, disposed in the structure of the HMD mechanical frame—and, as per the following, doing double duty by also adding to the structural system solution, rather than serving as a non-contributing load on the system—is a preferred version of implementing the advantageous multi-device array system which provides for parallel, distributed data capture.

7. A multi-point miniature sensor array, which can include multiple miniature camera optics-sensor array devices, is another preferred implementation of multi-perspective systems.

8. A more basic integrated commercial Lytro system, combined with some multiple of other camera/sensors in a small array, is a less preferred but still superior combination, allowing multiple image-base methods.

9. Auxiliary IR sensors, again preferably arranged in multiple, lower resolution device arrays, is, as has been indicated, can either provide an override low-light/night-vision feed to the display system, or providing corrective and supplementary data to the generative system to work in harmony and coordination with the real IR pass-through.

10. A Lytro-type light field system, based on the same arrangement, in pattern at the general level, for visible spectrum may be employed for sensors in other frequency bands, which, depending on the application, can include not only low-light/night vision, but also field analytics for other applications and use-cases, such as UV or microwave. Given limitations of resolution at longer wavelengths, none-the-less, a spatial reconstruction from non-visible, or non-visible supplemented by GPS/LIDAR reference data, may be generated, and other dimensional data collection correlations obtained, in performing sensor scans of complex environments. Compact mass-spectrometry, now being realized in smaller and smaller form factors and miniaturization, can also be contemplated for integration into an HMD, as miniaturization proceeds.

11. Finally, among image-based methods of advantage for fast data sampling of the lighting parameters, and what they tell us about materials, geometry and atmospheric conditions of a local environment, one or more micro “light-probe,” which is a reflective sphere whose surface can be imaged to extract a compact global reflectance map, positioned for instance at key vertices of the HMD (right and left corners, or solely the center, paired with multiple imagers to capture the entire reflected surface; alternatively, a concave reflective partial hemispherical “hole” can also be utilized, alone or preferably in combination with a sphere, either held in pace via magnetic fields, or on a strong spindle or mostly hidden-mounting, to extract lighting data from compact, compressed reflection surface), can provide a highly-accelerated method, in conjunction with the other related methods from photogrammetry, to parameterize the lighting, materials and geometry of a space—not only to accelerate fast graphic integration (shading, lighting, perspective rendering, including occlusion, etc.) of live and generated CGI/digital imagery, but also for performing fast analytics of likely risk factors for sensitive operations in complex, rapidly changing environments.

III. Mechanical and Substrating Systems:

As will be evident from the foregoing, the image display sub-system and the distributed and image-based sensing and auxiliary imaging systems that have already been proposed, focusing on the preferred embodiments, already provide substantial benefits and value towards the structural and mechanical and ergonomic goals of the present disclosure.

1. One preferred embodiment of structural-functional integration, with benefits to weight, bulk, size, balance, ergonomics, and cost is implementation of a textile-composite structure of tensioned thin-films in combination with flexible optical-structural substrate, in particular preferable an HMD frame formed of Corning Willow Glass, which is folded (and preferably, sealed) with all processing and functional electronics that must be integrated into the HMD, which can include power supply in less preferred versions which do not use wireless powering, fabricate on the folded glass frame. To protect the glass and wearer, and for comfort and ergonomics, a protective coating is applied/wrapped or otherwise added to the functional-optical-structural members, such as shockwave-system-based D30, which is when non-shocked, soft and resilient, but when impacted, the shockwave solidifies the material, providing an protective barrier to the less durable (though appreciably durable) Willow-glass structural/functional system). The folded Willow glass, with the interior surface being the location of system-on-glass electronics, is shaped in a cylindrical form, or semi-cylinder, for added strength and to better protect the electronics from shock, and to also thereby enable a thinner substrate.

Optical fiber data and illumination is delivered via flexible, textile-wrapped and protected (with preferably, D30 as an outer composite layer, or other shock-resistant composite component) cable, from illumination, powering (preferably wireless), and data processing units in a pocket or integrated into an intelligent textile composite wearable article on the users body, and thereby flattened and weight distributed and balanced.

2. Once the optical fiber (data, light, and optionally power) cable is integrated with the composite Willow glass frame, the optical fiber is bonded as a composite, preferable to the more expensive and unnecessary thermal fusing, to the data input points for E-O data transfer, and for the illumination insert points on the display face.

3. The display frame structural elements are, in this version, also Willow Glass or Willow-Glass type materials systems with optional additional composite elements: but instead of solid glass or polymer lenses forming the optical-form-factor elements (binocular pair or continuous visor), these are thin films composite layers, following a lens-type preform to help form desired surface geometries; compression ribs may also be employed to implement appropriate curvatures.

4. Since the sequence of functional optical elements includes, after the initial filters and in its most complex stages, light-guiding/confinement channels, a preferred option, as is found in both the proposed structural and substrating system, is to implement optical channel elements, such as optical fibers, as part of an aerogel-tensioned membrane matrix. Or, a hollow IR/near-IR rigid shell may be employed, with solid (or semi-flexible) optical channels for the IR-pass through to the IR generative channel, and the visible pass through channel, infiltrating the hollow and spaces in-between with aerogel, and including aerogel under positive pressure, will realize and extremely strong, low density, lightweight reinforced structural system. Aerogel-filament composites have been commercially developed and advances in this category of composite aerogel systems continue to be made, providing a wide-range of materials options for silica and other aerogels, and now fabricated in low-cost, manufacturing methods (Cabot, Aspen Aerogel, etc.).

5. A further option, and/or which can be employed in hybrid form with the Willow glass, is a graphene-CNT (carbon nanotube) functional-structural system, alone or preferable again in composite with aerogels.

6. As graphene is further developed or functional electronics and photonics features, a graphene layer or multilayer, formed on either a thinned Willow glass substrate or in a sandwich system with aerogel, the mixture of graphene and CNT for electronic interconnect, optical fiber and planar waveguides on glass for optical interconnect, and in combination with otherwise SOG system elements, and increasingly heterogeneous materials systems beyond SOG (as will be the case of heterogenous CMOS+ systems, post-“pure” CMOS), will be a preferred structural implementation.

7. In the nearer term, graphene, CNT, and preferably graphene-CNT combinations as compression elements, alone or in combination with rolled Willow glass and optional aerogel cells sandwiches, provide preferred light[-weight, integrated structural systems with superior substrate qualities. Thus, for both the on-board processor, sensor deployment, and dense pixel-signal-processing array layers, the semi-flexible Willow Glass, or similar glass products from Asahi, Schott, and others as they are likely to be developed, and also but less preferably near-term, polymer or polymer glass hybrids, may also serve as the depositional substrate.

IV. Other mobile or semi-wearable form factors, such as tablets, may also implement many of the mobile AR and VR solutions given full application in the preferred HMD form-factor.

While particular embodiments have been disclosed herein, they should not be construed to limit the application and scope of the proposed novel image display and projection, based on de-composing and separately optimizing the operations and stages required for pixel modulation.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. The apparatus substantially as disclosed herein.

2. The method substantially as disclosed herein.
